(19) United States
(12) Patent Application Publication
(10) Pub. No.: US 2004/0218899 A1
(43) Pub. Date: Nov. 4, 2004

(54) Data transmitting device, data receiving device and data communication system

(76) Inventors: Kazuya Oyama, Ikoma-Shi (JP); Masahiro Esashi, Nara-Shi (JP)

Correspondence Address: BIRCH STEWART KOLASCH & BIRCH, PO BOX 747, FALLS CHURCH, VA, 22040-0747, US

(21) Appl. No.: 10/834,018

(22) Filed: Apr. 29, 2004

(30) Foreign Application Priority Data
Apr. 30, 2003 (JP) 2003-124670

(51) Int. Cl. H04N 5/76; H04Q 11/00; H04L 12/16

(52) U.S. Cl. 386/46; 386/83

(57) ABSTRACT

When an AV data transmitting device 3 confirms that a blank condition devoid of the reception of an ACK signal and re-transmission request signal has lasted in a period from time ta to time tb, the system controlling unit 531 causes the AV data transmitter 3 to provisionally halt own operation. When the AV data transmitting device 3 confirms the reception of the ACK signals from an AV data receiving device 4 in succession during a period from time tc to time td, the AV data transmitting device 3 actuates operation of an AV source apparatus 1 so as to resume a reproducing operation thus far held under a provisional halt.

The present invention is based on Japanese Patent Application No. 2003-124670 filed on Apr. 30, 2003, the contents of which are hereby incorporated by reference.

### BACKGROUND OF THE INVENTION

1. Field of the Invention

The present invention relates to a data transmitting device for transmitting data signal after implementing encryption with enciphering codes, and the present invention also relates to a data receiving device for receiving and decoding enciphered data signal, while the present invention further relates to a data communication system integrated with the data transmitting device and the data receiving device in subject.

2. Description of the Prior Art

In recent years, relative to the complexity in the cable connection and the development of radio technology, there is such an AV (audio/visual) data radio communication system, which transmits an AV data to an AV reproduction unit such as a display or a projector from an AV source apparatus such as a tuner, a video tape recorder, or a DVD (digital versatile disc) recorder in order to enable the AV reproduction unit to display or output video data or audio data. To realize the above AV data radio communication system, an AV data transmitting device for transmitting AV data is connected to an AV source apparatus, whereas an AV data receiving device is connected to an AV reproduction unit. In addition, any AV data radio communication system may also be constituted with an AV source apparatus and an AV reproduction unit by combining the AV data transmitting device with the AV source apparatus and combining the AV data receiving device with the AV reproduction unit as well.

FIG. 57 exemplifies a constitution of a conventional AV data radio communication system. This conventional AV data radio communication system shown in FIG. 57 consists of an AV data transmitting device and an AV data receiving device with one-to-one relationship. Concretely, an AV data signal output from an AV source apparatus 1 is externally transmitted from an antenna 511 (shown in FIG. 58) provided for by an AV data transmitting device 101 connected to the AV source apparatus 1 via a cable. The AV data signal output from the AV source apparatus 1 is received by an antenna 541 (shown in FIG. 59) provided for by an AV data receiving device 102. Upon reception of the AV data signal by the AV data receiving device 102, the AV data signal is transmitted to an AV reproduction unit connected to the AV receiver 102 via a cable before eventually being reproduced and displayed.

When an infrared signal has been transmitted via a remote controller 11 provided for operating the AV source apparatus 1, the transmitted infrared signal is received by a remote controlling data signal receiver 553 of the AV data receiving device 102, and then converted into a radio communication signal before externally being transmitted from the antenna 541. Upon reception of this signal via the antenna 511 of the AV data transmitting device 101, this signal is converted into an infrared signal, which is then transmitted from an remote controller output terminal 517. Upon reception of the infrared signal by an infrared signal receiving terminal 12 of the AV source apparatus 1, the AV source apparatus 1 executes an operation instructed by the remote controller.

As shown in FIG. 58, the AV data transmitting device 101 is provided with an analog input terminal 502 for receiving an NTSC analog AV data signal for example and a digital signal input terminal 501 for receiving a digital signal. The received analog signal is then converted into a digital signal by an A/D converter 503. Next, the A/D converted digital signal is encoded by an MPEG (Moving Picture Image Coding Expert Group) encoder 504. Next, various data signals are processed by a data generator 505, and then added with error correcting codes by an error correction code adder 506. The error correcting code added signal is then scrambled into enciphered signal by a data scrambling unit 507, which is then transmitted to the AV data receiving unit via serial routes in order of a base band (BB) 509, a high-frequency amplifying circuit 510, and the antenna 511. The identification code used for scrambling the error correcting code added signal by the data scrambling unit 507 is stored in an ID memory 520. When the input signal is identified as a digital signal, the input signal is directly transmitted from the digital signal input terminal 501 to the data generator 505.

The AV data receiving device 102 having a constitution shown in FIG. 59 receives the above digital data signal via the antenna 541, a high-frequency amplifying circuit 542, and a base band 543. Next, the received digital data signal is released from the scrambled state by a descrambling unit 544. Next, a data analyzer 545 judges apportionment and shortage of AV data. Next, the AV data is decoded by the MPEG processor, and then the decoded AV data signal is converted into analog AV signal by a D/A converter 547. Finally, the analog AV data signal is output from an analog output terminal 548 as, for example, an NTSC data signal. Concurrently, the identification code used for releasing the AV signal from the scrambled state is stored in the ID memory 560. When it is required to output digital data signal, digital data signal delivered from the data analyzer 545 is output via a digital output analyzer 549 and a digital output terminal 550.

The AV data receiving device 102 also identifies such a packet that was not correctly received by the data analyzer 545. Based on the identified result, a packet retransmission request generator 558 generates a retransmission request packet for requesting retransmission of a specific packet that was not received by the data analyzer 545. The AV data receiving device 102 is further provided with an operating unit 553 for receiving a signal for controlling operation of the AV source apparatus 1 and a remote controlling data receiving terminal 553 for receiving data signal from a remote controller 11. Data signal from the operating unit 551 is then converted by an input data converter 552, whereas the data signal received by the remote controlling data receiving terminal 553 is also converted by a remote controlling data converter 554. Next, a data generator 555 generates a transmission data in response to the retransmission request packet from the packet retransmission request generator 558 and the converted data. The transmission data is then added with an error correcting code by the error correcting code adder 556. The error correcting code added data signal is then scrambled by a data scrambling unit 557 before eventually being transmitted via a base band 543, a high-frequency amplifying circuit 542, and an antenna 541.

When the above scrambled data signal is received by the AV data transmitting device 101 via the antenna 511, the high frequency amplifying circuit 510, and the base band 509, a descrambling unit 512 releases the received signal from the scrambled state. Next, the data analyzer 513 identifies the packet that was not correctly received by the AV data receiving device 102 and then apportions data. If it is necessary of retransmission of a specific AV data, the re-transmission request packet generator 514 generates a data packet of the AV data requested for retransmission thereof. Furthermore, the data for operating the AV source apparatus 1 generated by the data analyzer 516 is then converted into a remote controlling signal by the remote controlling data analyzer 516, and then, the remote controlling signal is output from the remote controller output terminal 517 as an infrared signal. All the digital data signals other than the remote controlling signal are output from the digital data output terminal 519 via the digital data analyzer 518.

Whenever operating the above-cited conventional AV radio communication system, operating functions of the AV source apparatus 1 is totally controlled by the user. Accordingly, depending on the wave condition and operating condition of the AV data transmitting device 101 and the AV data receiving device 102, in the event if the wave transmission were provisionally interrupted, in order to again reproduce and transmit the interrupted data signal, it is essential for the user to properly operate the AV source apparatus 1.

As disclosed in the Japanese Patent Publication (Laid-Open) No. 2002-300517 for example, a prior art proposes a reproduction unit and a reproduction method for automatically resuming reproduction of data signal from the interrupted portion whenever transmission is interrupted due to disconnection of power supply source on the part of the transmitter and/or the receiver. According to this prior art, when disconnecting power supply source on the way of transmitting data block from a transmitter to a receiver, the transmitter detects that the power supply source of this transmitting unit has been disconnected, and simultaneously, an ending flag designating the final transmission block is added to the data block that should be transmitted at the time of the above detection, and then, the ending flag added data block is transmitted to the receiver. Upon reception of this data block, the receiver memorizes that the data block next to this data block is at the resuming position.

However, as shown in FIG. 57, when transmitting AV data signal via a radio communication means, due to variation of obstacles, or due to the shift of the AV data receiving device, or due to interference of radio waves from other data wave source, radio wave condition may vary abruptly. In consequence, unintended interruption of visual and auditory data reception occurs due to faulty reception of visual and auditory data suddenly generated, thus obliging the audience to keep on viewing and listening to the partially interrupted AV program.

If the AV source unit on the part of the transmitter consists of a video tape recorder (VTR), it is possible for the user, by recovering normal reproduction mode after manipulating the rewinding button, to review the interrupted portion after restoring the reception. On the other hand, these serial manipulations involve complexity. Further, if the AV reproduction unit on the part of the receiver consists of a TV set operable via a rechargeable battery, after exhausting the battery power, the viewer may change this TV set with another one. Even when the viewer normally receives AV data signals, he may change this TV set with another one installed in another room. Even in this case, the user is obliged to initially actuate operation of another AV reproduction unit, and then, retrieve the interrupted portion via rewinding before being able to normally view the interrupted portion, thus also involving complex steps.

When applying the technology disclosed in the above-cited Japanese Patent Publication (Laid-Open) No. 2002-300517, after confirming that a specific AV data transmitting unit instructs itself to turn the power supply source OFF or after enabling a specific AV data transmitting unit to receive a signal designating that a specific AV data receiving unit has turned own power supply source OFF, the above AV data transmitting unit is enabled to confirm that the AV data transmitting unit itself or the correspondent AV data receiving device has turned own power supply source OFF. In this way, after confirming that the AV data transmitting unit itself or the correspondent AV data receiving unit has turned own power supply source OFF, the final flag of a data block to be subject to transmission at present is added to the above data signal before transmitting the combined data block to the correspondent AV data receiving unit. Accordingly, power supply source cannot be turned OFF until the AV data transmitting unit and the correspondent AV data receiving unit transmits or receives the data block added with the final flag.

Nevertheless, when applying the technology set forth in the above Japanese Patent Publication (Laid-Open) No. 2002-300517, as in the case of a radio communication system, when an AV data receiving unit is forced to turn OFF itself all of sudden as a result of abrupt disconnection from an outlet or exhaustion of battery power, it is impossible to inform the correspondent AV data transmitting unit of the act executed for turning the power supply source OFF. In consequence, the AV data transmitting unit may not be able to generate a data block added with the final flag before the AV data transmitting device itself and the AV data receiving unit becomes no longer possible to exchange communication. Likewise, there may be such a case in which communication has been disconnected before enabling the AV data receiving unit to receive the data block added with the final flag, thereby failing to receive the data block added with the final flag.

To prevent this from occurrence, there is a description on a method of transmitting data block added with the final flag at predetermined time intervals. However, if a data block without being added with the final flag were ever interrupted, inasmuch as it is so arranged that any data block devoid of the final flag is not transmissible over again, when the user resumes to view and listen to AV data stored in data block, he may not be able to properly view and listen to the desired AV data from the interrupted portion of the data block.

Further, when reproducing the AV data from a very precise relaying position, for example, when listening to a Japanese greeting phrase “Ohayo-u” (“good morning” in English), if an AV reproduction unit breaks off saying this phrase at “Oha”, when a listener resumes to listen to this phrase, he will be obliged to hear this phrase starting from “yo-u” without hearing the first half phrase. In this case, even when the listener resumes listening, the spoken phase “Ohayo-u” may not always be recognized by the listener properly. When it is so arranged that an AV data can be reproduced from the interrupted portion as in the above example, it is conceived that unrecognizable phrase at the interrupted portion may be spoken. Totally unlike the case of copying digital AV data, there may be a case in which the strict positional recording method alone can hardly suffice the audibility and visibility of the human beings.

### SUMMARY OF THE INVENTION

In the light of the above problems, as a primary object, the present invention provides a data communication system, which, even when data transmission is provisionally interrupted, continuously transmits data signal from the interrupted data position. As another object, the present invention further provides a data transmitting unit and a data receiving unit combined in the data communication system in subject.

To achieve the above object, according to one aspect of the present invention, a data transmitting device is provided with: a data transmitter that transmits a data signal; a data receiver that receives a receiving condition notifying signal that is transmitted, from a data receiving device that receives the data signal, to indicate receiving condition of the data receiving device; a receiving condition analyzer that checks, based on the receiving condition notifying signal received by the data receiver, whether or not reception is proceeding normally in the data receiving device; and a system controller that, when the receiving condition analyzer finds reception not to be proceeding normally, recognizes the data receiving device to be unable to perform stable communication and thus temporarily halts transmission of the data signal, and that, when the receiving condition analyzer finds reception to be proceeding normally while transmission of the data signal is temporarily or otherwise halted, recognizes the data receiving device to be able to perform stable communication and thus starts transmission of the data signal.

According to another aspect of the present invention, a data transmitting device is provided with: a data transmitter that transmits a data signal based on data that is generated on a time-series basis; a data receiver that receives a receiving condition notifying signal that is transmitted, from a data receiving device that receives the data signal, to indicate receiving condition of the data receiving device; a receiving condition analyzer that checks, based on the receiving condition notifying signal received by the data receiver, whether or not reception is proceeding normally in the data receiving device; a reproduction resuming data memory in which is stored, as a reproduction resuming data position, a data position on a time axis at which the data receiving device is found to be unable to perform stable communication; and a system controller that, when the receiving condition analyzer finds reception not to be proceeding normally, recognizes the data receiving device to be unable to perform stable communication and thus stores the reproduction resuming data position in the reproduction resuming data memory, and that thereafter, when the receiving condition analyzer finds reception to be proceeding normally, recognizes the data receiving device to be able to perform stable communication and thus resumes transmission of the data signal starting at the reproduction resuming data position stored in the reproduction resuming data memory.

According to another aspect of the present invention, a data receiving device is provided with: a data receiver that receives a data signal from a data transmitting device; a data analyzer that decodes the data signal received by the data receiver; a receiving condition checker that checks whether or not the data receiver has received the data signal normally; a system controller that, when the receiving condition checker finds reception not to be proceeding normally, recognizes the data receiving device itself to be unable to perform stable communication and thus generates temporary-halt control data for making the data transmitting device temporarily halt transmission of the data signal, and that, when the receiving condition checker finds reception to be proceeding normally while transmission of the data signal in the data transmitting device is being temporarily or otherwise halted, recognizes the data receiving device itself to be able to perform stable communication and thus generates transmission-resumption control data for making the data transmitting device start transmission of the data signal; and a data transmitter that transmits to the data transmitting device the temporary-halt control data or the transmission-resumption control data generated by the system controller.

According to another aspect of the present invention, a data receiving device is provided with: a data receiver that receives from a data transmitting device a data signal based on data that is generated on a time-series basis; a data analyzer that decodes the data signal received by the data receiver; a receiving condition checker that checks whether or not the data receiver has received the data signal normally; a reproduction resuming data memory in which is stored, as a reproduction resuming data position, a data position on a time axis at which the data receiving device itself is found to be unable to perform stable communication; a system controller that, when the receiving condition checker finds reception not to be proceeding normally, recognizes the data receiving device itself to be unable to perform stable communication and thus stores the reproduction resuming data position in the reproduction resuming data memory, and that thereafter, when the receiving condition checker finds reception to be proceeding normally, recognizes the data receiving device itself to be able to perform stable communication and thus generates transmission-resumption control data for requesting transmission of the data signal starting at the reproduction resuming data position; and a data transmitter that transmits the transmission-resumption control data generated by the system controller to the data transmitting device.

According to another aspect of the present invention, a data communication system is provided with: a data transmitting device that transmits a data signal; and a plurality of data receiving devices that are permitted to receive the data signal from the data transmitting device. Here, when a first data receiving device, which is one of the plurality of data receiving devices, finishes data communication with the data transmitting device and disconnects itself therefrom, the data transmitting device temporarily halts transmission of the data signal, and, when a second data receiving device, which is one of the plurality of data receiving devices, establishes connection for communication with the data transmitting device, the data signal is transmitted starting at a reproduction resuming data position that is set based on a data position at which the data transmitting device halted transmission.

According to another aspect of the present invention, a data communication system is provided with: a data transmitting device that transmits a data signal; and a plurality of data receiving devices that are permitted to receive the data signal from the data transmitting device. Here, when communication is performed, one of the following operation states is selected: a first operation state in which, when the data transmitting device transmits the data signal to the plurality of data receiving devices, a receiving-condition-dependent operation controlling function whereby transmission of the data signal is controlled according to receiving condition of the data receiving devices is disabled; a second operation state in which, when the receiving-condition-dependent operation controlling function is enabled, the data transmitting device transmits the data signal only to one of the data receiving devices, and stops reception by the other data receiving devices; and a third operation state in which, when the receiving-condition-dependent operation controlling function is enabled, the receiving-condition-dependent operation controlling function is used according to receiving condition of one of the plurality of data receiving devices to which the data transmitting device transmits the data signal.

### BRIEF DESCRIPTION OF THE DRAWINGS

The above and further objects and features of the present invention will become more apparent from the following description taken in conjunction with the preferred embodiments with reference to the accompanying drawings in which;

FIG. 1 is a schematic diagram for explanatory of a constitution of an AV data radio communication system according to the present invention;

FIG. 2 is a schematic block diagram representing an inner constitution of an AV data transmitting device according to the present invention;

FIG. 3 is a flowchart for exemplifying serial operations executed by an AV data transmitting device according to the first embodiment of the present invention;

FIG. 4 is a flowchart for exemplifying other serial operations executed by the AV data transmitting device according to the first embodiment of the present invention;

FIG. 5 is a flowchart for exemplifying serial operations executed by the AV data transmitting device according to the first embodiment of the present invention when operation mode shifts to a provisional halt;

FIG. 6 is a time chart for exemplifying serial operations of the AV data transmitting device and the AV data receiving device according to the first embodiment of the present invention;

FIG. 7 is explanatory of another AV data radio communication system according to the present invention;

FIG. 8 is a simplified block diagram representing an internal constitution of the AV data receiving device according to the present invention;

FIG. 9 is a flowchart for exemplifying serial operations of an AV data receiving device according to the second embodiment of the present invention;

FIG. 10 is a flowchart for explanatory of another example of serial operations of the AV data receiving device according to the second embodiment of the present invention;

FIG. 11 is a time chart for exemplifying serial operations of the AV data transmitting device and the AV data receiving device according to the second embodiment of the present invention;

FIG. 12 is a simplified block diagram representing an internal constitution of an AV data transmitting device according to the third embodiment of the present invention;

FIG. 13 is a simplified block diagram representing an internal constitution of the AV data receiving device according to the third embodiment of the present invention;

FIG. 14 is a flowchart representing an example of serial operations of an AV data transmitting device according to the fourth embodiment of the present invention;

FIG. 15 is a flowchart representing another example of serial operations of the AV data transmitting device according to the fourth embodiment;

FIG. 16 is a flowchart representing an example of serial operations of the AV data transmitting device according to the fourth embodiment of the present invention when shifting to resumption of reproduction;

FIG. 17 is a chart representing the relationship between the time difference up to the present time and the overlapped time;

FIG. 18 is a flowchart representing an example of serial operations of an AV data receiving device according to the fourth embodiment of the present invention;

FIG. 19 is a flowchart representing another example of serial operations of the AV data receiving device according to the fourth embodiment;

FIG. 20 is a flowchart representing an example of serial operations of the AV data transmitting device or the AV data receiving device after shifting to a provisional halt;

FIG. 21 is a simplified block diagram exemplifying an internal constitution of an AV data transmitting device according to the sixth embodiment of the present invention;

FIG. 22 is a flowchart representing serial operations of the AV data transmitting device after shifting to resumption of reproduction;

FIG. 23 is an example of display of an AV data reproduction unit according to the sixth embodiment;

FIG. 24 is a flowchart representing another example of serial operations of an AV data transmitting device after shifting to resumption of reproduction;

FIG. 25 is a simplified block diagram exemplifying an internal constitution of the AV data receiving device according to the sixth embodiment of the present invention;

FIG. 26 is a flowchart exemplifying an example of registering operations of an AV data transmitting device according to the seventh embodiment of the present invention while error remains generated therein;

FIG. 27 is a flowchart representing another example of the registering operations of the AV data transmitting device according to the seventh embodiment while error remains generated therein;

FIG. 28 is a flowchart representing an example of serial operations for deleting registrations in the AV data transmitting device according to the seventh embodiment while error remains generated therein;

FIG. 29 is a flowchart representing another example of registering operations in the AV data transmitting device according to the seventh embodiment while error remains generated therein;

FIG. 30 is a flowchart representing another example of registering operations in the AV data transmitting device according to the seventh embodiment while error remains generated therein;

FIG. 31 is a flowchart representing an example of registering operations in an AV data receiving device according to the eighth embodiment while error remains generated therein

FIG. 32 is a flowchart representing another example of registering operations in the AV data receiving device according to the eighth embodiment while error remains generated therein;

FIG. 33 is a flowchart representing an example of selective display operations of the AV data receiving device according to the eighth embodiment while error remains generated therein;

FIG. 34 is a flowchart representing another example of selective display operations of the AV data receiving device according to the eighth embodiment while error remains generated therein;

FIG. 35 is a flowchart representing another example of selective display operations of the AV data receiving device according to the eighth embodiment while error remains generated therein;

FIG. 36 exemplifies an example of display of an AV reproduction unit in the eighth embodiment;

FIG. 37 is a flowchart representing another example of registering operations of the AV data receiving device according to the eighth embodiment while error remains generated therein;

FIG. 38 is a flowchart representing another example of registering operations in the AV data receiving device according to the eighth embodiment while error remains generated therein;

FIG. 39 is a flowchart representing another example of selective display operation of the AV data receiving device according to the eighth embodiment while error remains generated therein;

FIG. 40 is a flowchart representing another example of selective display operations in the AV data receiving device according to the eighth embodiment while error remains generated therein;

FIG. 41 is a simplified block diagram exemplifying an internal constitution of an AV data transmitting device according to the ninth embodiment of the present invention;

FIG. 42 is a flowchart representing provisional halting operations of the AV data transmitting device according to the ninth embodiment;

FIG. 43 is a flowchart representing operations for resuming reproduction in the AV data transmitting device according to the ninth embodiment;

FIG. 44 is a time chart representing an example of serial operations of the AV data transmitting device, AV data receiving device, and the AV data source unit according to the ninth embodiment;

FIG. 45 is a time chart representing another example of serial operations of the AV data transmitting device, AV data receiving device, and the AV data source unit according to the ninth embodiment;

FIG. 46 is a diagram exemplifying the recorded condition of a packet for recording AV data;

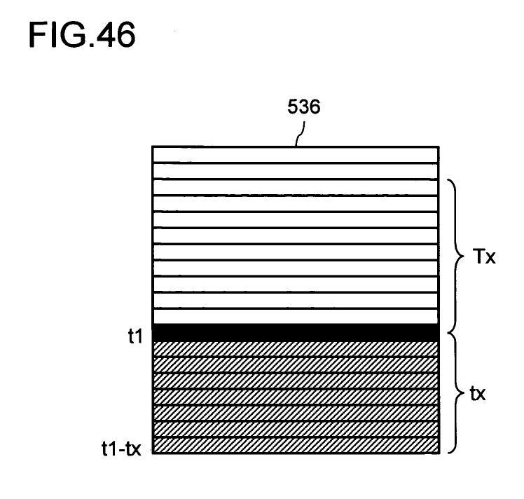

FIG. 47 is a schematic diagram for explanatory of an AV data radio communication system according to the tenth embodiment of the present invention;

FIG. 48 is a time chart representing an example of serial operations of the AV data transmitting device and the AV data receiving device according to the tenth embodiment;

FIG. 49 is a schematic diagram for explanatory of an AV data radio communication system according to the eleventh embodiment of the present invention;

FIG. 50 is a time chart representing an example of serial operations performed by the AV data transmitting device and the AV data receiving device according to the eleventh embodiment;

FIG. 51A to 51F are respectively a schematic diagram for explanatory of an AV data radio communication system according to the twelfth embodiment of the present invention;

FIG. 52 is a flowchart representing serial operations for setting transmitting function to the AV data transmitting device according to the twelfth embodiment;

FIG. 53A to 53D are respectively a schematic diagram for explanatory of the AV data radio communication system according to the twelfth embodiment;

FIG. 54 is a flowchart representing serial operations for setting transmitting function to the AV data transmitting device according to the twelfth embodiment;

FIG. 55A to 55C are respectively a schematic diagram for explanatory of an AV data radio communication system according to the thirteenth embodiment of the present invention;

FIG. 56 is a flowchart representing serial operations for setting transmitting function to an AV data transmitting device according to the thirteenth embodiment;

FIG. 57 is a schematic diagram for explanatory of a conventional AV data radio communication system;

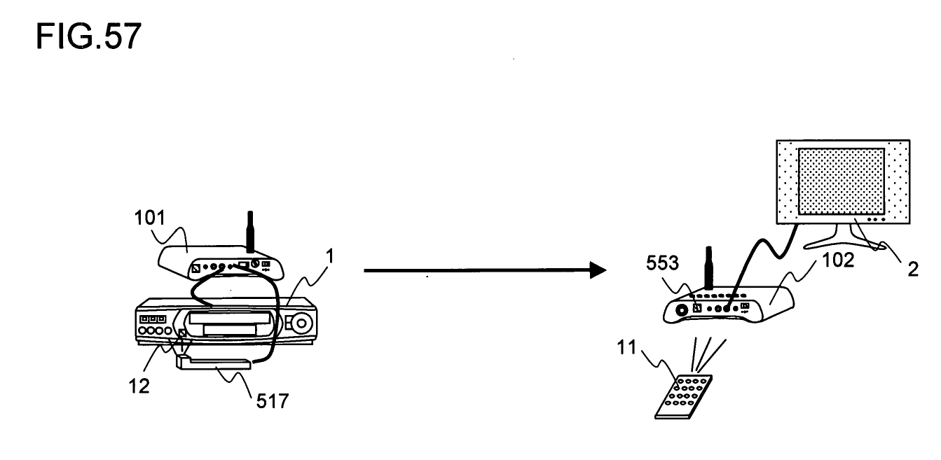

FIG. 58 is a simplified block diagram representing an internal constitution of a conventional AV data transmitting device; and

FIG. 59 is a simplified block diagram representing an internal constitution of a conventional AV data receiving device.

### DESCRIPTION OF THE PREFERRED EMBODIMENTS

The First Embodiment:

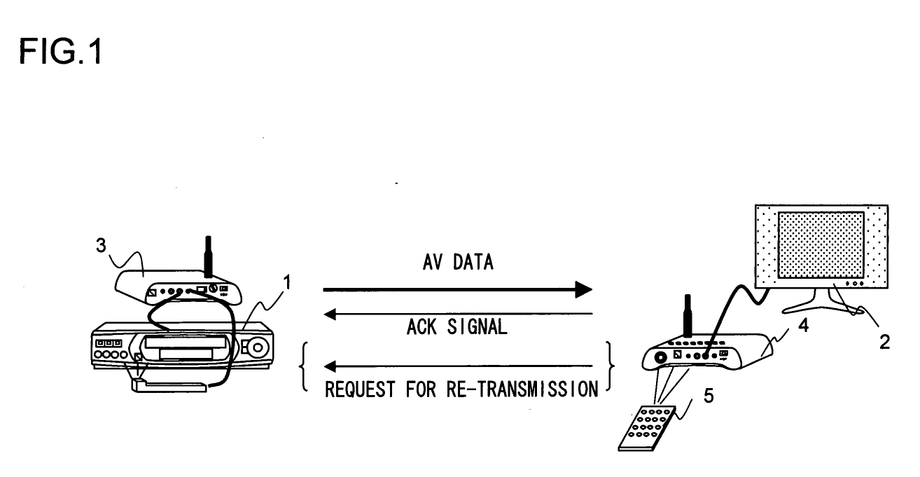

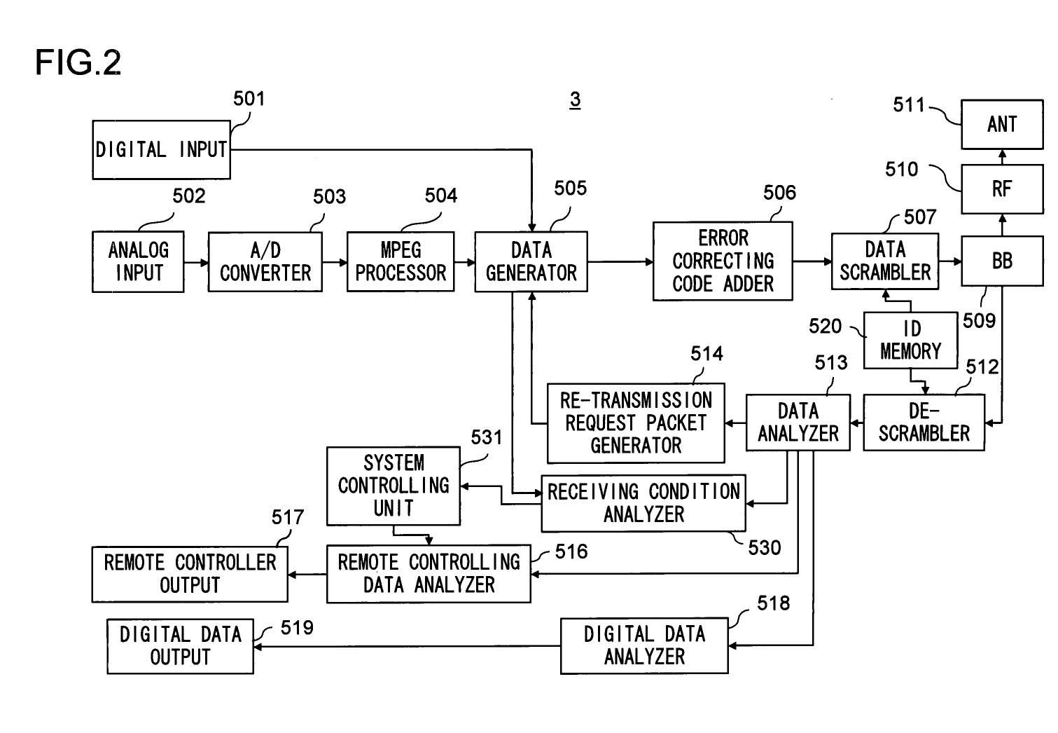

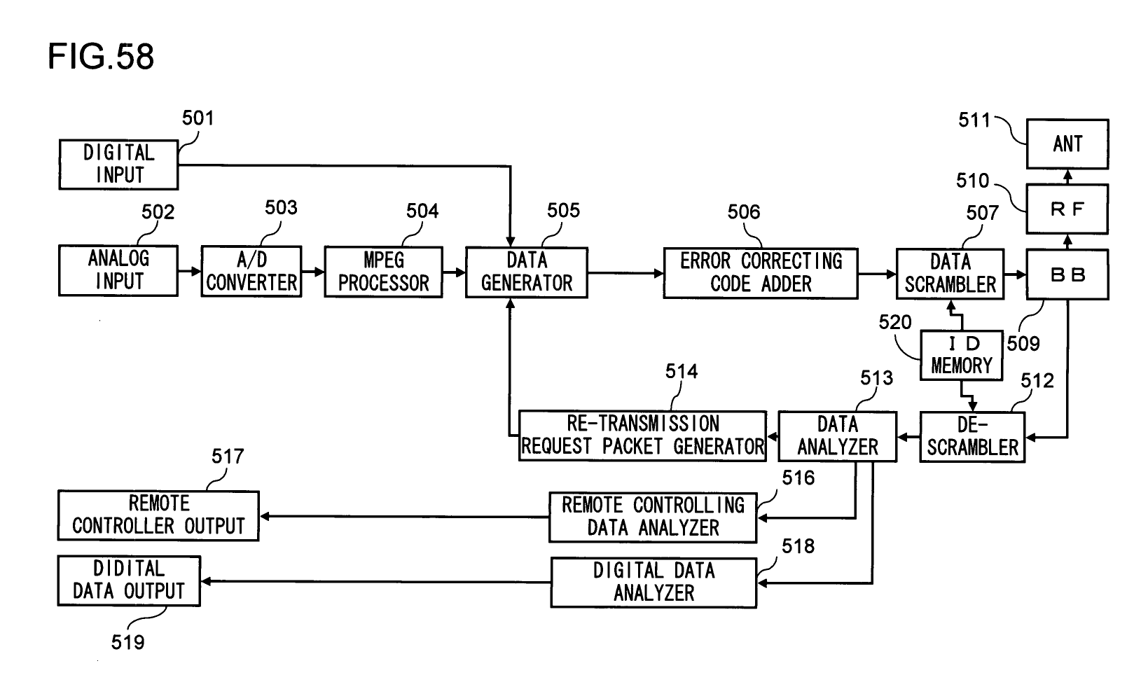

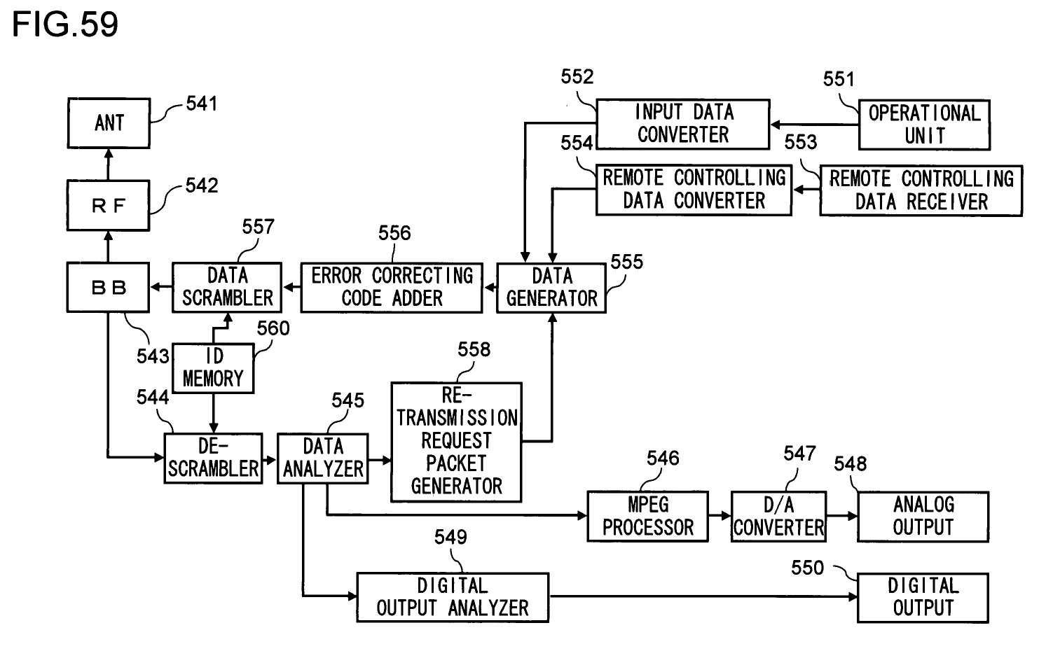

Referring now to the accompanying drawings, the first embodiment of the present invention is described below. FIG. 1 is a simplified block diagram representing an overall constitution of an AV data radio communication system according to the first embodiment of the present invention. FIG. 2 is a simplified block diagram representing an internal constitution of an AV data transmitting device according to the first embodiment of the present invention. Note that those components shown in FIG. 2 identical to those shown in FIG. 58 are respectively designated by identical reference numerals, wherein detailed descriptions on those components are thus deleted. Note also that the internal constitution of the AV data receiving device used for implementing the first embodiment of the present invention is identical to that is shown in FIG. 59.

The AV data radio communication system shown in FIG. 1 essentially consists of the following: an AV data transmitting device 3 connected to an AV source apparatus 1 via a cable; an AV data receiving device 4 connected to an AV reproduction apparatus 2 via a cable; and a remote controller 5 communicating with the AV data receiving device 4 with infrared rays. In this case, by providing the AV data transmitting device 3 with an ID code A for transmitting AV data and also by providing the AV data receiving device 4 with an ID code A for receiving AV data, the AV data transmitting device 3 and the AV data receiving device 4 are connected to each other so as to be able to communicate with each other.

Further, as shown in FIG. 2, the AV data transmitting device 3 is constituted with an integration of the AV data transmitting device shown in FIG. 58 with a receiving condition analyzer 530, which confirms the receiving condition of the AV data receiving device 4 by referring to the data receiving condition in a data analyzer 513, wherein the AV data transmitting device 3 is further added with a system controlling unit 531, which generates a unit operating data based on the receiving condition of the AV data receiving device 4 confirmed by the receiving condition analyzer 530 and then transmits the generated data to a remote controller data analyzer 516.

In the AV data radio communication system including the AV data transmitting device 3, only when the AV data receiving device 4 normally receives an AV data transmitted from the AV data transmitting device 3, the AV data receiving device 4 in a data generator 555 generates an ACK signal for designating that the AV data has normally been received by a data generator 555. The ACK signal may be generated every predetermined period of time or every predetermined number of packet. The ACK signal is then added with an error correcting code by an error correcting code adder 556, and then, the error-correcting code-added ACK signal is enciphered based on the ID code A stored in an ID memory 560 by a data scrambler 557. The AV data receiving device 4 transmits the enciphered ACK signal to the AV data transmitting device 3 via a base-band 543, a high-frequency amplifying circuit 542, and an antenna 541.

In the event if the AV data transmitted from the AV data transmitting device 3 has not been received by the AV data receiving device 4 in the normal condition, a retransmission request packet generator 558 identifies the packet that was not normally received, and then generates a retransmission request packet designating the packet that was not normally received. Next, based on the retransmission request packet generated by the retransmission request packet generator 558, the data generator 555 generates a retransmission request signal. Next, the retransmission request signal is added with an error-correcting code by the error-correction code adder 556. Next, the retransmission request signal added with the error-correcting code is enciphered based on the ID code A by the data scrambler 557, and then transmitted to the AV data transmitting device 3 via the base band 543, the high-frequency amplifying circuit 542, and the antenna 541.

When the AV data receiving device 4 transmits the ACK signal or the retransmission request signal, simultaneously, the AV data transmitting device 3 receives the ACK signal or the retransmission request signal via an antenna 511, a high-frequency amplifying circuit 510, and a base band 509. Next, the ACK signal or the retransmission request signal is respectively deciphered, by a descrambler 512, based on the ID code A stored in the ID memory 520. Next, the data analyzer 513 confirms the ACK signal or the retransmission request, and then notifies the receiving condition analyzer 530 that the ACK signal or the retransmission request signal have been received. In this case, if it is confirmed that the received signal corresponds to the re-transmission request signal, a retransmission request packet generator 514 generates AV data packets requested based on the retransmission request signal, and then transmits the AV data packet to a data generator 505.

By referring to the condition of the received ACK signal or retransmission request signal, the received condition analyzer 530 confirms the receiving condition of the AV data receiving device 4, and then, based on the confirmed receiving condition, causes the system controlling unit 531 to set operating condition of the AV source apparatus 1. Based on this arrangement, if the system controlling unit 531 identifies that the receiving condition of the AV data receiving device 4 has actually been degraded, the system controlling unit 531 generates a unit operating data for causing reproduction of the AV data to be halted provisionally in the AV source apparatus 1, and then, transmits the unit operating data to the remote controller data analyzer 516. On the other hand, if it is identified that the receiving condition of the AV data receiving device 4 remains satisfactory, the system controlling unit 531 generates another unit operating data for releasing the AV data from the state of provisionally halted reproduction in the AV source apparatus 1, and then, transmits the unit operating data to the remote controller data analyzer 516.

Serial operations performed by the AV data transmitting device 3 for identifying the receiving condition of the AV data receiving device 4 are described below.

1. The First Example of Serial Operations for Identifying the Receiving Condition of the AV Data Receiving Device 4:

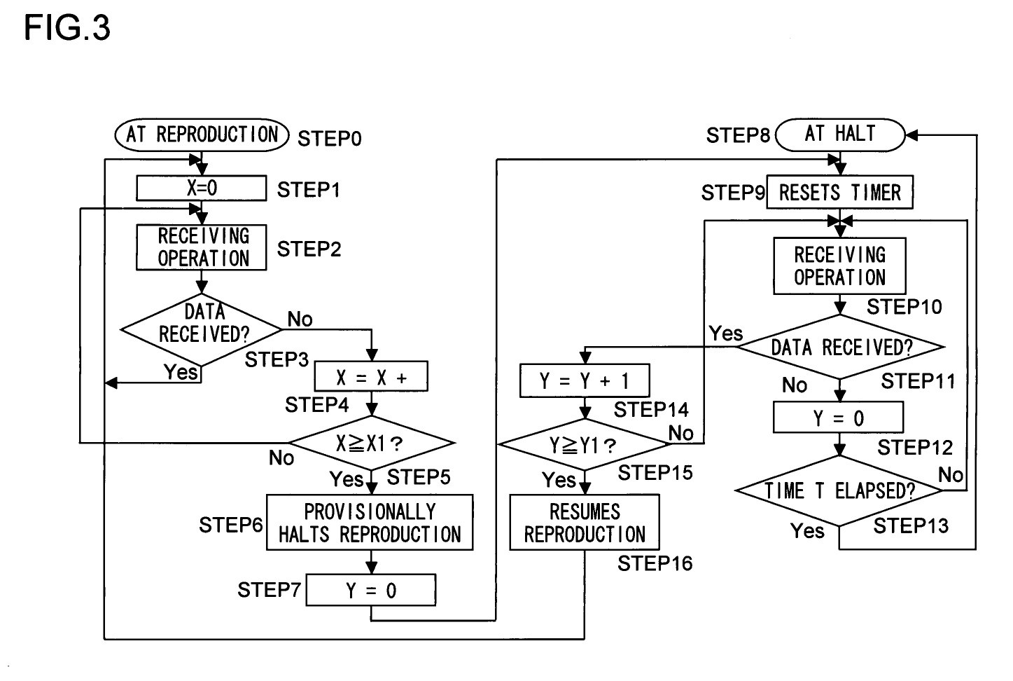

First, referring to a flowchart shown in FIG. 3, the first example of serial operations for identifying the receiving condition is described below. Initially, in step 0, the AV source apparatus 1 performs its reproducing operation, and the data generator 505 generates packet comprising AV data. Next, step 1 is entered, in which count value X of a non-receiving counter (not shown) inside of the receiving condition analyzer 530 is reset to zero. Note that the non-receiving counter is not used for counting the receiving rounds, but it counts up the rounds of non-received ACK signals or retransmission request signals from the AV data receiving device 4. Next, step 2 is entered, in which, signals from the AV data receiving device 4 are received via the antenna 510, the high-frequency amplifying circuit 511, and the base band 509, at a predetermined timing. Next, step 3 is entered, in which the data analyzer 513 checks and confirms whether the ACK signal or the retransmission request signal has been received from the AV data receiving device 4, or not.

In the event that reception of the ACK signal or the retransmission request signal has been confirmed (YES), then, the reception of the ACK signal or the retransmission request signal is notified of the receiving condition analyzer 530 of, then, operating mode shifts to step 1. If it is identified that neither the ACK signal nor the retransmission request signal has been received (NO), the receiving condition analyzer 530 is notified of the failure of the reception of the ACK signal or the retransmission request signal, thus causing operating mode to proceed to step 4, in which the count value of the above non-receiving counter is counted up by one.

When the count value X of the non-receiving counter has been counted up by one in step 4, then step 5 is entered, in which it is identified whether the count value X has exceeded a predetermined value X1 or not. If the count value X still remains within the value X1 (NO), then operating mode shifts to step 2. On the other hand, if it is identified that the count value has exceeded the predetermined value X1 (YES), then, the receiving condition analyzer 530 identifies that the receiving condition of the AV data receiving device 4 has actually been degraded, thus entering step 6, in which the system controlling unit 531 generates a unit operating data for causing the reproduction of AV data to be halted provisionally.

While step 6 is underway, a unit operating data for provisionally halting reproduction of the above AV data is converted into a remote controlling data by the remote controller data analyzer 516, and then, the remote controlling data is output from an remote controller output terminal 517. Upon reception of the remote controlling data via an infrared communication, the AV source apparatus 1 causes reproduction of the above AV data to be halted provisionally. After completion of step 6, every period of transmitting the AV data, the data generator 505 generates a data packet from the AV data at the time at which reproduction is provisionally halted, and then, the data packet is added with an error correcting code by the error correction code adder 506. The error-correcting-code added data packet is then enciphered by the ID code A of the data scrambler 507. Finally, the AV data transmitting device 3 transmits the enciphered data packet to the AV data receiving device 4 via the base band 509, the high-frequency amplifying circuit 510, and the antenna 511. When the AV source apparatus 1 provisionally halts its operation, the AV data transmitting device 3 transmits an AV data at the time at which the AV source apparatus 1 provisionally halted own operation. However, not only this data, the AV data transmitting device 3 may also transmit a previously stored AV data consisting of a still image. The time exactly corresponding to the provisionally halted scene is stored in the system controlling unit 531 as the reproduction resuming time.

While the AV source apparatus 1 remains in a halt during step 8, or after the AV source apparatus 1 was instructed to halt itself provisionally during step 6, when the count value Y of a receiving counter (not shown) set inside of the receiving condition analyzer 530 for counting the received rounds of the ACK signal from the AV data receiving device 4 is reset to zero during step 7, this also causes a timer (not shown) inside of the receiving condition analyzer 530 to be reset to zero during step 9. Concurrently, in order to receive the ACK signal from the AV data receiving device 4, the AV data transmitting device 3 generates, for confirming the reception of the AV data in the AV data receiving device 4, a data including still image generated when starting the provisionally halted period, and then transmits this data to the AV data receiving device 4. Next, step 10 is entered, in which the AV data transmitting device 3 performs receiving operation of signal from the AV data receiving device 4 at a predetermined timing via the antenna 511, the high-frequency amplifying circuit 510, and the base band 509.

Next, step 11 is entered, in which the data analyzer 513 confirms whether the ACK signal or the retransmission request signal has been received from the AV data receiving device 4 or not. If the reception of the ACK signal or the retransmission request signal from the AV data receiving device 4 were not confirmed (NO), then, step 12 is entered, in which the count value Y of the receiving counter is reset to zero. Next, step 13 is entered, in which it is confirmed whether a predetermined period of time T has already elapsed based on the time measured by a timer (not shown) or not. If the time T is already past (YES), and then step 8 is entered, in which the system controlling unit 531 generates a unit operating data for causing the AV source apparatus 1 to halt own operation, and then transmits this data as a remote controlling data via infrared communication so as to halt operation of the AV source apparatus 1. If the predetermined period of time T were not past (NO), operating mode shifts to step 10.

While step 11 is underway, when reception of the ACK signal or the retransmission request signal from the AV data receiving device 4 has been confirmed (YES), the count value Y of the receiving counter is counted up by one in step 14, and then, step 15 is entered, in which it is confirmed whether the count value Y has exceeded the predetermined value Y1 or not. If the count value Y still remains within the value Y1 (NO), operating mode proceeds to step 10.

When it is confirmed that the count value Y has exceeded the predetermined value Y1 (YES), step 16 is entered, in which the receiving condition analyzer 530 identifies that the AV data receiving device 4 remains in the data receivable condition, and then causes the system controlling unit 531 to generate a unit operating data including the reproduction resuming time for resuming reproduction and a command for instructing to resume the reproduction of the AV data. Simultaneously, by way of transmitting remote controlling data via infrared communication, the AV source apparatus 1 is enabled to resume reproduction of AV data. When the reproducing operation is resumed from the scene at the reproduction resuming time in the AV source apparatus 1, operating mode shifts to step 1.

2. The Second Example of the Operation for Identifying the Receiving Condition:

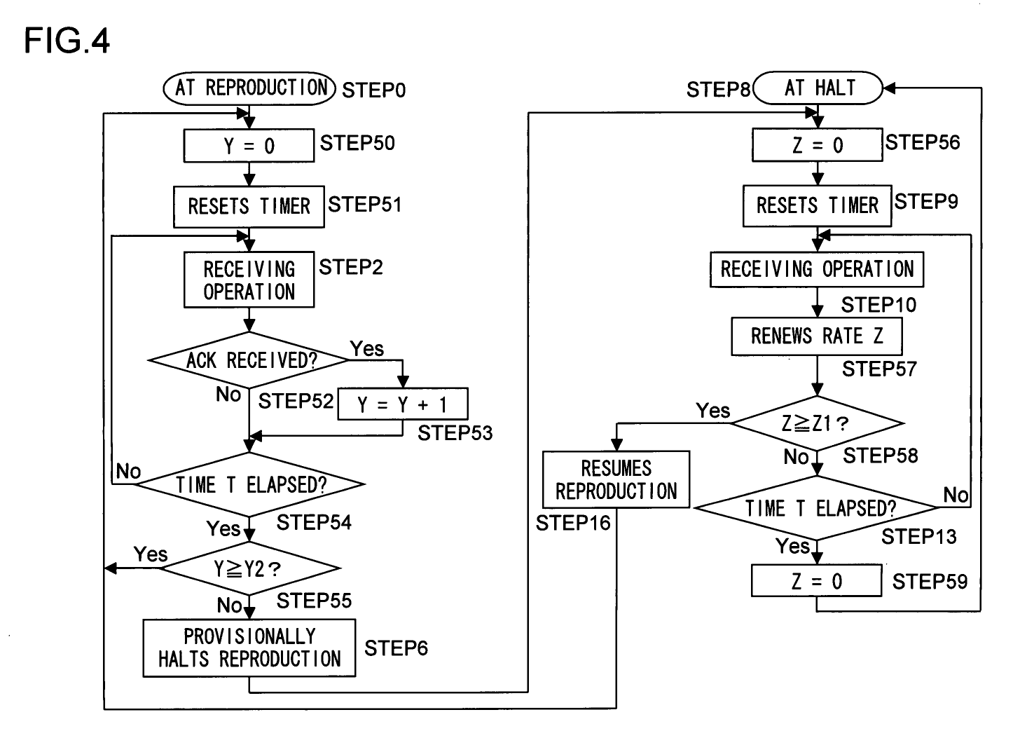

Next, referring to a flowchart shown in FIG. 4, the second example of the operation for identifying the receiving condition is described below. Note that, those operating steps shown in the flowchart in FIG. 4 performing those operations identical to those which are shown in the flowchart of FIG. 3 are respectively designated by identical step numbers, thereby deleting detailed description thereof. When the AV source apparatus 1 reproduces AV data in step 0, first, the count value Y of a receiving counter set inside of the receiving condition analyzer 530 is reset to zero in step 50. Here, this receiving counter counts up the received rounds of the ACK signals from the AV data receiving device 4. When step 51 is entered, a timer (not shown) set inside of the receiving condition analyzer 530 is reset to zero, and then, step 2 is entered, in which the AV transmitting device 3 performs receiving operation of signal from the AV data receiving device 4 at a specific timing.

Next, step 52 is entered, in which the receiving condition analyzer 530 confirms whether the AV transmitting device 3 has received the ACK signal during the receiving process in step 2, or not. If the reception of the ACK signal is confirmed (YES), the count value Y of the receiving counter is counted up by one in step 53. After counting up the count value Y by one during step 53 or when the reception of the ACK signal has not been confirmed (NO) in step 52, then, step 54 is entered, in which it is confirmed, from the time counted by the timer set inside of the receiving condition analyzer 530, whether a specific period of time “t” has already elapsed, or not.

If it is confirmed that a specific period of time “t” is already past (YES), then, step 55 is entered, in which it is confirmed whether the count value Y of the above receiving counter has exceeded a predetermined value Y2, or not. If the predetermined time “t” is not yet past (NO), then, step 2 is entered. If the count value Y exceeds the value Y2 (YES) during step 55, then, step 50 is entered. Conversely, if the count value Y is less than the predetermined value Y2 during step 55 (NO), then, step 6 is entered, in which infrared signal is transmitted to the AV source apparatus 1 so as to provisionally halt the reproduction. After executing the operation of step 6, the AV data transmitting device 3 generates a data packet from the provisionally halted AV data, and then transmits the data packet to the AV data receiving device 4 per AV data transmitting period.

When the AV source apparatus 1 remains in a halt during step 8, or when the AV source apparatus 1 is instructed to halt itself provisionally in step 6, step 56 is entered, in which receiving rate Z of the ACK signal from the AV data receiving device 4 is reset to zero, and then, step 9 is entered, in which the timer in the receiving condition analyzer 530 is reset to zero. Concurrently, in order to receive the ACK signal from the AV data receiving device 4, the AV data transmitting device 3 generates, for confirming reception of AV data, a data including still image at the moment of the provisional halt of the reproduction, and then transmits this data to the AV data receiving device 4. Next, step 10 is entered, in which the AV data transmitting device 3 receives signal from the AV data receiving device 4 at a predetermined timing.

Next, step 57 is entered, in which the received condition analyzer 530 renews the ACK receiving rate Z computed by dividing the cumulative rounds of the received ACK signals into the time measured by the timer after resetting the time. It is also possible to compute the ACK receiving rate by dividing the cumulative rounds of the received ACK signals into the receiving timing rounds. Here, step 9 is entered, in which, instead of resetting the timer, count value of a counter for counting the rounds of the receiving timing set inside of the receiving condition analyzer 530 is reset to zero.

Next, step 58 is entered, in which the receiving condition analyzer 530 confirms whether the ACK receiving rate Z renewed in step 57 has exceeded a predetermined rate Z1, or not. When the ACK receiving rate Z does not exceed the predetermined rate Z1 (NO), then, step 13 is entered, in which it is confirmed whether a predetermined period of time “T” has already elapsed, or not. When the elapse of the predetermined period of time “T” has been confirmed (YES), step 59 is entered, in which the ACK receiving rate Z is reset to zero, and then, step 8 is entered. If the predetermined time “T” were not yet past (NO), then operating mode shifts to step 10.

While step 58 is underway, if it is confirmed that the ACK receiving rate Z exceeds the predetermined rate Z1 (YES), then, step 16 is entered, in which the AV data transmitting device transmits the infrared signal to the AV source apparatus 1 so as to resume reproduction of AV data, and then, operating mode shifts to step 50.

3. Operation for Instructing Provisional Halt in the Course of Identifying the Receiving Condition:

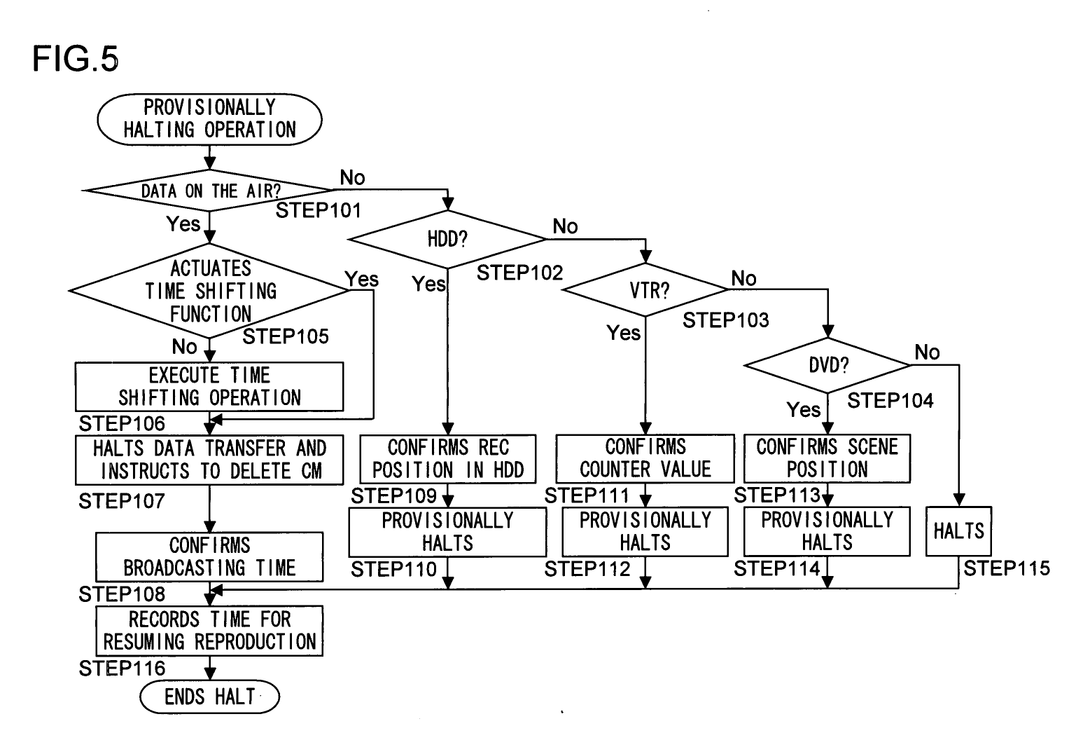

As described above, in compliance with the flowchart shown in FIG. 3 or 4, the AV data transmitting device 3 judges the actual receiving condition on the part of the AV data receiving device 4, and then based on the judged result, operating condition of the AV source apparatus 1 is set. However, in this case, depending on the kinds of the AV source apparatus 1 being connected, contents of the provisional halting operation subject to instructions are changeable. Provisional halting operations instructed for executing provisional halting of reproduction under step 6 shown in FIG. 3 and FIG. 4 is described by referring to the flowchart shown in FIG. 5 as follows.

When step 6 is entered, by referring to a header information of an AV data delivered to the data generator 505, the receiving condition analyzer 530 confirms in step 101 whether the AV data input from the linked AV source apparatus 1 corresponds to an AV data on the air received via a tuner, or not. If the AV data were not the one on the air (NO), then, step 102 is entered, in which the receiving condition analyzer 530 confirms whether the AV data corresponds to the one read out from a hard disc installed in the AV source apparatus 1, or not.

If the AV data were not read out from a hard disc (NO), then, step 103 is entered, in which the receiving condition analyzer 530 confirms whether the AV data has been read out from a video tape in a VTR installed in the AV source apparatus 1, or not. If the AV data were not read out from a video tape loaded in a VTR (NO), then, the receiving condition analyzer 530 further checks and confirms in step 104 whether the AV data has been read out from a DVD set inside of the AV source apparatus 1, or not.

Reverting to step 101, if the AV data corresponds to the one on the air received by a tuner from a broadcast program (YES), the receiving condition analyzer 530 checks to see if the AV source apparatus 1 is on the way of a time shifting operation, or not, in step 105. The term “time shifting operation” comprises a step of storing an AV data on the air and another step of reproducing the past AV data being stored. It is also possible to confirm whether the time-shifting operation is underway or not by causing the data generator 505 to compare the present time to the time of the transmission of an AV data delivered from the AV source apparatus 1. Alternatively, it is also possible to identify the time shifting operation by making the AV source apparatus 1 notify the AV data transmitting device 3 of the execution of the time shifting operation.

When it is confirmed that the AV data on the air has been transmitted instead of the time shifting operation (NO), step 106 is entered, in which the system controlling unit 531 generates a unit operating data for instructing execution of the time shifting operation. When generating the unit operating data in step 106 so as to instruct execution of the time shifting operation, or when it is confirmed in step 105 that the time shifting operation is underway (YES), operating mode proceeds to step 107, in which the system controlling unit 531 further generates another unit operating data for instructing to suspend transmission of AV data beyond the following scene and execute a recording operation by way of eliminating commercial advertising programs.

Next, the unit operating data generated by the system controlling unit 531 is converted into a remote controlling data by the remote controlling data analyzer 516, and then the remote controlling data is output as an infrared signal from the remote controller output terminal 517. Next, by referring to the header information of the AV data transmitted from the AV source apparatus 1, the data generator 505 confirms the time programmed for broadcasting the corresponding scene of this AV data while step 108 is underway.

Accordingly, until resuming the reproduction, the AV source apparatus 1 keeps on recording those AV data beyond the scene at the programmed broadcasting time, and the AV source apparatus 1 halts transmission of AV data beyond the confirmed scene. In this case, those AV data corresponding to commercial advertising programs are excluded from the recording. It is possible to allow the AV source apparatus 1 to keep on transmitting the AV data that becomes the exact scene corresponding to the confirmed programmed broadcasting time against the AV data transmitting device 3. It is also allowable to store those AV data in the data generator 505 of the AV data transmitting device 3.

If the AV data were identified as the one read out from a hard disc installed in the AV source apparatus 1 during step 102 (YES), then, step 109 is entered, in which the data generator 505 confirms the recorded position of the AV data transmitted from the AV source apparatus 1 in the hard disc. Next, step 110 is entered, in which the system controlling unit 531 generates another unit operating data so as to instruct that any AV data beyond the exact scene at the recorded position shall neither be read out from the hard disc nor transmitted from the AV source apparatus 1, and then, the unit operating data is transmitted to the AV source apparatus 1.

Accordingly, until resuming the reproduction process, the AV source apparatus 1 halts transmission of those AV data beyond the scene confirmed at the moment step 6 was entered. In this case, it is also allowable for the AV source apparatus 1 to keep on transmitting the AV data at the confirmed recorded position of the hard disc to the AV data transmitting device 3. Alternatively, it is also allowable to store the above AV data in the data generator 505 of the AV data transmitting device 3.

If the AV data were identified as the one read out from a video tape loaded in a VTR while step 103 was underway (YES), then, step 111 is entered, in which the data generator 505 confirms the counter value of the AV data transmitted from the AV source apparatus 1. This counter value is counted up in correspondence with the reproduction speed of the VTR and represents the position at which a specific scene on a video tape is recorded. When operating mode shifts to step 112, the system controlling unit 531 generates another unit operating data for instructing provisional halt of the reproducing operation of the VTR.

If the AV data were identified as the one read out from a DVD while step 104 was underway (YES), then, step 113 is entered, in which the data generator 505 confirms the position of a specific scene by referring to the chapter position or the like of the AV data transmitted from the AV source apparatus 1. Next, step 114 is entered, in which another unit operating data instructing provisional halt of the reproducing operation of the DVD is transmitted to AV source apparatus 1.

Accordingly, upon reception of the instructions generated in the course of executing step 112 or 114, the AV source apparatus 1 provisionally halts reproduction of AV data stored in a video tape or in a DVD until being instructed to resume the reproduction. In this case, it is allowable for the AV source apparatus 1 to keep on transmitting the AV data corresponding to a specific scene at the provisionally halted position to the AV data transmitting device 3. Alternatively, it is also allowable to store the above AV data in the data generator 505 of the AV data transmitting device 3.

If the AV data were identified as the one not being read out from a DVD as in the case of such an AV source apparatus 1 devoid of the function for recording the AV data on the air (NO) while step 104 was underway, then, step 115 is entered, in which the system controlling unit 531 generates another unit operating data for halting operations of the AV source apparatus 1, and then transmits the unit operating data to the AV source apparatus 1 before completing predetermined operating routines. In consequence, the AV source apparatus 1 is brought to a halt. In this case, it is also allowable to store the AV data representing a specific scene immediately before being halted in the data generator 505, and then, transmit this AV data to the AV data receiving device 4. Alternatively, it is also allowable to previously store such an AV data becoming still image in the data generator 505 and then transmit this AV data to the AV data receiving device 4.

Simultaneous with execution of serial steps 108, 110, 112, and 114, those data pertaining to the programmed broadcasting time confirmed via step 107, recorded position confirmed via step 109, the counter value confirmed via step 111, and the position of the reproducible scene confirmed via step 113, are respectively delivered to the system controlling unit 531 via the receiving condition analyzer 530. After storing these data in the system controlling unit 531 as the data representing the time of resuming reproduction in the final step 116, all the operating routines are terminated.

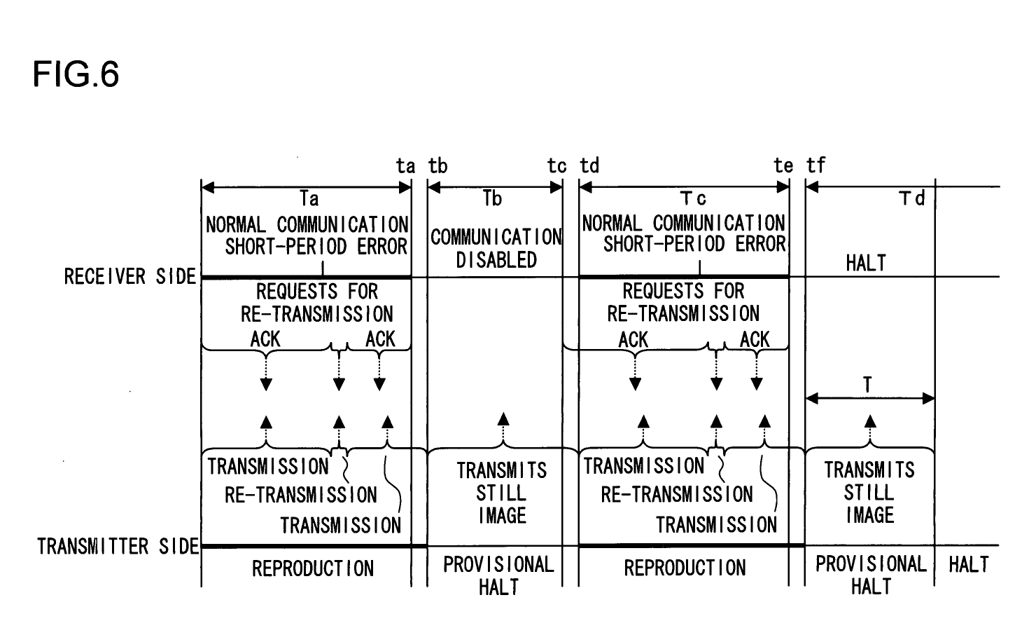

Operating examples of the AV data transmitting device 3 and the AV data receiving device 4 are described below by referring to a timing chart shown in FIG. 6. Based on an assumption that the AV data receiving device 4 normally receives AV data during a period Ta, in response to an AV data transmitted from the AV data transmitting device 3, the AV data receiving device 4 transmits the ACK signal or the retransmission request signal.

Concretely, when the number of the packet of AV data received has reached a predetermined number, or when a predetermined period of time has passed, the ACK signal or the retransmission request signal is transmitted from the AV data receiving device 4. More particularly, during the period Ta, there is a very short period of time in which the AV data transmitted from the AV data transmitting device 3 failed to be received in the normal condition. In the meanwhile, the AV data receiving device 4 transmits the retransmission request signal, and then, in response to the retransmission request signal, the re-transmitted AV data is normally received by the AV data receiving device 4.

In order to prevent the AV data transmitted from the AV data transmitting device 3 from colliding with the ACK signal or the retransmission request signal transmitted from the AV data receiving device 4 at the radio wave transmission route, the period specified for enabling the AV data transmitting device 3 to transmit AV data is set discretely from the period specified for enabling the AV data receiving device 4 to transmit the ACK signal or the retransmission request signal. Further, when the AV data receiving device 4 transmits the retransmission request signal, the AV data transmitting device 3 transmits the AV data being asked for retransmission over again.

When the AV data receiving device 4 has entered into the state incapable of exchanging radio communication exactly at the time “ta”, the AV data transmitting device 3 confirms that the number of the rounds that failed to normally receive the ACK signal or the retransmission request signal has reached “a predetermined number of rounds X 1” at the time “tb” or confirms that the number of rounds of receiving the ACK signal at a preset time “T2′ has becomes less than or equal to “a predetermined number of rounds Y2”. Accordingly, when the time “tb” has come, the AV data transmitting device 3 provisionally halts operation of the AV source apparatus 1, and simultaneously, in order to confirm the ACK signal from the AV data receiving device 4, the AV data transmitting device 3 commences transmission of data signals including AV data such as still image.

While an ensuing period Tb” remains, the AV data receiving device 4 still remains in the state incapable of exchanging radio communication. On the other hand, the AV data transmitting device 3 continuously transmits various data signals including AV data such as still image. Then, when the AV data receiving device 4 has entered into the state capable of normally exchanging radio communication exactly at the time “tc”, the ACK signal in response to the data signal transmitted from the AV data transmitting device 3 is transmitted from the AV data receiving device 4.

Next, when the time “td” has come, the AV data transmitting device 3 confirms that the number of the rounds of receiving the ACK signal from the AV data receiving device 4 has exceeded the predetermined value Y1 or the rate of receiving the ACK signal from the AV data receiving device 4 has exceeded the predetermined rate Z1. Accordingly, when the time “td” has come, the AV data transmitting device 3 allows the AV source apparatus 1 to resume a reproducing operation exactly from the scene previously brought under a provisional halt, and at the same time, also allows resumption of the reproduction of the AV data beyond the scene previously brought under a provisional halt.

As described above, by resuming transmission of AV data, reproducing operation is also resumed. While the AV data receiving device 4 remains in the state capable of normally exchanging communication during a period “Tc”, as in the case of period “Ta”, in response to the AV data transmitted from the AV data transmitting device 3, the AV data receiving device 4 transmits the ACK signal or the retransmission request signal. If transmission of AV data is resumed during the period “Tc” while an AV data on the air is received or transmitted during the period “Ta”, it is allowable for the AV source apparatus 1 to quickly reproduce AV data at a rate faster than the normal reproducing speed until catching up the AV data on the air.

Upon arrival at the time “Tc”, when the power supply source of the AV data receiving device 4 is turned OFF thereby making the AV data receiving device 4 no longer capable of exchanging communication, in response, the AV data transmitting device 3 confirms that the number of rounds incapable of receiving the ACK signal or the retransmission request signal has reached “a predetermined number of rounds X 1” at the time “tf”, or the AV data transmitting device 3 confirms that the rounds of receiving the ACK signal has become less than or equal to the predetermined rounds Y2 at a preset time T2. Accordingly, when the time “tf” has come, the AV data transmitting device 3 puts the AV source apparatus 1 into the state of provisionally halting own operation, and then transmits data signal such as still image AV data to the AV source apparatus 1.

In the ensuing period Td, in the case in which the AV data transmitting device 3 doesn't confirm the reception of the ACK signal from the AV data receiving device 4 until a preset time T is past, and also in the case in which the rounds of receiving the ACK signal fails to reach a predetermined number of rounds Y1 or the receiving rate of the ACK signal fails to reach a predetermined rate Z1, then, the AV data transmitting device 3 puts the AV source apparatus 1 into the state of fully halting own operation. Simultaneously, transmission of data signal including still image AV data is brought to a halt.

As described above, according to this embodiment, availing of proper function of the AV data transmitting device 3, it is possible to confirm the receiving condition of the AV data receiving device 4. Accordingly, based on the actual receiving condition confirmed by the AV data transmitting device 3, it is possible to properly control the AV source apparatus 1 into the state of a provisional halt, reproduction mode, or stoppage. Accordingly, in the event if the receiving condition of the AV data receiving device 4 has become abnormal on the way of reproducing AV data, it is possible to provisionally halt operation of the AV data receiving device 4, and then, when the receiving condition of the AV data receiving device 4 has become normal again, it is possible to resume reproduction of the corresponding AV data exactly from the provisionally halted scene.

According to this embodiment, after provisionally halting operation of the AV source apparatus 1, in order to enable the AV data transmitting device 3 to confirm the ACK signal from the AV data receiving device 4, data signal is transmitted. However, when the AV data receiving device 4 transmits a data signal in place of the ACK signal so as to enable the AV data transmitting device 3 to confirm the receiving condition of the AV data receiving device 4, it is allowable to cause the AV data transmitting device 3 to provisionally halt its transmitting operation.

Further, as in the case of the flowchart shown in FIG. 5, whenever drawing judgment in the processes corresponding to steps 101 to 104, judgment may also be drawn by way of those serial processes described below. Initially, when a user operates a remote controller 5, the kind of AV data is transmitted to the AV data receiving device 4 with infrared signal output from the remote controller 5. In response, the AV data receiving device 4 transmits radio signal to the AV data transmitting device 3 so as to notify the AV data transmitting device 3 of the kind of AV data.

In this embodiment, it is so arranged that the AV data receiving device 4 transmits the ACK signal and the retransmission request signal. Alternatively, it is also practicable to cause the AV data receiving device 4 to transmit a NACK signal designating the failure to normally receive data signal so as to enable the AV data transmitting device 3 to judge the actual receiving condition of the AV data receiving device 4 based on the serial rounds of receiving the NACK signal and the receiving rate thereof. It is also allowable to confirm whether the receiving condition of the AV data receiving device 4 has actually worsened or not based on the serial rounds of receiving signal from the AV data receiving device 4, and also confirm whether the receiving condition of the AV data receiving device 4 has actually been improved or not based on the receiving rate of signal from the AV data receiving device 4. On the other hand, conversely, it is also allowable to confirm whether the receiving condition of the AV data receiving device 4 has actually been worsened or not based on the receiving rate of signal from the AV data receiving device 4 and also confirm whether the receiving condition of the AV data receiving device 4 has actually been improved based on the serial rounds of receiving signal from the AV data receiving device 4.

The Second Embodiment:

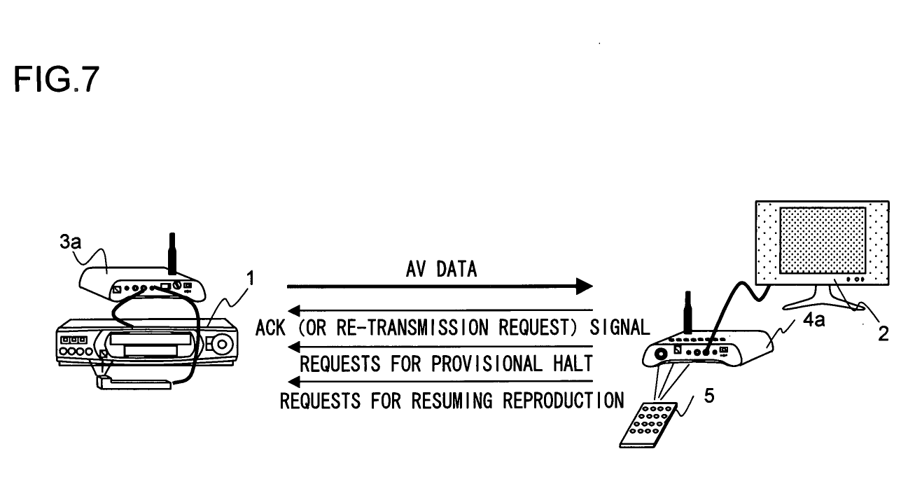

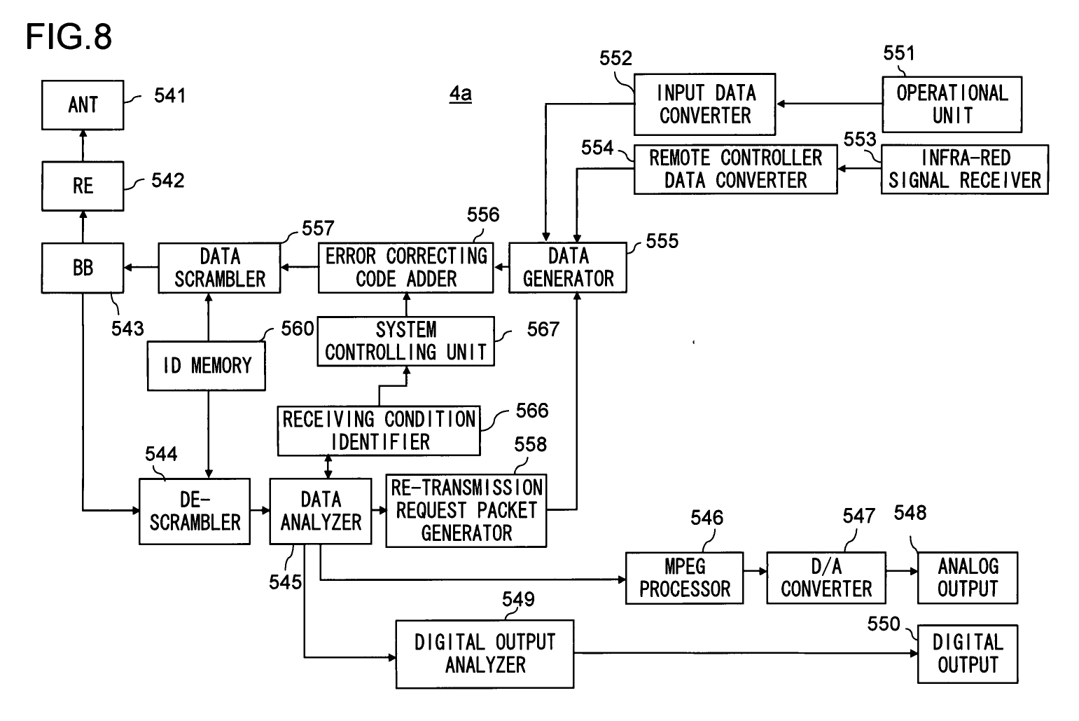

Referring now to FIG. 7 and FIG. 8, the second embodiment of the present invention is described below. FIG. 7 is a simplified block diagram representing an AV data radio communication system according to the second embodiment. FIG. 8 is a simplified block diagram representing an internal constitution of an AV data receiving device according to the second embodiment. Those components shown in FIG. 8 identical to those shown in FIG. 59 are respectively designated by identical reference numerals, and thus detailed description thereof is deleted. Further, internal constitution of an AV data transmitting device related to the second embodiment is identical to the one shown in FIG. 58.

The AV data radio communication system shown in FIG. 7 comprises the following: an AV data transmitting device 3a connected to an AV source apparatus 1 via a cable, an AV data receiving device 4a connected to an AV reproduction apparatus 2 via a cable, and a remote controller 5 which communicates with the AV data receiving device 4a with infrared signal. The AV data transmitting device 3a is linked with the AV data receiving device 4a via an ID code A provided for enabling them to communicate with each other.

As shown in FIG. 8, the AV data receiving device 4a provided for by the second embodiment basically consists of an AV data receiving device shown in FIG. 59 added with the following: a receiving condition identifier 566 which confirms the receiving condition of the AV data receiving device 4a by referring to the data receiving condition in a data analyzer 545, and a system controlling unit 567 which initially generates a data for representing operation based on the receiving condition of the AV data receiving device 4a confirmed by the receiving condition identifier 566, and then transmits the data to an error correcting code adder 556. As in the case of the AV data receiving device 4 of the first embodiment, the AV data receiving device 4a of the second embodiment causes a data generator 555 to generate an ACK signal and a retransmission request signal, and then transmits these signals to the AV data transmitting device 3a.

Based on the judgment drawn by the receiving condition identifier 566 whether decoding is normally performed by the data analyzer 545 or not, the AV data receiving device 4a confirms own receiving condition. By referring to the confirmed receiving condition, the system controlling unit 567 sets operating condition of the AV source apparatus 1. The system controlling unit 567 further generates a unit operating data for instructing the established operating condition. Next, the error correcting code adder 556 adds an error correcting code to the unit operating data. The error correcting code added unit operating data is then enciphered based on an ID code A stored in an ID memory 560 by a data scrambler 557. The enciphered operating data is then externally transmitted via a base band 543, a high-frequency amplifying circuit 542, and an antenna 541.

The AV data transmitting device 3a receives the unit operating data transmitted from the AV data receiving device 4a via an antenna 511, a high-frequency amplifying circuit 510, and a base band 509. The received unit operating data is then deciphered by a descrambler 512, and then decoded by the data analyzer 513. Next, the unit operating data decoded by the data analyzer 512 is then delivered to a remote controlling data analyzer 516 so as to be converted into a remote controlling data, which is then transmitted to the AV source apparatus 1 as an infrared signal via a remote controller output terminal 517.

Operation for identifying own receiving condition performed by the AV data receiving device 4a is described below.

1. The First Example of Operation for Identifying the Receiving Condition:

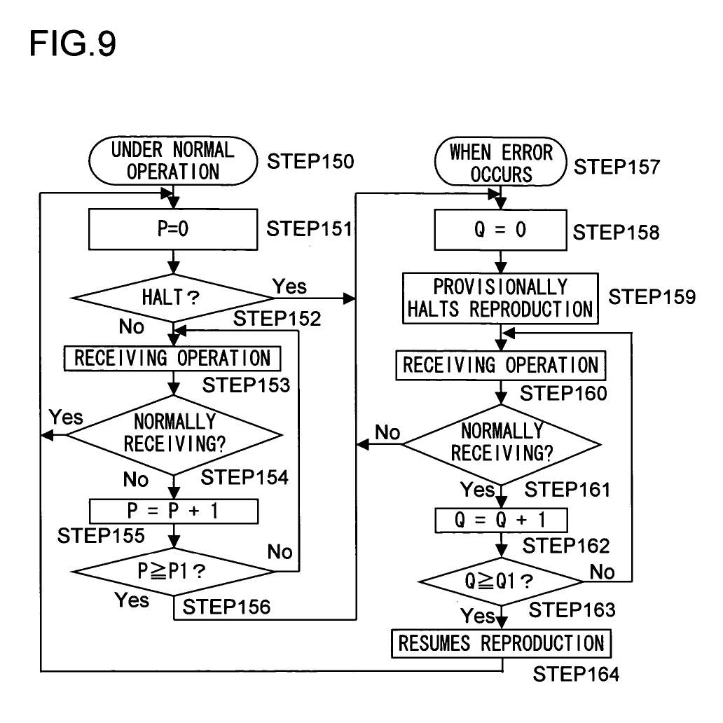

First, referring to the flowchart shown in FIG. 9, the first example of the operation for identifying the receiving condition is described below. While step 150 remains, AV data reproducing operation is normally performed by normally receiving AV data from the AV data transmitting device 3a. While this condition remains, first, in order to count the rounds of the receiving error, the count value P of an error counter (not shown) is reset to zero in the following step 151. Next, step 152 is entered, in which it is confirmed whether the instructions have been generated so as to turn the power OFF to put the system into a halt or not by referring to a data signal given to a data generator 555 via an operating unit 551 and a data converter 552 or via a remote controlling data receiving unit 553 and a remote controlling data converter 554. If the instructions for turning the power OFF were not generated (NO), and then, step 153 is entered, in which operation for receiving signal from the AV data transmitting device 3a is performed at a predetermined timing via the antenna 541, the high frequency amplifying circuit 542, and the base band 534. Then, step 154 is entered, in which the data analyzer 545 confirms whether the receiving operation is normally carried on, or not.

When the AV data is normally received from the AV data transmitting device 3a (YES), the receiving condition identifier 566 is notified of this effect, thereby operating mode proceeds to step 151. In the event if the data analyzer 545 confirms that error has been generated in the AV data from the AV data transmitting device 3a (NO), the receiving condition identifier 566 is notified of the occurrence of error in the receiving operation, and then, step 155 is entered, in which the count value P of the error counter is counted up by one. When the count value P of the error counter has been counted up in step 155, then step 156 is entered, in which it is confirmed whether the count value P has exceeded a predetermined value P1, or not. If the count value P has not yet exceeded the predetermined value P1 (NO), then, operating mode proceeds to step 153.

When the AV data from the AV data receiving device 4a is not normally received in step 157, or when the instructions have been generated in step 152 so as to turn the power OFF to halt the system operation (YES), or when the count value P of the error counter has exceeded the predetermined value P1 in step 156 (YES), count value Q of a receiving counter (not shown) for counting the normally received rounds set inside of the receiving condition identifier 566 is reset to zero in step 158. Next, step 159 is entered, in which a unit operating data for provisionally halting reproduction of AV data is generated by the system controlling unit 567.

The unit operating data is then added with an error correcting code by the error correcting code adder 556, which is then enciphered by the data scrambler 557 before externally being transmitted via the base band 543, the high frequency amplifying circuit 542, and the antenna 541. Accordingly, when the unit operating data has been received by the AV data transmitting device 3a, the enciphered unit operating data is then deciphered by the descrambler 512 and then decoded by the data analyzer 513.

The unit operating data decoded by the data analyzer 513 is then converted into a remote controlling data by the remote controlling data analyzer 516. The remote controlling data is then transmitted to the AV source apparatus 1 as an infrared signal from a remote controller output terminal 517. Upon reception of this remote controlling data via infrared communication, the AV source apparatus 1 provisionally halts reproduction of AV data. The system controlling unit 567 stores the data of the time corresponding to the provisionally halted scene as the time for resuming the reproduction.

As a result of executing a process corresponding to step 159, when the AV source apparatus 1 provisionally halted reproduction of AV data, as was performed for the first embodiment, the AV data transmitting device 3a transmits the AV data at the time of provisional halt to the AV data receiving device 4a per period of the AV data transmission. The AV data transmitted from the AV data transmitting device 3a at the time of causing the AV source apparatus 1 to provisionally halt own operation is not solely limited to the AV data that was present at the moment of entering a provisional halt, but the transmissible AV data may also include previously stored still image as well.

After transmitting the unit operating data for causing the AV source apparatus 1 to provisionally halt own operation, step 160 is entered, in which a receiving operation of signal from the AV data transmitting device 3a is performed at a predetermined timing. Next, step 161 is entered, in which the data analyzer 545 confirms whether the data signal receiving operation is normally carried on, or not. If the data signal were not normally received (NO), step 158 is entered. If it is confirmed that data signal is normally received (YES), step 162 is entered, in which the count value Q of the receiving counter inside of the receiving condition identifier 566 is counted up by one.

When the count value Q of the receiving counter has been counted up in step 162, then, step 163 is entered, in which it is confirmed whether the counted value Q has exceeded a predetermined value Q1, or not. If the counted value Q has not yet exceeded the predetermined value Q1 (NO), then, operating mode proceeds to step 160. If it is confirmed that the counted value Q has exceeded the predetermined value Q1 (YES), then, step 164 is entered, in which the reproduction resuming time data stored in the system controlling unit 567 is read out, and then, the system controlling unit 567 generates another unit operating data for instructing resumption of the reproduction, and then operating mode shifts to step 151. The unit operating data is then transmitted to the AV data transmitting device 3a, and then further transmitted to the AV source apparatus 1 as a remote controlling data from the AV data transmitting device 3a via infrared communication. After receiving the remote controlling data via infrared communication, the AV source apparatus 1 commences reproduction of the AV data exactly from the moment preset for the resumption of the reproducing operation.

2. The Second Example of the Operation for Identifying the Receiving Condition:

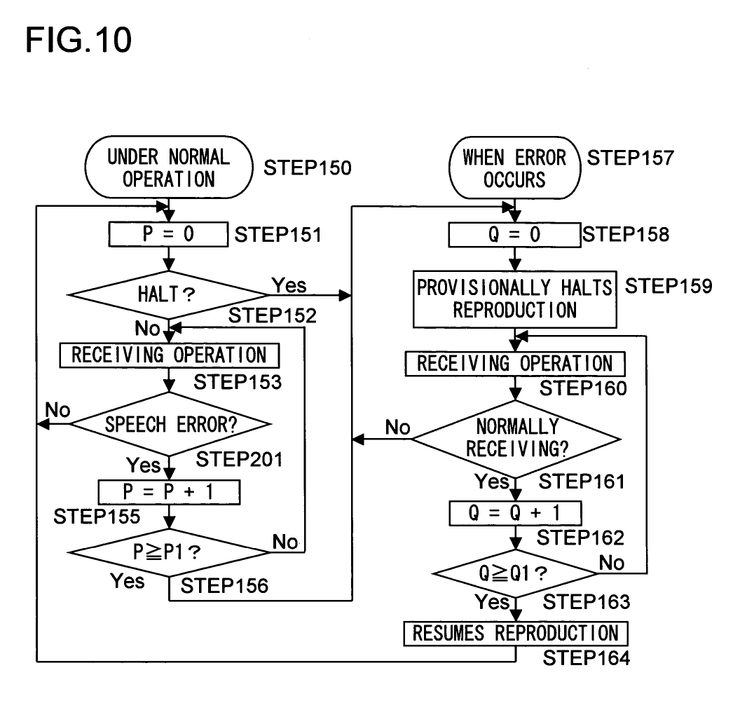

Next, referring to the flowchart shown in FIG. 10, the second example of the operation for identifying the receiving condition is described below. Those operating steps shown in the flowchart of FIG. 10 behaving performances identical to those which are shown in the flowchart of FIG. 9 are respectively designated by identical reference numerals, where detailed description of them are deleted. First, while step 150 remains, when operation for receiving data signal is normally carried on, the count value P of an error counter (not shown) set inside of the receiving condition identifier 566 is reset to zero in the following step 151. Next, step 152 is entered, in which it is confirmed that instructions for turning the power OFF have been generated, or not. If the power-OFF instructions were not generated (NO), then, step 153 is entered, in which operation for receiving data signal from the AV data transmitting device 3a is carried on at a predetermined timing. Next, step 201 is entered, in which it is confirmed whether error has been generated in the speech data among those data decoded by the data analyzer 545, or not.

If there were no error in the speech data (NO), operating mode shifts to step 151. If error has been detected from the speech data (YES), then step 155 is entered, in which the count value P of the error counter set inside of the receiving condition analyzer 545 is counted up by one. Accordingly, unlike the above described first example, independent of the presence or absence of error in the received data, in the second example it is judged whether provisional halt of the AV data transmission should be instructed or not depending on the presence or absence of error in the decoded speech data among the received data signals. Other functional operations are identical to those of the first example, and thus, detailed description thereof is deleted.

As described above, the AV data receiving device 4a judges its own receiving condition by referring to the flowchart shown in FIG. 9 or FIG. 10, and then, establishes proper operation of the AV source apparatus 1 based on the judged result. In this case, depending on the kind of the AV source apparatus 1 connected to the AV data transmitting device 3a, the AV data receiving device 4a changes the provisional halting operation to be instructed. Concretely, in the course of executing step 159 shown in the flowchart in FIG. 9 and FIG. 10, as was performed for the first embodiment, by way of performing an operation based on the flowchart shown in FIG. 5, the AV data receiving device 4a changes the provisional halting operation to be instructed.

While steps 101 to 104 are underway, it is allowable to judge the kind of AV data by referring to the header information of AV data, and also allowable to judge by notifying the AV data receiving device 4a of the kind of AV data via infrared signal from the remote controller 5 operated by a user. Individual time data for representing video scenes at the time of provisional halt to be confirmed during serial steps 107, 109, 111, and 113, shown in the flowchart of FIG. 5 are respectively stored in the system controlling unit 567 as the time for resuming the reproducing operation. When instructing that the reproducing operation should be resumed in step 164, individual time data confirmed in the serial steps 107, 109, 111, and 113 shown in the flowchart of FIG. 5 are sequentially read out, and then transmitted together with a unit operating data for instructing resumption of the reproducing operation.

In the first and second examples of the above-described operations for judging the receiving condition, it is so arranged that, after resetting the count value Q of the receiving counter to zero in step 158, operating mode shifts to step 159 so as to transmit the unit operating data for effecting the provisional halt. Alternatively, it is also practicable to shift operating mode to step 159 so as to transmit the unit operating data for effecting the provisional halt only in the case in which power supply source is turned OFF in step 152 (YES) or only in the case in which count value P of the error counter has exceeded a predetermined value P1 in step 156 (YES). When data signal is not normally received in step 157, or when the unit operating data for effecting the provisional halt is transmitted in step 159, or when data signal receiving operation is not normally carried on (NO) in step 161, operating mode shifts to step 158 so as to reset the count value Q of the receiving counter to zero.

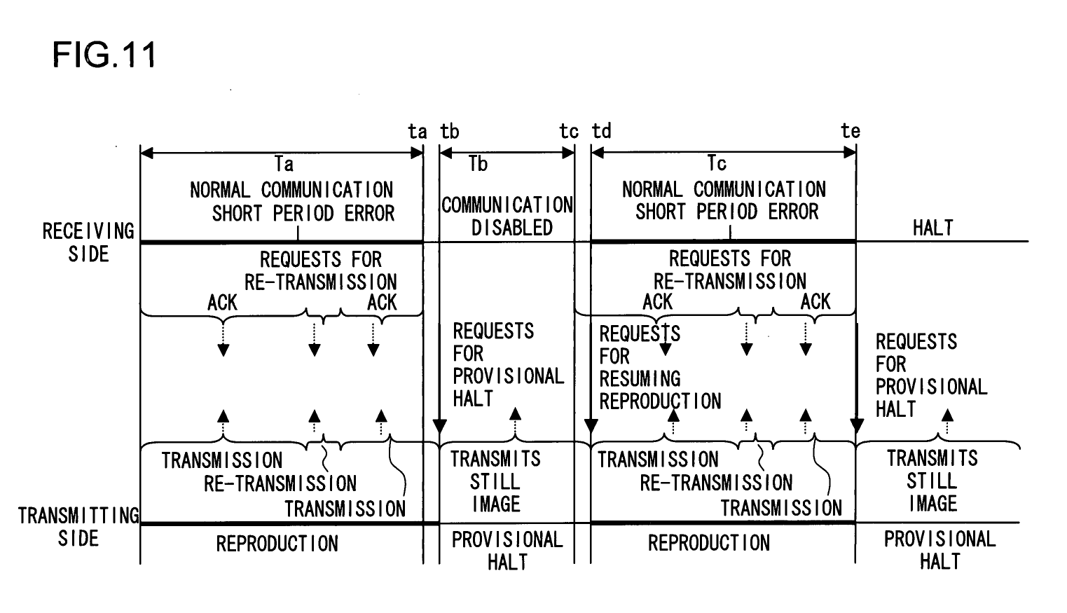

Referring now to the timing chart shown in FIG. 11, examples of the operations of the AV data transmitting device 3a and the AV data receiving device 4a are described below. Assuming that the AV data receiving device 4a normally receives AV data during a period Ta, in response to an AV data transmitted from the AV data transmitting device 3a, the AV data receiving device 4a transmits an ACK signal or the retransmission request signal to the AV data transmitting device 3a. Simultaneously, when the number of packet of the AV data has reached a predetermined number or every specific period, the AV data receiving device 4a transmits the ACK signal or the retransmission request signal to the AV data transmitting device 3a.

In the period Ta, as in the case of the first embodiment, there is merely a short period in which AV data transmitted from the AV data transmitting device 3a failed to be received normally. In other words, there is no possibility of causing the AV data receiving device 4a to continuously transmit the retransmission request signal by more than the predetermined rounds P1, or there is no possibility of causing error to be generated continuously in the speech data received by the AV data receiving device 4a by more than the predetermined rounds P1.

As in the case of the first embodiment, when the AV data receiving device 4a has entered into the state no longer capable of exchanging communication exactly at the time “ta”, the AV data receiving device 4a confirms that the rounds of transmission of the retransmission request signal have reached the predetermined rounds P1 exactly at the time “tb” or confirms that the rounds of occurrence of error in the speech data have exceeded the predetermined rounds P1. Accordingly, when the time “tb” has come, the AV data receiving device 4a transmits a unit operating data for provisionally halting operation of the AV source apparatus 1. Accordingly, the AV data transmitting device 3a receives the unit operating data, and then causes the AV source apparatus 1 to provisionally halt own operation. At the same time, the AV data transmitting device 3a commences transmission of data signal including still-image AV data.

While the period Tb remains, the AV data receiving device 4a still remains in the state incapable of exchanging communication. Although the AV data transmitting device 3a keeps on transmitting data signals including still-image AV data, inasmuch as the AV data receiving device 4a is incapable of normally receiving these data, it cannot continuously transmit the ACK signal by more than the predetermined rounds Q1. When the time “tc” has come, the AV data receiving device 4a is enabled to normally exchange communication, and thus, the AV data receiving device 4a transmits the ACK signal against the data signal transmitted from the AV data transmitting device 3a.

Next, when the time “td” has come, it is confirmed that the AV data receiving device 4a has normally received AV data and the rounds of transmitting the ACK signal have reached the predetermined rounds Q1. Accordingly, when the time “td” has come, the AV data receiving device 4a transmits a unit operating data for causing the AV source apparatus 1 to resume reproducing operation exactly from the provisionally halted scene. In response, as in the case of the first embodiment, having received the unit operating data, the AV data transmitting device 3a causes the AV source apparatus 1 to resume the reproducing operation, and then resumes transmission of the AV data after the provisionally halted scene.

As described above, by resuming transmission of AV data, the AV source apparatus 1 is enabled to resume reproduction of AV data. Next, while the period “Tc” remains, the AV data receiving device 4a remains in the state capable of normally exchanging communication, and thus, as was in the period “Ta”, the AV data receiving device 4a transmits the ACK signal or the retransmission request signal against the AV data transmitted from the AV data transmitting device 3a. Then, when the time “te” has come, power supply source of the AV data receiving device 4a is turned OFF. Simultaneously, the AV data receiving device 4a transmits another unit operating data to the AV data transmitting device 3a so as to provisionally halt operation of the AV source apparatus 1. Upon reception of the unit operating data, the AV data transmitting device 3a causes the AV source apparatus 1 to provisionally halt its own operation, and then transmits data signal including still-image AV data to the AV data receiving device 4a.

As described above, according to the second embodiment, the AV data receiving device 4a is enabled to confirm its own receiving condition. Accordingly, based on the confirmed receiving condition of the device 4a itself it is possible for the AV data receiving device 4a to transmit a unit operating data to the AV data transmitting device 3a so as to bring the AV source apparatus 1 into a provisional halt, or AV data reproducing operation, or into a full halt. Accordingly, if the receiving condition of the AV data receiving device 4a becomes instable in the course of reproducing AV data, it is possible to provisionally halt operation of the AV data receiving device 4a after transmitting the unit operating data to the AV data transmitting device 3a, and then, after restoring the receiving condition of the AV data receiving device 4a, by transmitting the unit operating data to the AV data transmitting device 3a to enable the AV source apparatus 1 to resume reproducing operation from the provisionally halted scene.

The second embodiments provides the AV data transmitting device 3a with a constitution identical to that is shown in FIG. 58. But instead, it is also allowable to constitute the AV data transmitting device 3a with the composition identical to that of the AV data transmitting device 3 shown in FIG. 2 related to the first embodiment. Based on this arrangement, it is possible to confirm the actual receiving condition of the AV data receiving device on the part of the AV data transmitting device and also on the part of the AV data receiving device bilaterally. Even when the communicating condition remains instable or the power supply is turned OFF from the AV data receiving device thereby causing the unit operating data from the AV data receiving device to become undeliverable to the AV data transmitting device, it is possible for the AV data transmitting device to confirm the actual receiving condition of the AV data receiving device, thereby making it possible to automatically control operation of the AV source apparatus.

In the second embodiment, it is so arranged that operating condition of the AV source apparatus 1 is subject to change depending on the number of rounds of normal reception of AV data or depending on the number of rounds of occurrence of error in the AV data reception and occurrence of error in the speech data. However, like the second example of the first embodiment, it is also allowable to shift the operating condition of the AV source apparatus 1 based on the rate computed via division of the number of rounds in the normal reception of AV data or the number of rounds in the occurrence of receiving error and speech data error into the time. If the error generation rate were higher than a predetermined rate, the system controlling unit instructs the AV source apparatus 1 so as to provisionally halt own operation. Conversely, if the error generation rate were lower than the predetermined rate, the system controlling unit instructs the AV source apparatus 1 to resume its reproducing operation. Further, by referring to distortion of video image caused by the receiving error, it is also allowable to shift the operating condition of the AV source apparatus 1.

Further, when the AV data receiving device 4a performs own operation based on the flowchart shown in FIG. 9 or FIG. 10, it is confirmed during step 152 whether the instructions have been generated so as to bring the AV data receiving device 4a into a halt, or not. Instead, it is also allowable to confirm whether the AV reproduction apparatus 2 itself has been brought into a halt, or not. If the AV data receiving device 4a and the AV reproduction apparatus 2 are respectively driven by rechargeable batteries, if the charge capacity were found insufficient upon confirmation of the chargeable capacity, it is also allowable in step 152 to judge that the AV data receiving device 4a and the AV reproduction apparatus 2 are respectively under the halted condition.

The Third Embodiment:

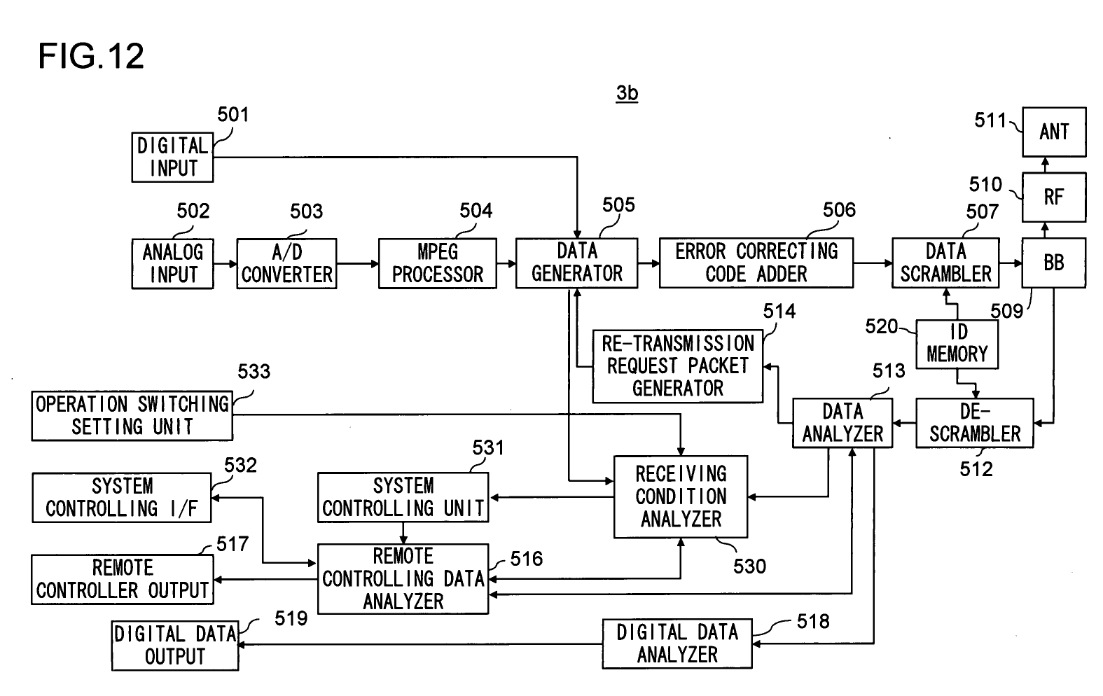

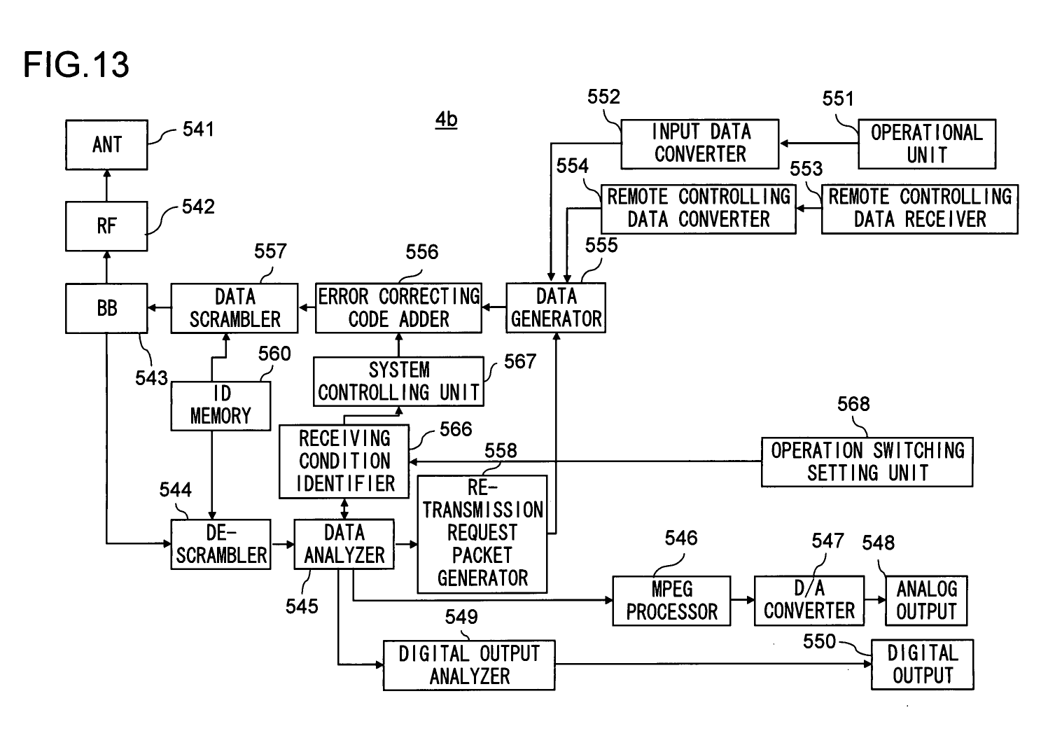

Referring now to FIG. 12 and FIG. 13, the third embodiment of the present invention is described below. FIG. 12 is a simplified block diagram representing an internal constitution of an AV data transmitting device according to the third embodiment of the present invention. FIG. 13 is a simplified block diagram representing an internal constitution of an AV data receiving device according to the third embodiment of the present invention. Those components shown in FIG. 12 and FIG. 13 identical to those shown in FIG. 2 and FIG. 8 are respectively designated by identical reference numerals, where the detailed description thereof is deleted here.

The AV data transmitting device 3b shown in FIG. 12 basically consists of the AV data transmitting device 3 shown in FIG. 2 added with the following: a system controlling interface 532, which directly transmits a remote controlling data generated by a remote controlling data analyzer 516 to an AV source apparatus 1 and receives a controlling data form AV source apparatus 1, and an operation switching setting unit 533 which switches operating condition of a receiving condition analyzer 530. The AV data receiving device 4b shown in FIG. 13 basically consists of the AV data receiving device 4a shown in FIG. 8 added with an operation switching setting unit 568 which switches operating condition of a receiving condition identifier 566.

By constituting the AV data transmitting device 3b as shown in FIG. 12, when identifying the operating condition according to the flowchart shown in FIG. 5, while step 101 to step 104 are individually underway, information on the kind of AV data is transmitted from the AV source apparatus 1 to the receiving condition analyzer 530 via the system controlling interface 532 and the remote controlling data analyzer 516 to enable the receiving condition analyzer 530 to identify the kind of the AV data. It is also possible to simultaneously notify the receiving condition analyzer 530 of the kind of the AV data via the operation switching setting unit 533. Further, it is also possible to instruct via the operation switching setting unit 533 whether operation should be carried on in pursuit of the flowchart shown in FIG. 3 or the flowchart shown in FIG. 4. Inasmuch as the AV data transmitting device 3b of the third embodiment executes other operations in the way identical to that was performed by the AV data transmitting device 3 of the first embodiment, further description thereof is deleted here.

By constituting the AV data receiving device 4b as shown in FIG. 13, when identifying the operating condition according to the flowchart shown in FIG. 5, while step 101 to step 104 are individually underway, information on the kind of AV data is transmitted to the receiving condition identifier 566 via the operation switching setting unit 568. It is also possible to instruct via the operation switching setting unit 568 whether operation should be carried on in pursuit of the flowchart shown in FIG. 9 or the flowchart shown in FIG. 10. Inasmuch as the AV data receiving device 4b of the third embodiment executes other operations in the way identical to that was performed by the AV data receiving device 4a of the second embodiment, further description thereof is deleted here.

It is possible for the operation switching setting unit 533 to change a predetermined number of rounds X1, Y1, Y2 and a predetermined rate Z1, respectively constituting judging values, in the receiving condition analyzer 530, essential for changing operation of the AV data source apparatus 1. Likewise, it is also possible for the operation switching setting unit 568 to change a predetermined number of rounds P1 and Q1 respectively constituting judging values, in the receiving condition identifier 566, essential for changing operation of the AV data source apparatus 1.

By constituting the above arrangement, depending on the visual and auditory contents, it is possible to switch the judging values and judged operation in the receiving condition analyzer 530 or the receiving condition identifier 566 required for changing operation of the AV data source apparatus. Concretely, when handling such contents as are difficult to grasp ever with a slight interruption, one of the following methods is used: the value of a predetermined number of rounds X1 is lowered, whereas the value of a predetermined number of rounds Y1 is raised; the value of a predetermined number of rounds Y2 is lowered, whereas the predetermined rate Z1 is raised; the value of a predetermined number of rounds P1 is lowered, whereas the value of a predetermined number of rounds Q1 is raised. By any of these methods, judging value for shifting to the provisional halt is lowered, whereas the judging value for shifting to the reproducing operation is raised.

In the block diagram shown in FIG. 12, the system controlling interface 532 is discretely set from the operation switching setting unit 533. However, it is also possible to combine the system controlling interface 532 with the operation switching setting unit 533. Further, it is also allowable to cause the operation switching setting unit 533 to receive an infrared signal from a remote controller 5 and then analyze the received data signal. Further, it is also allowable to cause the operation unit 551 shown in FIG. 13 to function as an operation switching setting unit 568. Further, it is also allowable to cause a remote controlling data receiver 553 to function as an operation switching setting unit 568 so as to include a data for executing operational switching in the infrared signal from the remote controller 5.

The Fourth Embodiment:

Referring now to the accompanying drawings, the fourth embodiment of the present invention is described below. Like the first embodiment, the fourth embodiment constitutes an AV data transmitting device as shown in FIG. 2, whereas an AV data receiving device is constituted as shown in FIG. 59.

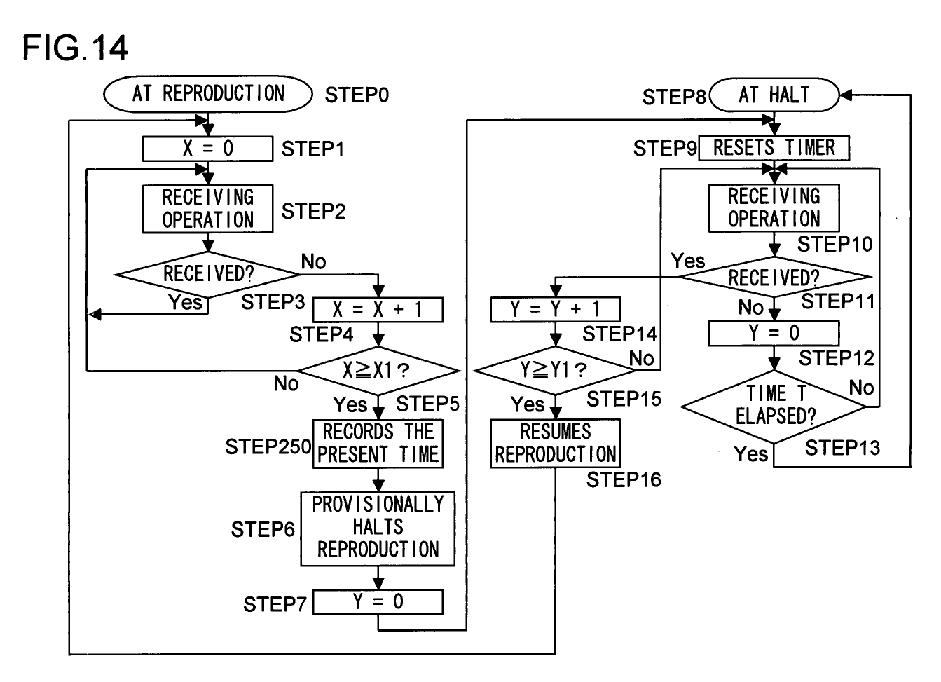

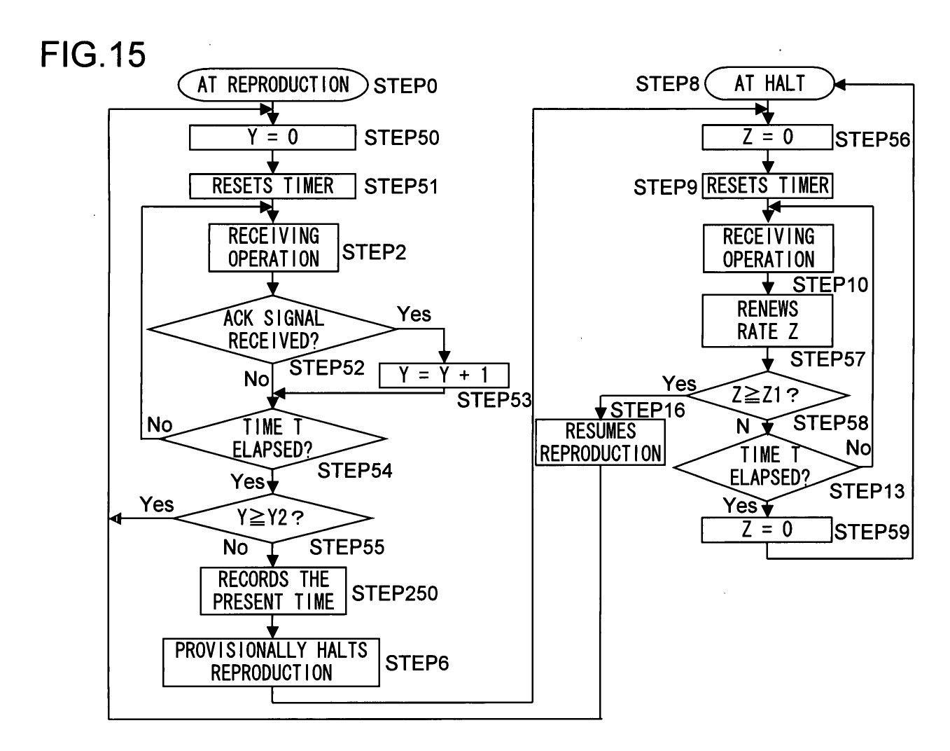

Like the first embodiment, the AV data radio communication system according to the fourth embodiment consists of an AV data transmitting device 3 having a constitution identical to the one shown in FIG. 2, an AV data receiving device 4 having a constitution identical to the one shown in FIG. 59, and a remote controller 5. The AV data transmitting device 3 executes an operation for judging the receiving condition of the AV data receiving device 4 in accordance with the flowchart shown in FIG. 14 or FIG. 15. Note that operating steps of the flowchart shown in FIG. 14 identical to the one shown in the flowchart of FIG. 3 are respectively designated by identical step numbers. Likewise, those operating steps shown in the flowchart of FIG. 15 identical to those shown in the flowchart of FIG. 4 are respectively designated by identical step numbers. Concretely, the first example of the operation for judging the receiving condition in the fourth embodiment corresponds to the stepwise operations in pursuit of the flowchart shown in FIG. 14, whereas the second example corresponds to those stepwise operations in pursuit of the flowchart shown in FIG. 15.

Like the first embodiment, according to the first example of the operation performed by the AV data transmitting device 3 for judging the receiving condition of the AV data receiving device 4, by enabling the receiving condition analyzer 530 to confirm the number of rounds failed to receive the ACK signal and the retransmission request signal from the AV data receiving device 4, operating function whether provisional halt should be applied or not is entered. When executing this operating function, if the count value X of a non-receiving counter (not shown) set inside of the receiving condition analyzer 530 has exceeded a predetermined number of rounds X1 (YES) while step 5 is underway, after confirming the present time, the data of the present time is stored in the receiving condition analyzer 530 as the provisionally halted time while step 200 is underway. Thenceforth, those operations beyond step 6 are executed.

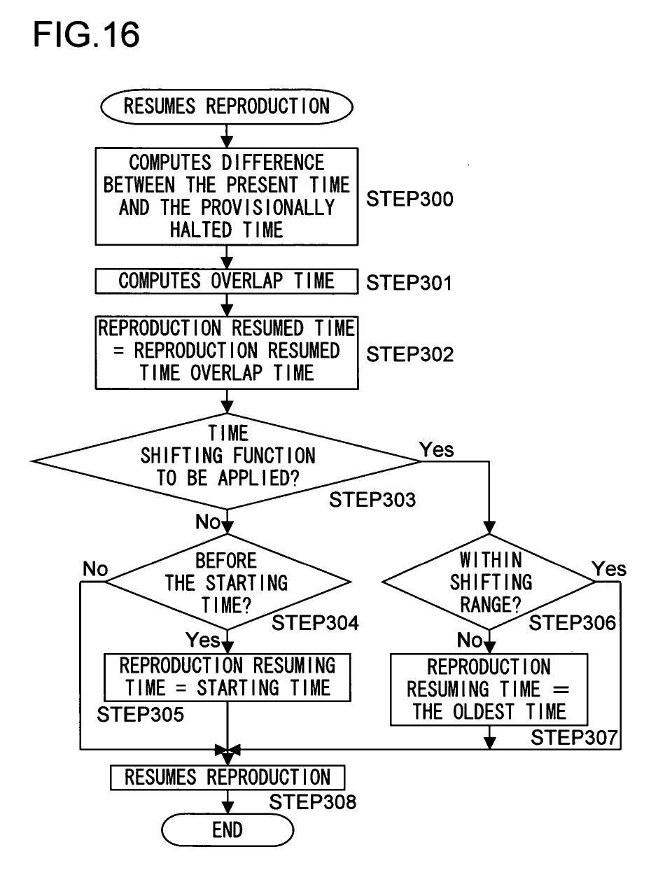

In order to resume the reproducing operation while step 16 is underway, when transmitting an operation controlling data to the AV source apparatus 1 via an infrared signal, operations are executed in pursuit of the flowchart shown in FIG. 16. First, the receiving condition analyzer 530 reads out the provisionally halted time stored in the step 250, and then computes the difference from the present time in step 300. Next, step 301 is entered, in which, based on the time-wise difference between the present time and the provisionally halted time, an overlap time is computed over which to reproduce AV data back from the reproduction resuming time data stored in the system controlling unit 531 during step 116 of the flowchart shown in FIG. 5.

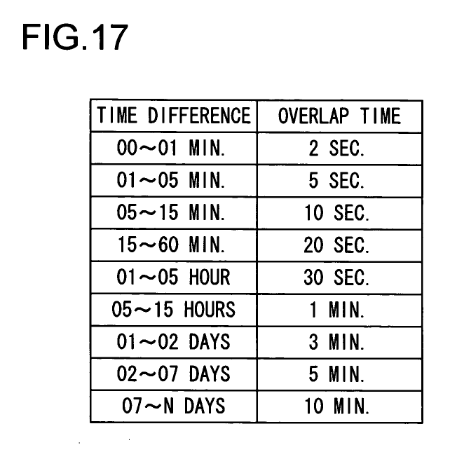

It is allowable to compute the overlap time at a constant rate (for example, 3%) of the time-wise difference between the present time and the provisionally halted time. Further, in order that the overlap time can be prolonged relative to the extension of the time-wise difference between the present time and the provisionally halted time, it is allowable to arrange the relationship between the time-wise difference existing between the present time and the provisionally halted time and the overlap time as shown in FIG. 17. In this case, if the time-wise difference between the present time and the provisionally halted time is up to 1 minute, it is so arranged that reproduction of AV data is resumed 2 seconds before the preset reproduction resuming time. If there is 1 to 5 minutes of the time-wise difference between the present time and the provisionally halted time, then, reproduction is resumed 5 seconds before the preset reproduction resuming time. If there is 5 to 15 minutes of the time-wise difference between the present time and the provisionally halted time, then reproduction is resumed 10 seconds before the preset reproduction resuming time. If there is 15 to 60 minutes of the time-wise difference between the present time and the provisionally halted time, then, reproduction is resumed 20 seconds before the preset reproduction resuming time. If there is an hour to 5 hours of the time-wise difference between the present time and the provisionally halted time, then, reproduction is resumed 30 seconds before the preset reproduction resuming time. If there is 5 to 24 hours of the time-wise difference between the present tie and the provisionally halted time, then, reproduction is resumed one minute before the preset reproduction resuming time. If there is 1 to 2 days of the time-wise difference between the present time and the provisionally halted time, then, reproduction is resumed 3 minutes before the preset reproduction resuming time. If there is 2 to 7 days of the time-wise difference between the present time and the provisionally halted time, then, reproduction is resumed 5 minutes before the preset reproduction resuming time. If there is more than 7 days of the time-wise difference between the present time and the provisionally halted time, then, reproduction is resumed 10 minutes before the preset reproduction resuming time.

When the overlap time is computed in step 301, the time resulted from subtraction of the overlap time from the reproduction resuming time is sought as a renewed reproduction resuming time in the following step 302. When the next step 303 is entered, it is confirmed whether the AV data subject to resumption of reproduction via the AV source apparatus 1 corresponds to the one treated with the time-shifting function, or not. If this AV data is one untreated with the time-shifting function like the AV data contained a hard disc, a DVD, and a video tape loaded in a VTR (NO), then, step 304 is entered, in which it is confirmed whether the reproduction resuming time newly sought in step 302 can become a specific time before the commencing time of the contents to be reproduced by the AV source apparatus 1, or not. If the reproduction resuming time is set before the commencing time of the contents (YES), then step 305 is entered, in which the commencing time of the contents is established as the reproduction resuming time.

When it is identified in step 303 that the AV data has already been treated with the time shifting function as in the case of AV data on the air (YES), then, step 306 is entered, in which it is confirmed whether the renewed reproduction resuming time sought in step 302 can become a specific time prior to the oldest time of the contents recorded via the time shifting function by the AV source apparatus 1, or not (in other words, whether the renewed reproduction resuming time is within the shifting range, or not). If the reproduction resuming time is out of the shifting range (NO), then, the recorded oldest time of the contents is set as the new reproduction resuming time in the following step 307.

When it is found in step 304 that the renewed reproduction resuming time sought in step 302 is not the one prior to the time for commencing the contents (NO), or when the time for commencing the contents is set as the new reproduction resuming time in step 305, or when the renewed reproduction resuming time sought in step 302 enters within the shifting range in step 306 (YES), or when the oldest time of the contents recorded is applied to the new reproducing time in step 307, then, step 308 is entered, in which the receiving condition analyzer 530 generates a unit operating data for instructing resumption of the AV data reproducing operation from the scene exactly corresponding to the time for resuming reproduction of this AV data specified in steps 304 to 307, and then, transmits the unit operating data to the AV source apparatus 1.

Except for the storage of data on the provisional halting time executed in step 250 and those serial operations performed in pursuit of the flowchart shown in FIG. 16 while step 16 remains, the AV data radio communication system executes serial operations identical to those of the first embodiment, and thus, detailed description of these serial operations shall be referred to the first embodiment, thus deleting the description thereof.

As was performed for the first embodiment, in the second example of the operation of the AV data transmitting device 3 for judging the receiving condition of the AV data receiving device 4, the receiving condition analyzer 530 confirms the number of the rounds of receiving the ACK signal from the AV data receiving device 4 at a specific time “t”, and then determines whether the provisional halt should be executed or not. While the above process is underway, when the count value Y of a receiving counter (not shown) set inside of the receiving condition analyzer 530 has exceeded a predetermined value Y2 (YES) in step 55, then, step 250 is entered, in which the AV data transmitting device 3 confirms the present time and then stores this data in the receiving condition analyzer 530 as the data of the provisional halting time. Thenceforth, the AV data transmitting device 3 performs those serial operations beyond step 6. Further, as was performed in the first example, when step 16 is entered, the AV data transmitting device 3 executes serial operations in pursuit of the flowchart shown in FIG. 16. The AV data transmitting device 3 executes other operations identical to those which were performed for the first embodiment.

In the fourth embodiment, the AV data transmitting device and the AV data receiving device are respectively constituted with the composition identical to that was formed in the first embodiment, and further, by causing the AV data transmitting device to confirm the receiving condition of the AV data receiving device so as to change the operating condition of the AV source apparatus 1. However, by providing the same constitution as that of the second embodiment, it is also possible to allow the AV data receiving device to confirm the actual receiving condition of the AV data receiving device itself.

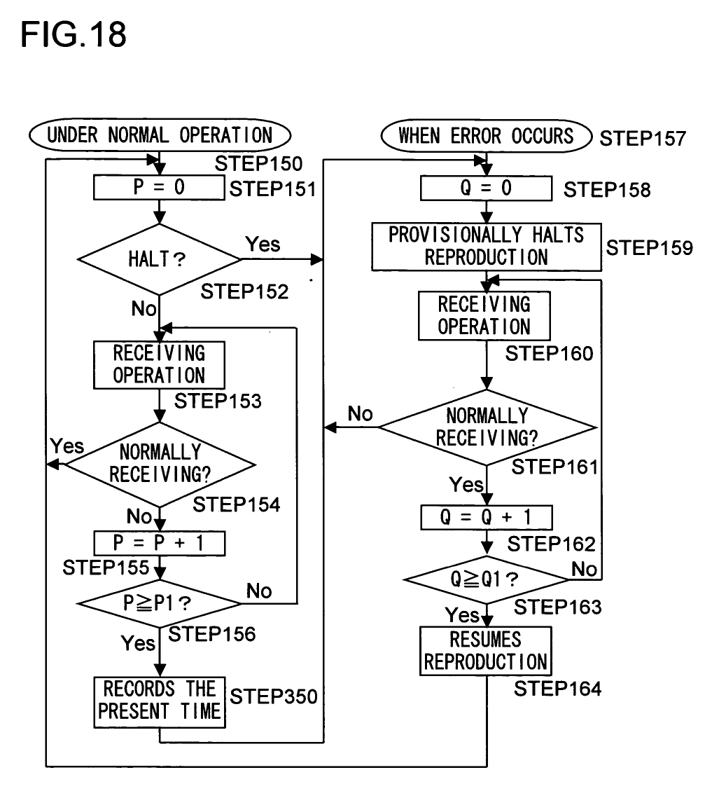

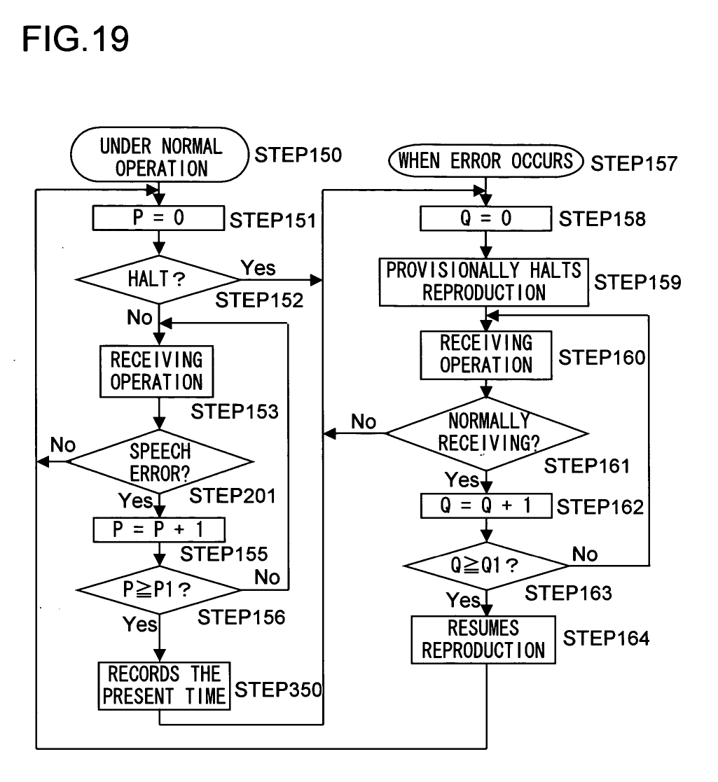

Here, in place of the serial operations according to the flowchart shown in FIG. 9 or FIG. 10, as designated in the flowchart shown in FIG. 18 or FIG. 19, when the count value P of an error counter set inside of the receiving condition identifier 566 has exceeded a predetermined number of rounds P1 (YES) in step 156, the AV data receiving device 4a confirms the present time and stores this data in the receiving condition identifier 566 as the data of the provisional halting time in step 350. Thenceforth, the AV data receiving device 4a executes serial processes beyond step 158. When step 164 is entered, the AV data receiving device 4a executes those processes in pursuit of the flowchart shown in FIG. 16.

It is also allowable for the fourth embodiment to provide the AV data transmitting device and the AV data receiving device with the function described in the third embodiment. In this case, it is possible to execute a setting process against the AV data transmitting device and the AV data receiving device via the operation switching setting unit.

The Fifth Embodiment:

Referring now to the accompanying drawings, the fifth practical embodiment of the present invention is described below. As in the case of the first or the fourth embodiment, the fifth embodiment provides the constitution of the AV data transmitting device as shown in FIG. 2 and the constitution of the AV data receiving device as shown in FIG. 59.

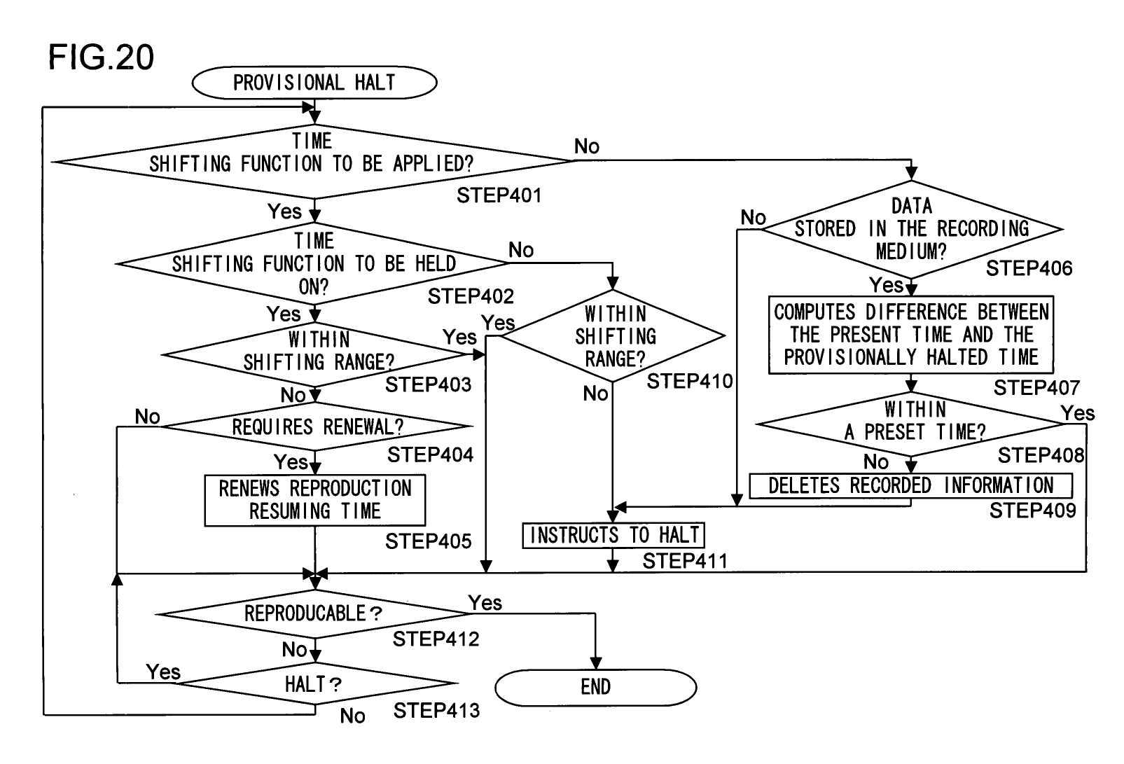

The fifth embodiment uses an AV data transmitting device 3 and an AV data receiving device 4 identical to those which were used for implementing the first or the fourth embodiment. As was done for the first or the fourth embodiment, when step 6 is entered, in order that an AV source apparatus 1 makes a provisional halt, a unit operating data is generated and then transmitted to the AV source apparatus 1. Concurrently, the AV data transmitting device 3 performs serial operations in pursuit of the flowchart shown in FIG. 20 until instructing the AV source apparatus 1 to resume AV data reproducing operation. Referring to the flowchart shown in FIG. 20, serial operations of the AV data transmitting device 3 to be performed after shifting to the provisional halting mode is described below.

When step 6 is entered, a command is directed to the AV source apparatus 1 so as to provisionally halt its operation. Then, step 401 is entered, in which the receiving condition analyzer 530 confirms whether the command for instructing the provisional halt of the operation of the AV source apparatus 1 is accompanied with the time shifting function as is done for the AV data on the air, or not. If it is identified that this command for instructing the AV source apparatus 1 is accompanied with the time shifting function (YES), then, step 402 is entered, in which it is confirmed whether the time shifting function is set to be continuously practicable, or not. Continuous execution of the time shifting function may optionally be arranged by a user via a remote controller 5 and the AV receiving device 4 in advance, or the time shifting function may be arranged by direct input to the AV data transmitting 3 device.

When continuous execution of the time shifting function has already been set (YES), then, step 403 is entered, in which it is confirmed whether the time from the start of the time shifting function up to the present time is within a time range that can be recorded by the AV source apparatus 1 via the time shifting function, or not (in other words, whether the present time is within a shifting range, or not.). If the present time is out of the shifting range (NO), the AV data corresponding to the time of the oldest scene recorded by the AV source apparatus 1 via the time shifting function is renewed. In other words, the previously recorded AV data being out of the shifting range is deleted in the AV source apparatus 1.

Then, the time corresponding to the oldest scene recorded by the AV source apparatus 1 via the time shifting function becomes the time beyond the reproduction resuming time stored in the receiving condition analyzer 530, and then it is confirmed in step 404 whether renewal of the reproduction resuming time is required, or not. If it is confirmed that the reproduction resuming time should be renewed (YES), the, step 405 is entered, in which the time corresponding to the oldest scene recorded by the AV source apparatus 1 via the time shifting function is renewed as the reproduction resuming time.

When the provisional halt using the time shifting function is not effected in step 401 (NO), then, step 406 is entered, in which it is confirmed whether operation for reproducing AV data recorded on a recording medium such as a hard disc, a video tape loaded in a VTR, or a DVD has provisionally been halted, or not. If the AV data recorded on a recording medium has been identified (YES), then, step 407 is entered, in which time-wise difference between the present time and the provisional halting time is computed, and then, it is confirmed whether the computed time-wise difference is within a predetermined time, or not. Then, if it is confirmed that the time-wise difference computed in step 407 exceeds the predetermined period of time (NO), then, step 409 is entered, in which those data recorded in the system controlling unit 531 including the provisionally halted contents, the provisional halting time, and the reproduction resuming time, are respectively deleted.

If the continuous application of the time shifting function were not set in step 402 (NO), as was done in step 403, it is confirmed whether the present time is within the shifting range or not in step 410. When the present time were identified to be out of the shifting range in step 410 (NO), or when the AV data were identified to be the one not recorded on a recording medium in step 406 (NO), or when information for resuming reproduction is deleted from the receiving condition analyzer 530 in step 409, the system controlling unit 531 generates a unit operating data for instructing the AV source apparatus 1 to halt own operation, and then transmits the unit operating data to the AV source apparatus in step 411.

When the present time is within the shifting range while step 403 or 410 is underway (YES), or when the renewal of the reproduction resuming time is not required in step 404 (NO), or when operation for renewing the reproduction resuming time is executed in step 405, or when the time computed in step 407 is identified to be within a predetermined time (YES), or when the instructions are transmitted to the AV source apparatus 1 to halt own operation in step 411, then, step 412 is entered, in which it is confirmed whether the receiving condition of the AV data receiving device 4 has been improved so as to be able to shift to the operation for resuming AV data reproduction, or not.

Here if it is not practicable to shift to the operation for resuming the AV data reproduction (NO), then step 413 is entered, in which it is confirmed whether the AV source apparatus 1 has been instructed to halt own operation in step 411, or not. In this case if the operation halting instructions were transmitted to the AV source apparatus 1 (YES), then, operating mode proceeds to step 412. Conversely if the operation halting instructions were not transmitted to the AV source apparatus 1 (NO), then, operating mode proceeds to step 401. If it has become possible to shift to the operation for resuming reproduction of AV data in step 412, the above processes are completed, thereby commencing the operation for resuming the reproduction thereof.

The fifth embodiment uses the AV data transmitting device 3 according to the first or fourth embodiment. However, it is also practicable to use the AV data receiving device 4a according to the second or fourth embodiment. In this case, in order to enable the AV source apparatus 1 to execute a provisional halting operation, a unit operating data is generated in step 159, and then transmitted to the AV source apparatus 1 via the AV data transmitting device 3a. These processes are executed in accordance with the sequence of the flowchart shown in FIG. 20.

In the course of executing operations after generating the instructions to provisionally halt operation of the AV source apparatus 1, when step 405 is entered, the contents recorded in the receiving condition identifier 566 are renewed. When step 409 is entered, contents recorded in the receiving condition identifier 566 are deleted. Operations specified in step 411 are executed by communicating with the AV source apparatus 1 via the AV data transmitting device 3a.

It is also allowable to provide the AV data transmitting device 3 and the AV data receiving device 4a in the fifth embodiment with proper functions of the AV data transmitting device 3b and the AV data receiving device 4b of the third embodiment.

The Sixth Embodiment:

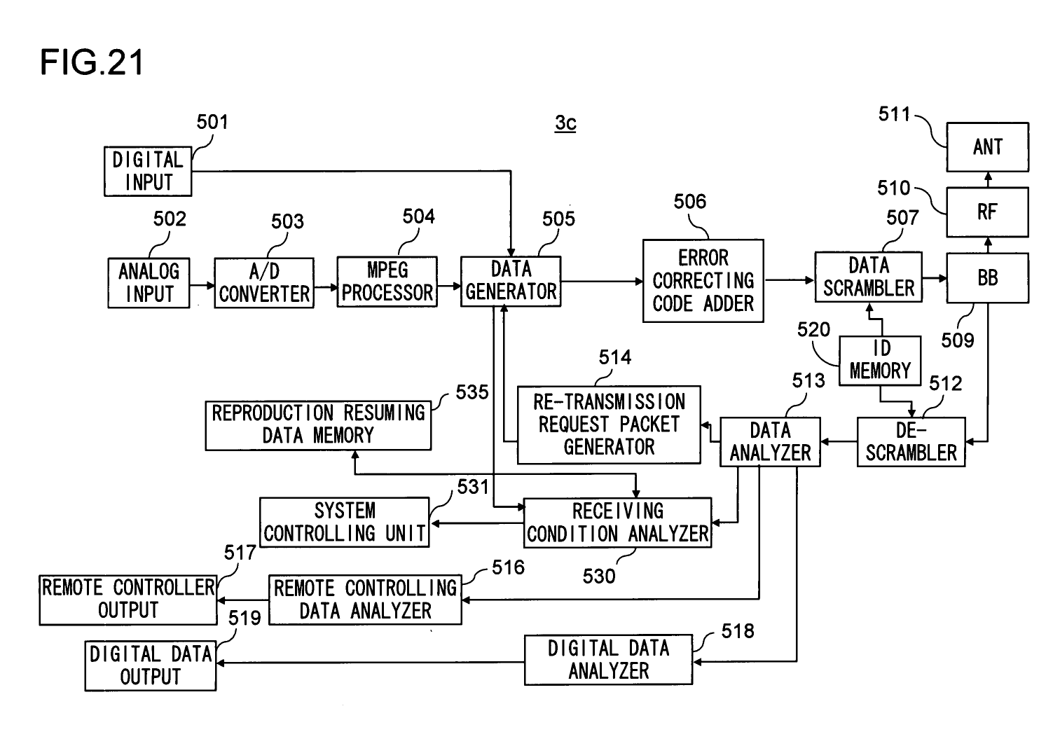

Referring to the accompanying drawings, the sixth embodiment of the present invention is described below. FIG. 21 is a simplified block diagram representing a constitution of an AV data transmitting device according to the sixth embodiment of the present invention. Those components of the AV data transmitting device 3c shown in FIG. 21 identical to those of the AV data transmitting device 3b shown in FIG. 2 are respectively designated by identical reference numerals, where the detailed descriptions of these components are deleted. On the other hand, constitution of an AV data receiving device 4 used for implementing the sixth embodiment is identical to the one shown in FIG. 59.

The AV data transmitting device 3c basically consists of the AV data transmitting device 3 shown in FIG. 2 added with a reproduction resuming data memory 535. The reproduction resuming data memory 535 added to the AV data transmitting device 3c stores various information including data of the time for resuming the reproduction of individual contents and the names of individual contents as present when provisional halting process is executed per user. Next, referring to the drawings, operations of the AV data transmitting device 3c when instructing the AV source apparatus 1 so as to start reproduction of AV data is described below.

1. The First Example of the Reproduction Instructing Operation:

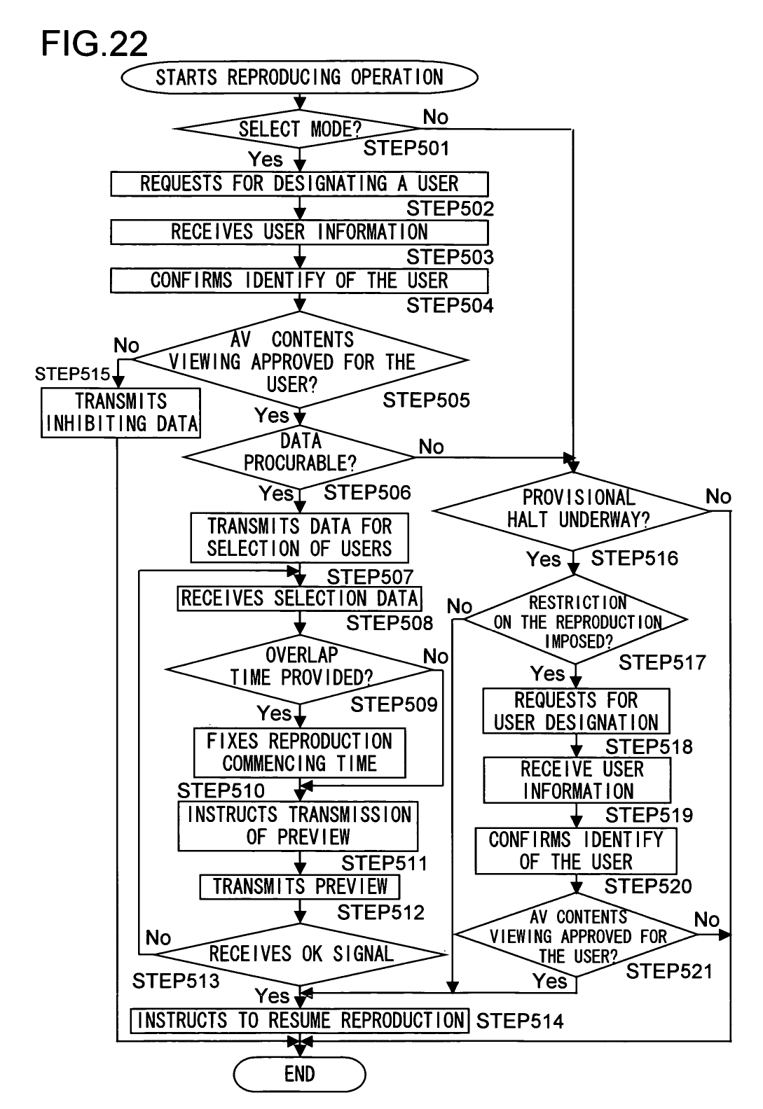

In the sixth embodiment, the AV data transmitting device 3c executes the receiving condition judging operation analogous to that was performed for the first or fourth embodiment. When executing the receiving condition judging operation, serial operations to be executed in step 16 correspond to the serial operations in pursuit of the flowchart shown in FIG. 22. Referring now to the flowchart shown in FIG. 22, reproduction instructing operation according to the sixth embodiment is described below.

When the receiving condition analyzer 530 confirms that the AV data receiving device 4 has entered into the state capable of receiving AV data, as when the number of rounds of receiving ACK signal from the AV data receiving device 4 has exceeded a predetermined number of rounds, or as when the rate of receiving the ACK signal has exceeded a predetermined rate, step 501 is entered, in which the receiving condition analyzer 530 further confirms whether a select mode for selecting contents subject to resumption of reproduction has been set, or not. The select mode can be established by initially notifying the AV data receiving device 4 of the established select mode via a remote controller 5 followed by notifying the AV data transmitting device 3 of this effect from the AV data receiving device 4 via radio communication. The receiving condition analyzer 530 memorizes whether the select mode has been established, or not.

When it is confirmed that the select mode has been set (YES), step 502 is entered, in which the AV data transmitting device 3 transmits a user designating request signal to the AV data receiving device 4 so as to specifically designate a user. Upon reception of the user designating request signal, the AV data receiving device 4 executes an operation as in the case of receiving the AV data, thereby transmitting a data signal to an AV reproduction apparatus 2 so as to indicate that a request has been generated to specify a user, thus implementing an indication for requesting the AV reproduction apparatus 2 so as to specify a user.

Next, the user himself conforms the indication expressed by the AV reproduction apparatus 2, and then, by operating a remote controller 5, the user transmits the user information expressing the user himself to the AV data receiving device 4 via infrared communication. Upon reception of this user information via an infrared signal receiving port 553, the AV data receiving device 4 transmits the user information to the AV data transmitting device 3 by executing serial operations as in the case of receiving infrared signals expressing other operations from the remote controller 5.

The AV data transmitting device 3 receives the user information via an antenna 511, a high frequency amplifying circuit 510, and a base band 509. Next, the user information is deciphered by an ID code A of a descrambler 512. Next, step 503 is entered, in which a data analyzer 513 confirms that the deciphered data correspond to the user information, and then transmits the deciphered data to the receiving condition analyzer 530. Next, step 504 is entered, in which, by referring to the received user information, the receiving condition analyzer 530 confirms the identity of the user about to view and listen to the AV data presently received by the AV data receiving device 4 via the AV reproduction apparatus 2.

When the next step 505 is entered, it is confirmed whether the alleged user confirmed via the user information can be identified as an authentic user approved for viewing and listening to the AV data transmitted from the AV data transmitting device 3c or not. In this case, it is also allowable to confirm approval for viewing and listening to the AV data depending on the feasibility to confirm the user by referring to the user information. Further, it is also allowable to previously store the user information on the user approved for viewing and listening to the AV data in the receiving condition analyzer 530, and then confirm the approval for the viewing and listening of the AV data by referring to the received user information.

When it is confirmed in step 505 that the alleged user is identified as an authentic user approved for viewing and listening to the AV data (YES), then, step 506 is entered, in which it is confirmed whether a specific data against certain contents provisionally withheld against this user is recorded in the reproduction resuming data memory 535, or not. If the data against the user confirmed in step 504 has been recorded in the reproduction resuming data memory 535 (YES), the data against the user is read out from the reproduction resuming data memory 535, and then the receiving condition analyzer 530 generates a selecting data for selecting the contents subject to resumption of the reproduction, which is then transmitted to the AV data receiving device 4 in the following step 507.

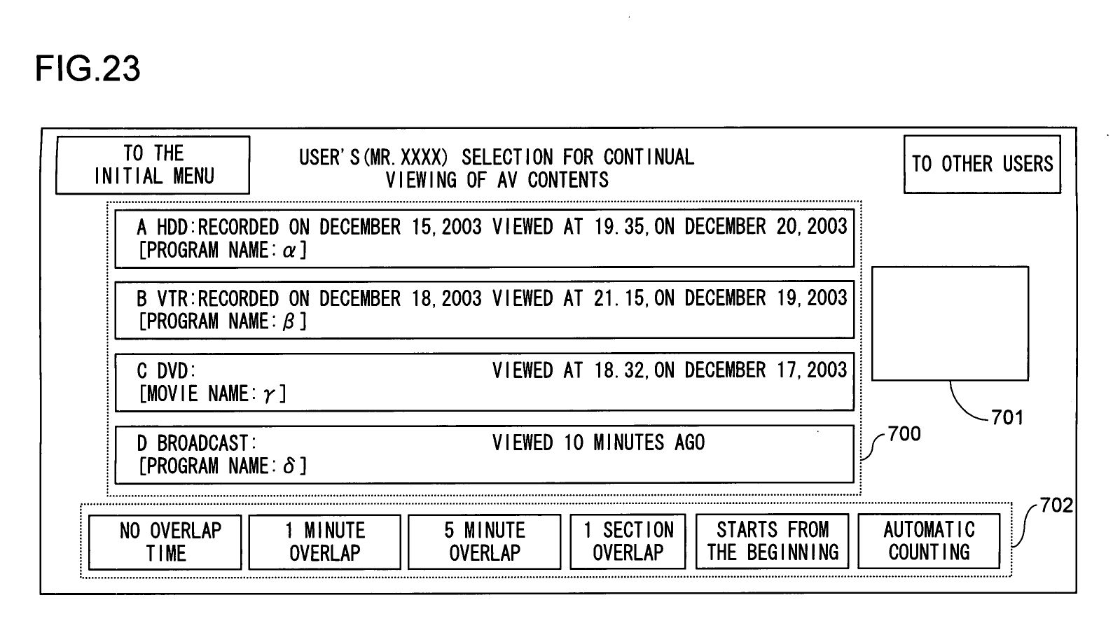

Upon reception of the selecting data, the AV data receiving device 4 performs an operation identical to the case of receiving AV data, thereby enabling the AV reproduction apparatus 2 to duly receive the selecting data to further enable the AV reproduction apparatus 2 to display the list of contents allowable for resuming the reproduction via the selecting data. FIG. 23 exemplifies the contents of display on the AV reproduction apparatus 2.

In FIG. 23, the center domain 700 displays the substance of contents that records a provisional halt, the preview screen 701 displays a scene of a specific portion of the contents predetermined for resuming its reproduction by a user among those contents individually displaying own substance, and the bottom domain 702 displays overlap time selectable by the user. The center domain 700 displays the following: a program “α” recorded on a hard disc on December 15th and concurrently with the contents “a” against which the user halted viewing it at 19.35 PM, on December 20th; another program “β” recorded on a video tape loaded in a VTR on December 18th and concurrently with the contents “b” against which the user halted viewing it at 21.15 PM on December 19th; a movie “γ” recorded on a DVD and concurrently with the contents “c” against which the user halted viewing it at 18.32 PM on December 17th; and a TV program “δ” on the air and concurrently with the contents “d” against which the user halted viewing it 10 minutes before.

The bottom domain 702 displays a plurality of overlap time units comprising 0 minute, 1 minute, 5 minutes, and “1 section” corresponding to a chapter in the DVD. In addition, the bottom domain 702 also displays “From the beginning” designating that the reproduction of the contents is commenced from the startup time. The bottom domain 702 further displays “Automatic counting” for designating that an overlap time is used, which can be computed automatically from the time-wise difference between the provisionally halted time and the present time as was done for the fourth embodiment.

When the user operates a remote controller 5, a controlling signal is transmitted to the AV data receiving device 4 via an infrared communication signal, thereby causing a cursor and a pointer displayed inside of the center domain 700 and the bottom domain 702 to shift themselves. Simultaneously, one of the contents a to d displayed in the center domain 700 and one of overlap time units (including the time to commence reproduction of the contents) displayed in the bottom domain 702, are respectively selected. In response, the data generator 555 generates a selecting data including the selected contents and overlap time unit in its substance, and then, transmits the selecting data to the AV data transmitting device 3c as in the case of transmitting the remote controlling data.

When the AV data transmitting device 3 receives the selecting data, step 508 is entered, in which the data analyzer 513 notifies the receiving condition analyzer 530 of the substance of the contents and the overlap time unit selected by the user. Next, step 509 is entered, in which it is confirmed whether any overlap time is present, or not. If the overlap time is present (YES), then, step 510 is entered, in which a time resulted from a subtraction of an overlap time from the reproduction resuming time against the selected contents stored in the reproduction resuming data memory 535 is set as a new reproduction resuming time. When the next step 511 is entered, the system controlling unit 531 generates a unit operating data for instructing transmission of a preview AV data at the reproduction resuming time (set in step 510) for the selected contents, and then transmits the generated unit operating data to the AV source apparatus 1. If it is confirmed in step 509 that the overlap time is not present (NO), then, step 511 is entered, in which the system controlling unit 531 transmits a unit operating data to the AV source apparatus 1 for supporting transmission of the preview AV data at the reproduction resuming time against the contents selected.

Upon reception of the preview AV data from the AV source apparatus 1, as in the case of transmitting normal AV data to the AV data receiving device 4, the preview AV data is transmitted to the AV data receiving device 4 in step 512. Upon reception of the preview AV data, the AV receiving device 4 transmits the preview AV data to the AV reproduction apparatus 2 as in the case of transmitting normal AV data. Next, visual scene stored in the preview AV data is displayed on the preview screen 701 so as to enable the user to visually confirm the first scene of the selected contents subject to resumption of its reproduction. The visual scene to be displayed on the preview screen may consist of a single still image or plurality of moving scenes.

If the user agrees to resume the reproduction from the scene displayed on the preview screen 701, the user operate the remote controller 5, thereby enabling an OK signal indicating resumption of the reproduction from a specific scene stored in the preview AV data to be transmitted to the AV data receiving device 4 via infrared communication. If the user does not desire to resume the reproduction from the scene displayed on the preview screen 701, the user operate the remote controller 5 so as to cause an NG signal for rejecting resumption of the reproduction from the above scene stored in the preview AV data to be transmitted to the AV data receiving device 4 via infrared communication. The OK and NG signals are respectively transmitted to the AV data transmitting device 3c by executing an operation as in the case of treating the above selecting data and other remote controlling data.

After transmitting the preview AV data to the AV data receiving device 4 in step 512, the next step 513 is entered, in which it is confirmed whether the AV data transmitting device 3c has received the OK signal, or not. If the NG signal has been received (NO), then, operating mode is reverted to step 508 over again, in which reception of the selected data based on the contents and the overlap time selected by the user anew is confirmed. Then, those serial operations beyond step 508 are executed.

If the user confirmed by the user information in step 505 is not approved (NO), an inhibiting data representing disapproval of use is generated by the data generator 505, and is then transmitted to the AV data receiving device 4 in step 515, thereby terminating the serial operations. Upon reception of the inhibiting data, the AV data receiving device 4 performs an operation as in the case of receiving normal AV data so as to transmit the inhibiting data to the AV reproduction apparatus 2. Upon reception of the inhibiting data, the AV reproduction apparatus 2 displays that use of the AV source apparatus 1 has been disapproved.

If the select mode has not been set in step 501 (NO), or if there was no data on the confirmed user in step 506 (NO), then, step 516 is entered, in which it is confirmed whether provisional halting of the operation has been executed, or not. Concurrently, when it is confirmed by the receiving condition analyzer 530 that the provisional halting of the operation is underway (YES), then, it is confirmed in step 517 whether or not the act of the provisional halt is applied to a specific user so as to restrict the reproduction of specific AV data. If the reproduction of the AV data has been restricted (YES), as was done in steps 502 and 503, the user designation request signal is transmitted to the AV data receiving device 4 in step 518, and then, the user information is received from the AV data receiving device 4 in the following step 519. Then, step 520 is entered, in which, as was done in step 504, identity of a specific user is judged by referring to the user information in step 520. Finally, when step 521 is entered, it is confirmed whether the checked user can be identified as the authentic user approved for viewing and listening to the selected AV data, or not.

When it is confirmed in step 513 that the OK signal has been received by the AV data transmitting device 3c (YES), or when no restriction is imposed by the user (NO), or when it is confirmed in step 521 that the checked user is the authentic user approved for viewing and listening in order to resume reproduction of the selected contents from the reproduction resuming time set in step 510, or in order to resume reproduction of the contents under a provisional halt confirmed in step 516, a unit operating data is transmitted to the AV source apparatus 1 while step 514 is underway, thus terminating serial operations. If the operation is not halted provisionally in step 516 (NO), or if the user were identified to be disapproved for viewing and listening to selected AV data in step 521, then, serial operations are terminated.

In the sixth embodiment, when instructing the provisionally halted contents confirmed in step 516 to resume reproduction thereof, by way of performing an operation as was done during step 510, it is also allowable for the user to newly set a reproduction resuming time depending on the overlap time selected from the display in the bottom domain 702 shown in FIG. 23.

2. The Second Example of the Reproduction Instructing Operation:

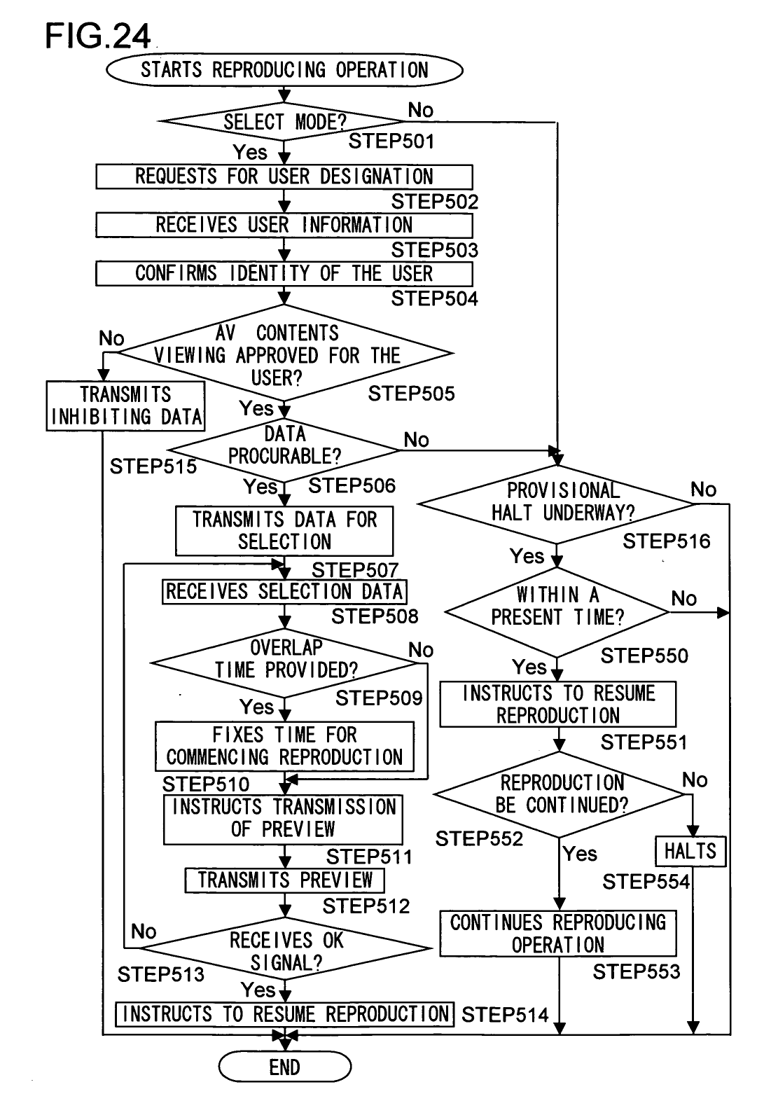

In the sixth embodiment, the AV data transmitting device 3c performs operations for judging the receiving condition as was performed in the fourth embodiment. Those serial operation during step 16 correspond to those serial operation in pursuit of the flowchart shown in FIG. 24. Referring to the flowchart shown in FIG. 24, operations for instructing reproduction of AV data are described below. Those operations performed in steps 501 to 516 of the flowchart shown in FIG. 24 correspond to those of the first example of the reproduction instructing operation in pursuit of the flowchart shown in FIG. 23. Accordingly, only those portions different from those described in the first example are described below.

While step 516 is underway, if the receiving condition analyzer 530 confirms that a provisional halting operation is presently executed (YES), the time-wise difference between the present time and the provisionally halted time is computed, and then, the receiving condition analyzer 530 confirms in step 550 whether the computed time-wise difference is within a predetermined period of time to be set so as to enable resumption of the reproduction of the contents provisionally being halted, or not. If the computed time-wise difference were confirmed to be within a predetermined period of time (YES), in order to resume reproduction of the contents under a provisional halt confirmed in step 516, a unit operating data is transmitted to the AV source apparatus 1 in step 551. Accordingly, when the AV source apparatus 1 resumes provisionally halted transmission of the AV data to the AV data transmitting device 3c, the AV data from the AV source apparatus 1 is transmitted to the AV data receiving device 4.

When transmission of the AV data to the AV data receiving device 4 has been resumed, reproduction display begins with the scene provisionally halted in the AV reproduction apparatus 2. Next, the user notifies the AV data receiving device 4 via a remote controller 5 whether reproduction of the contents under display would be held on continuously or not. Concretely, the user operates the remote controller 5 so as to inform the AV data receiving device 4 of his intention to continue reproduction of the contents by transmitting OK signal via infrared communication or discontinue reproduction of the contents by transmitting NG signal via infrared communication. Either the OK signal or the NK signal is then transmitted from the AV data receiving device 4 to the AV data transmitting device 3c via radio communication.

When performing the above serial operations, the AV data transmitting device 3c confirms in step 552 whether it has actually received the OK signal after resuming transmission of the AV data. When the OK signal has been received by the AV data transmitting device 3c (YES), step 553 is entered, in which it is set that transmission of the AV data resumed from step 551 will be held on continuously, thus terminating serial operations. When the NG signal has been received by the AV data transmitting device 3c (NO), step 554 is entered, in which transmission of the AV data resumed from step 551 is halted, thus terminating serial operations.

When it is confirmed that the time-wise difference is within a predetermined period of time in step 550, as was performed in steps 517 to 521 of the first example, it is also allowable to approve or inhibit resumption of the reproduction of the provisionally halted contents depending on the case in which restriction is imposed on a specific user or not.

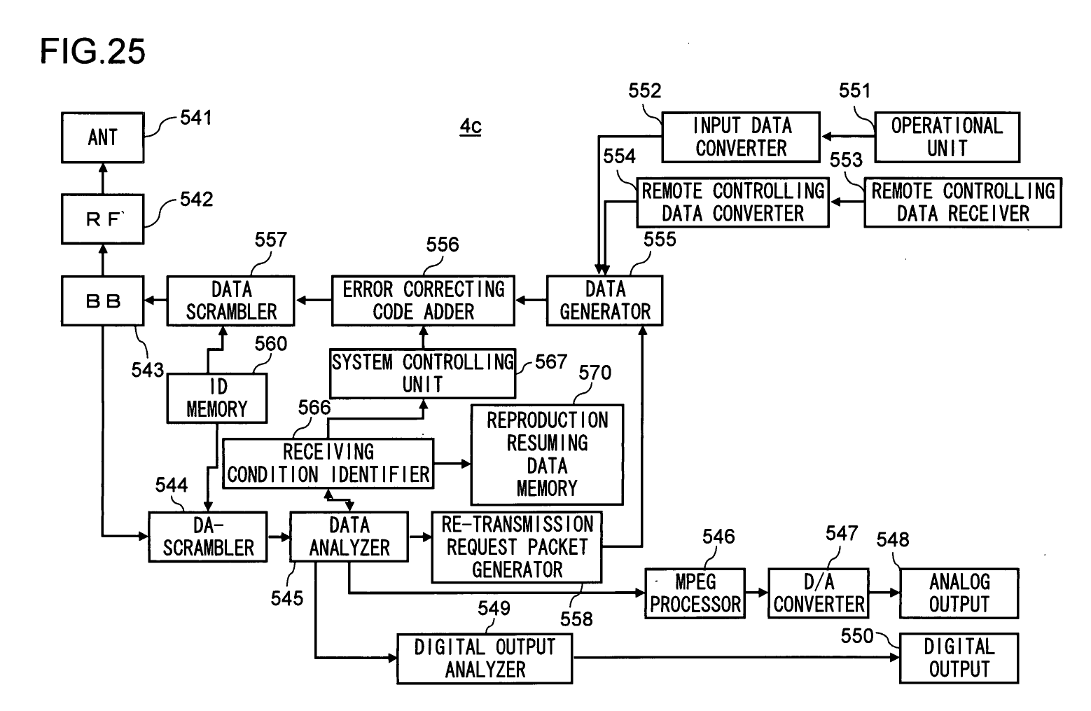

In the sixth embodiment, it is arranged to use the AV data transmitting device 3c provided with the reproduction resuming data memory 535. However, as shown in FIG. 25, it is also allowable to use an AV data receiving device 4c basically consisting of the constitution shown in FIG. 8 added with a reproduction resuming data memory 570. Like the reproduction resuming data memory 535 loaded in the above AV data transmitting device 3c, the reproduction resuming memory 570 stores various information including the reproduction resuming time and the names related to individual contents at the time of executing provisional halt per user.

When using the above-referred AV data receiving device 4c having the constitution as shown in FIG. 25, the AV data receiving device 4c performs a receiving condition judging operation as was performed by the preceding AV data receiving device 4a provided for the second or fourth embodiment. When performing a reproduction resuming operation in step 164, the AV data receiving device 4c performs the reproduction instructing operation based on the flowchart shown in FIG. 22 or 24 identical to that is performed by the AV data transmitting device 3c. In the course of performing the reproduction instructing operation, serial operations based on steps 502, 507, 512, 515, and 518, are executed by communication exchanged between the AV data receiving device 4c and the AV reproduction apparatus 2. Further, the AV data receiving device 4c executes serial operations based on steps 503, 508, 513, 519, and 552, by exchanging communication with the remote controller 5. The AV data receiving device 4c further executes serial operations based on steps 511, 514, 551, 553, and 554, by exchanging communication with the AV source apparatus 1 via the AV data transmitting devices 3, 3a to 3c.

It is also allowable to record the preview AV data in conjunction with contents data per user in the reproduction resuming data memory 535 loaded in the AV data transmitting device 3c or in the reproduction resuming data memory 570 loaded in the AV data receiving device 4c. This arrangement dispenses with the needs for receiving the preview AV data from the AV data source apparatus 1, and thus, it is possible to display the contents and the reproduction resumed scene based on the content and the overlap time selected in the preview screen 701 shown in FIG. 23 earlier. In this way, when storing the preview AV data in the reproduction resuming data memories 535 and 570, by way of recording the preview AV data via compression, it is possible to limit the capacity of the reproduction resuming data memories 535 and 570.

In the preview screen 701 shown in FIG. 23, it is so arranged that user can identify the reproduction resumed scene by way of displaying still image or moving image corresponding to the reproduction resuming scene. Instead, it is also allowable to merely display the reproduction resuming time per contents displayed in the center domain 700 shown in FIG. 23. Further, it is also allowable to further provide the AV data transmitting device 3c and the AV data receiving device 4c with proper function of the AV data transmitting devices 3b and 3 and the AV data receiving devices 4b and 4a.

The Seventh Embodiment:

Referring now to the accompanying drawings, the seventh embodiment of the present invention is described below. As was done for the first embodiment, constitution of the AV data transmitting device conforms to that is shown in FIG. 2, whereas constitution of the AV data receiving device conforms to that is shown in FIG. 59. Detail of the seventh embodiment is described in conformity with the constitution of the first embodiment. Note that it is also possible to apply the function of the seventh embodiment even in the third to sixth embodiment of the present invention.

As described earlier in the first embodiment, when the AV source apparatus 1 performs an AV data reproducing operation, and further when the AV data transmitting device 3 transmits an AV data delivered from the AV source apparatus 1 to the AV data receiving device 4, the receiving condition on the part of the AV data receiving device 4 is apt to become instable, thereby receiving error may be generated. In the seventh embodiment, when the system enters into a state in which receiving error is generated only for a short period of time without the necessarily raising the instructions against the AV source apparatus 1 to provisionally halt own reproducing operation, this period is stored in the receiving condition analyzer 530 as the data of the error generated period. The above state corresponds to the case in which a count value X counted by a non-receiving counter (not shown) cited in the flowchart shown in FIG. 3 is less than X1 or the case in which a count value Y counted by a receiving counter (not shown) cited in the flowchart shown in FIG. 4 is more than Y2.

1. The First Example of Registering the Error Generated Period:

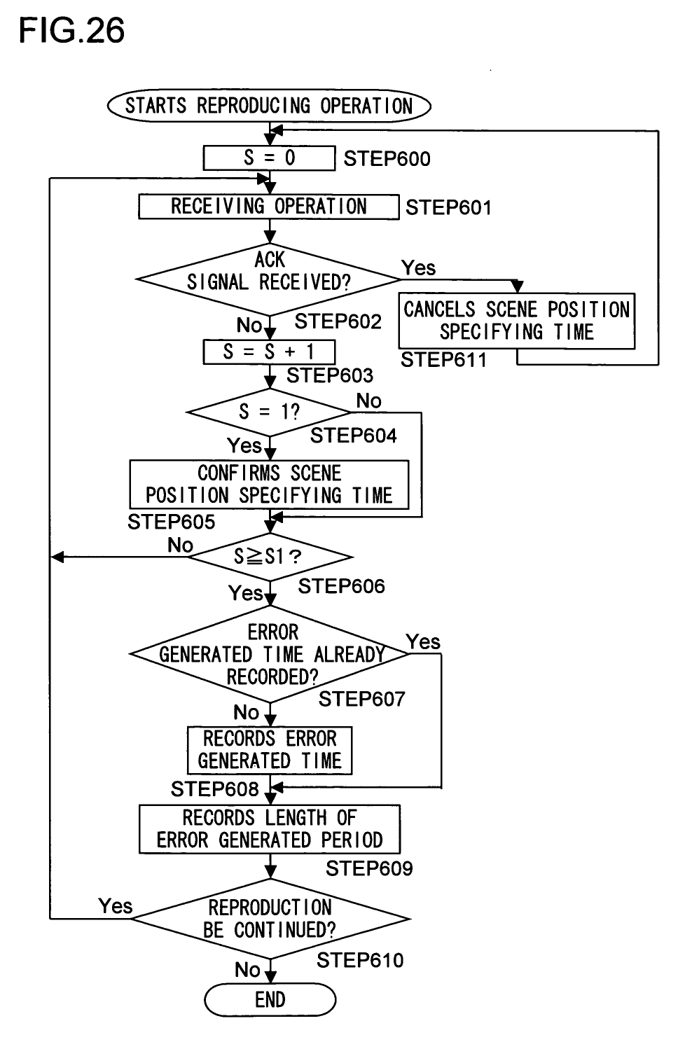

Referring to the flowchart shown in FIG. 26, the first example of registering operation performed by storing the above error generated period data in the receiving condition analyzer 530. First, the AV source apparatus 1 commences own reproducing operation. Then, step 600 is entered, in which a count value S counted by an ACK non-receiving counter (not shown) loaded in the receiving condition analyzer 530 so as to count the number of rounds failed to receive ACK signal from the AV data receiving device 4 is reset to zero. Next, step 601 is entered, in which an operation for receiving signal from the AV data receiving device 4 is executed at a predetermined timing.

Whenever executing an operation for receiving signal from the AV data receiving device 4, the receiving signal analyzer 530 confirms whether the ACK signal against the AV data transmitted to the AV data receiving device 4 has been received or not while step 602 is underway. If the reception of the ACK signal has been confirmed (YES), then step 611 is entered, in which the count value S of the ACK non-received counter is reset to zero. If the reception of the ACK signal has not been confirmed (NO), then step 603 is entered, in which the count value S of the ACK non-received counter is counted up by one.

Next, step 604 is entered, in which it is confirmed whether the count value S corresponds to 1, or not. If the reception of the ACK signal from the AV data receiving device 4 has failed for the first time, and thus the count value S remains 1 (YES), then, step 605 is entered, in which, by referring to the header information of the received AV data, a scene position specifying time for specifying a scene position corresponding to the broadcast time and the count value is confirmed in order to specify an AV data scene. If the count value S is greater than 1 in step 604 (NO), or if the scene position specifying time has been confirmed in step 605, then step 606 is entered, in which it is confirmed whether the count value S has exceeded a predetermined number of rounds S1, or not.

If the count value S exceeds the predetermined number of rounds S1 (YES), then, step 607 is entered, in which it is confirmed whether the scene position specifying time confirmed in step 605 has already been stored in the receiving condition analyzer 530 as the error generated time for specifying the error generated period, or not. If it is confirmed that the scene position specifying time has not yet been recorded as the error generated time (NO), then, step 608 is entered, in which the scene position specifying time confirmed in step 605 is stored in the receiving condition analyzer 530 as the error generated time.

When it is confirmed in step 607 that the confirmed scene position specifying time has already been recorded as the error-generated time (YES), or when the confirmed scene position specifying time has been recorded in step 608 as the error generated time, then step 609 is entered, in which the count value S is stored in the receiving condition analyzer 530 as the duration of the error-generated period. In other words, when operating mode shifts from step 608 and step 609, the count value S1 is stored in the receiving condition analyzer 530. When operating mode shifts from step 607 to step 609, the duration of the error generated period is renewed into a count value S counted in step 603. Next, step 610 is entered, in which it is confirmed whether the AV data reproducing operation still continues, or not.

While the above step 610 is underway, if the instructions were transmitted to the AV source apparatus 1 so as to provisionally halt or fully halt the AV data reproducing operation (NO), then, in order to provisionally suspend the AV data reproducing operation, the process for registering the error generated period is terminated. When the ACK signal has been received from the AV data receiving device 4 in step 602 (YES), then, step 611 is entered, in which the scene position specifying time confirmed in step 605 is set aside, and then, step 600 is entered. If the count value S were found to be less than a predetermined number of rounds S1 in step 606 (NO), or if the AV data reproducing operation still continues (YES) in step 610, then operating mode shifts to step 601.

By performing the above serial operations, if the number of the non-received rounds of the ACK signal exceeds a predetermined number of rounds S1, it is presumed that this corresponds to the error generated period, and then, the starting time of the error generated period is registered as the error generated time, and further, the count value of the ACK non-received counter is registered as the duration of the error generated period. By defining that the predetermined number of rounds S1 is of a value lower than the predetermined number of rounds X1 provided for the first embodiment, it is possible to register the error generated time at the time of generating error in a period shorter than the case of such an error deserving generation of the instructions so as to provisionally halt the AV data reproducing operation.

2. The Second Example of Registering the Error Generated Period:

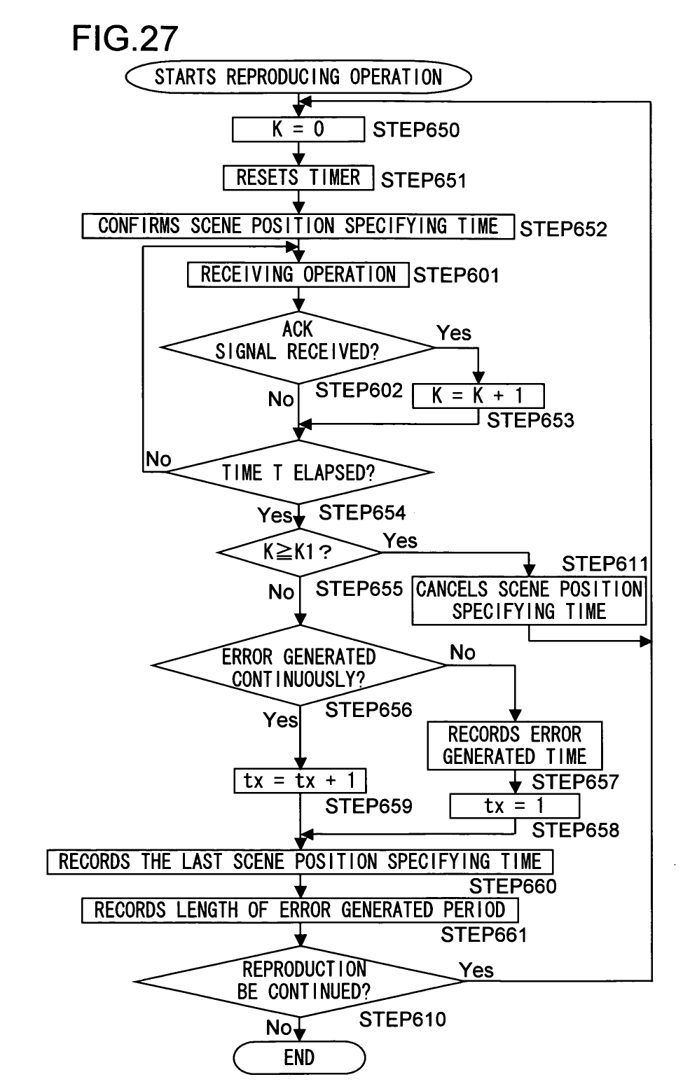

Referring to the flowchart shown in FIG. 27, the second example of registering the error generated period is described below. First, an AV data reproducing operation is actuated in the AV source apparatus 1. Then, step 650 is entered, in which the count value K counted by an ACK receiving counter (not shown) loaded in the receiving condition analyzer 530 is reset to zero. Here this ACK receiving counter counts the number of the received rounds of the ACK signal transmitted from the AV data receiving device 4. When the next step 651 is entered, a timer (not shown) set inside of the receiving condition analyzer 530 is reset to zero.

Next, step 652 is entered, in which the scene position specifying time is confirmed by referring to the header information of the AV data transmitted from the AV source apparatus 1, and then, step 601 is entered, in which a receiving operation of signal from the AV data receiving device 4 is performed at a specific timing, and then confirms the reception of the ACK signal in step 602. When the ACK signal has been received (YES), step 653 is entered, in which the count value K of the ACK receiving counter loaded in the receiving condition analyzer 530 is counted up by one.

When reception of the ACK signal was not confirmed in step 602 (NO), or when the count value K has been counted up by one in step 653, step 654 is entered, in which it is confirmed, based on the time counted by the timer of the received condition analyzer 530, whether a predetermined period of time “t” has elapsed, or not. If the elapse of time “t” is not confirmed (NO), then, step 601 is entered. If the elapse of the predetermined period of time “t” has been confirmed (YES), then, step 655 is entered, in which it is confirmed whether the count value K exceeds a predetermined number of rounds K1, or not.

If the count value K were confirmed to be less than the predetermined number of rounds K1 (NO), then, step 656 is entered, in which it is confirmed whether the scene position specifying time confirmed in step 652 corresponds to the sum of the scene position specifying time confirmed in the preceding round added with the time “t”, or not. If it is not confirmed that the scene position specifying time does not correspond to the sum of the previously confirmed scene position specifying time added with the time “t” (NO), then, step 657 is entered, in which the scene position specifying time confirmed in step 652 is stored in the receiving condition analyzer 530 as the error generated time. Then, step 658 is entered, in which count value “tx” of a period measuring counter loaded in the receiving condition analyzer 530 is set to be 1. Here this period measuring counter counts the period of time in which generation of error has been confirmed so as to measure length of the error generated duration.

While step 656 is underway, if it is confirmed that the confirmed scene position specifying time corresponds to the sum of the previously confirmed scene position specifying time added with the time “t” (YES), then, step 659 is entered, in which the count value “tx” of the period measuring counter loaded in the receiving condition analyzer 530 is counted up by one. Next, operations related to steps 658 or 659 are executed, and then, step 660 is entered, in which, in order to use the scene position specifying time confirmed in step 652 as the previously confirmed scene position specifying time confirmed in step 656, the scene position specifying time confirmed in step 652 is recorded in the receiving condition analyzer 530, and then, the value “tx” counted as the length of the error generated duration is also recorded in the receiving condition analyzer 530 in step 661. The, step 610 is entered, in which it is confirmed whether the AV data reproducing operation still continues, or not.

If the AV data reproducing operation still goes on (YES), then, step 650 is entered. If the AV data reproducing operation were not continued (NO), then, operation is terminated. If it is confirmed in step 652 that the counted value K has exceeded the predetermined rounds K1 (YES), then, the scene position specifying time confirmed in step 652 is deleted from the receiving condition analyzer 530 in step 611, and then, operating mode shifts to step 650.

While executing the above serial operations, when the received rounds of the ACK signal subject to counting per specific period of time “t” is less than the predetermined number of rounds K1, it is regarded as an error generated duration with a low rate of receiving the ACK signal. If the error generated duration confirmed per specific time “t” continues, it is defined as one error generated duration. The starting time of the detected error generated duration is registered as the error generated time, and further, the continued rounds corresponding to the counted value “tx” is also registered as the length of the error generated duration. By way of defining the predetermined number of rounds K1 to be of a value higher than that of the predetermined number of rounds Y2 in the first embodiment, it is possible to register the error generated time at the time of generating error with an ACK receiving rate higher than the case of error generation deserving actuation of the command to provisionally halt the reproducing operation (in other words, at the time of generating error with a low rate of error generation).

When it is arranged to make the time for counting the ACK signal receiving rounds to be shorter than the predetermined period of time “t”, and when the actual number of the ACK signal received rounds K counted per specific counting time has been found to be less than the predetermined number of rounds K1 in succession, it is also allowable to confirm the error generated duration by confirming that the value counted the continued rounds has actually exceeded the predetermined round. In other words, when the specific counting time, in which the ACK signal received rounds K remains lower than the predetermined number of rounds K1, continued for more than the predetermined number of rounds, the error generated period of time is confirmed. In this case, it is also allowable to define the predetermined number of rounds K1 to be of a value corresponding to the predetermined number of rounds Y2 as defined in the first embodiment.

In the above-described first and second examples of the operation for registering the error generated period, it is so defined that the predetermined number of rounds S1 is less than the predetermined number of rounds X1 and the predetermined number of rounds K1 to be higher than the predetermined number of rounds Y2. However, it is also allowable to equalize the predetermined number of rounds S1 to the predetermined number of the rounds X1 and also equalize the predetermined number of rounds K1 to the predetermined number of rounds Y2. In this case, it is so arranged that, whenever instructing the AV source apparatus 1 to provisionally halt AV data reproducing operation after confirming generation of error in the communication with the AV data receiving device 4, error generated period is confirmed and then the error generated time is recorded in the receiving condition analyzer 530.

3. Processes for Canceling Registration of Error Generated Period:

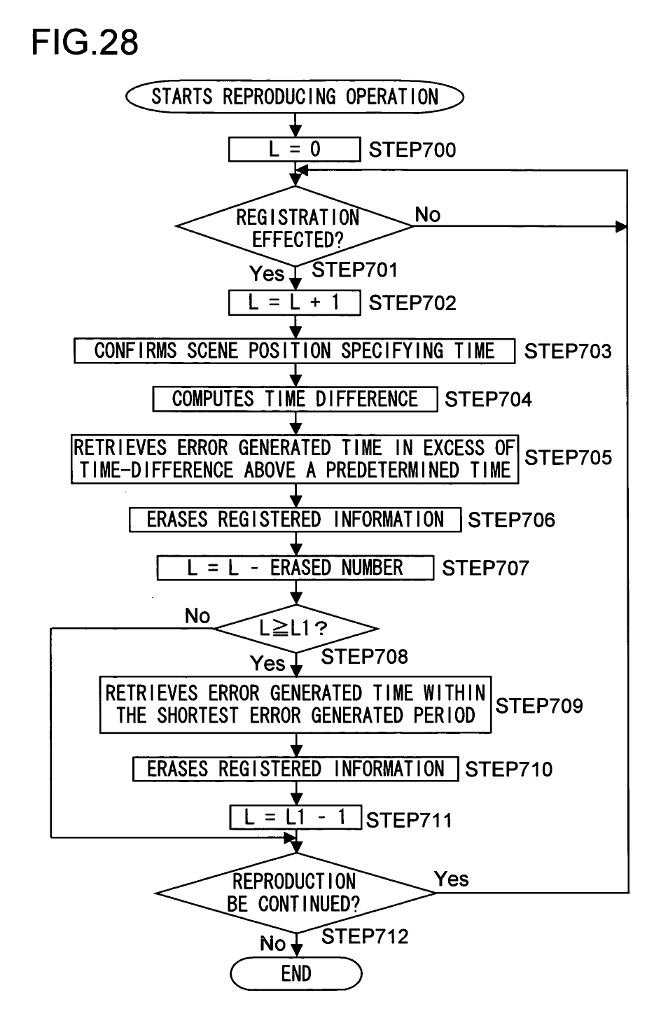

In accordance with the above first and second examples of the operations for registering the error generated period, when storing the error generated time data representing the error generated period in the receiving condition analyzer 530, quantitative or time-wise restriction is applied. Concretely, if the data on the error generated time stored in the receiving condition analyzer 530 reaches a critical limit in quality-wise or time-wise definition, this data is deleted from the record stored in the receiving condition analyzer 530. Referring to the flowchart shown in FIG. 28, serial operations executed for canceling registration of the error generated period is described below.

Fist, when the AV source apparatus 1 commences an AV data reproducing operation, step 700 is entered, in which the count value L of an error generated period counter loaded in the receiving condition analyzer 530 is reset to zero. Here this error generated period counter counts the registered error generated period. Then, step 701 is entered, in which it is confirmed via the above operation for registering the error generated period whether the error generated period has been registered, or not. If the registration of the error generated period could not be confirmed (NO), then, confirming operation executed in step 701 is repeated again.

When registration of the error generated period has been confirmed (YES), step 702 is entered, in which the count value L of the error generated period counter loaded in the receiving condition analyzer 530 is counted up by one, and then, step 703 is entered, in which the scene position specifying time of the presently received AV data is confirmed. When the next step 704 is entered, time-wise differences between every error generated period stored in the receiving condition analyzer 530 and the scene position specifying time confirmed via step 703 is computed, and then, step 705 is entered, in which an error generated period having own time-wise difference beyond a predetermined period of time is retrieved.

When the next step 706 is entered, in order to erase the error generated periods retrieved via step 705 from the registration, the records on the error generated period and lengths of the error generated period are deleted from the receiving condition analyzer 530 in the following step 706. Then, step 707 is entered, in which the counted value L of the error generated period counter is renewed into a value resulted from the subtraction of the number of the error generated period erased via step 706 from the counted value L counted via step 702.

When the next step 708 is entered, it is confirmed whether the counted value L of the error generated period counter renewed via step 707 has exceeded a predetermined value L1, or not. In this case, if the counted value L of the error generated period counter exceeds the predetermined value L1, then, step 709 is entered, in which an error generated period with the shortest error generated duration recorded in the above operation for registering the error generated period is retrieved. In this case, when presence of a plurality of the shortest error generated periods has been confirmed, the one found to be of the oldest time in the error generation is selected.

When the next step 710 is entered, the error generated period retrieved via step 709 is deleted from the registration by way of executing operations as was done via step 706. Then, step 711 is entered, in which the value L counted by the error generated period counter is subtracted by one so as to make it L1−1. If in step 708 the value L counted by the error generated period counter is less than the predetermined value L1 (NO), or if the value L counted by the error generated period counter is set to be L1−1 in step 711, then step 712 is entered, in which, as was done in step 610, it is conformed whether the AV data reproducing operation still goes on continuously, or not. If the continuation of the AV data reproducing operation has been confirmed (YES), then step 701 is entered. If the continuation of the AV data reproducing operation has not been confirmed (NO), then, operation is terminated.

By executing the above serial operations, it is possible to confine the error generated period registered in the receiving condition analyzer 530 within a predetermined number, and, in comparison with the presently reproduced AV data, it is possible to restrict the number of the errors that were generated at the considerably past time.

As in the seventh embodiment, by effect of registering the error generated period, it is possible for users to optionally select resumption of the AV data reproduction from the registered error generated period at the time of resuming the AV data reproduction. In this case, instead of displaying a selectable overlap time in the bottom domain 702 shown in FIG. 23, it is possible to display the selectable error generated period by means of a time unit based on the present moment. When a specific error generated period has been selected at the time of resuming the AV data reproduction, the error generated time against the selected error generated period is entered as the AV data reproduction resuming time, thus enabling to resume transmission of AV data from the reproduction resuming time entered via the above serial processes. In this case, it is also allowable to set a specific overlap time as was done for the sixth embodiment, and then further set the time resulted from the subtraction of the overlap time from the error generated time as the time for resuming reproduction of AV data.

4. Registration of the Error Generated Period by Users:

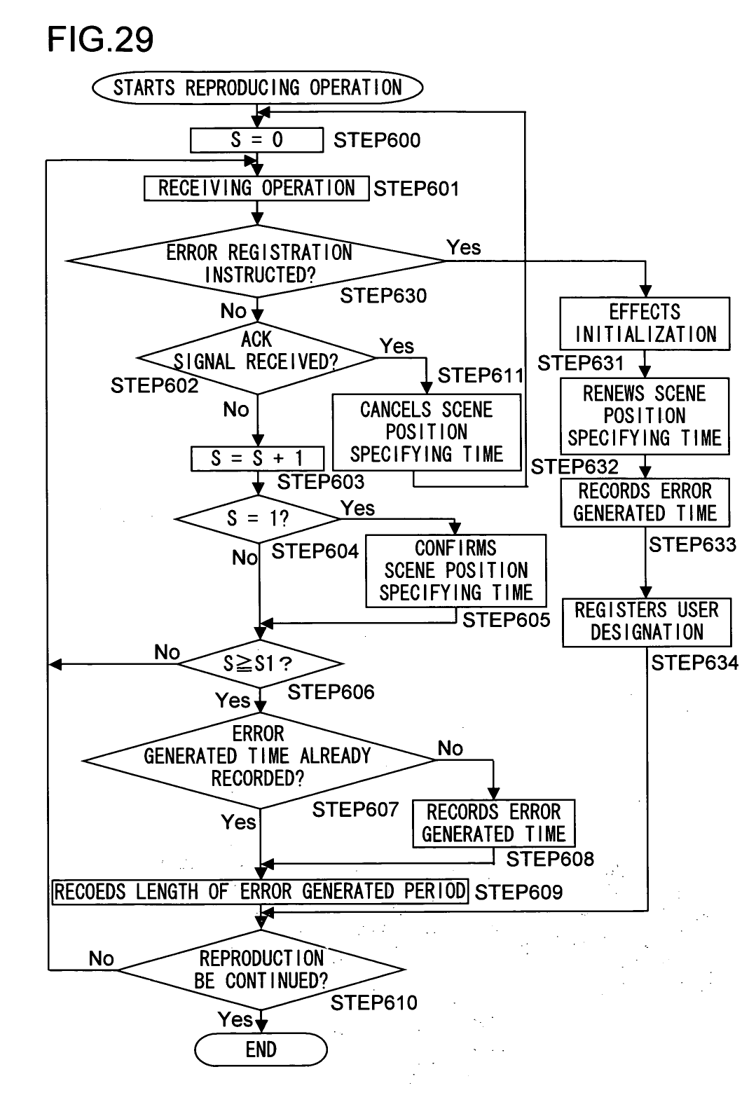

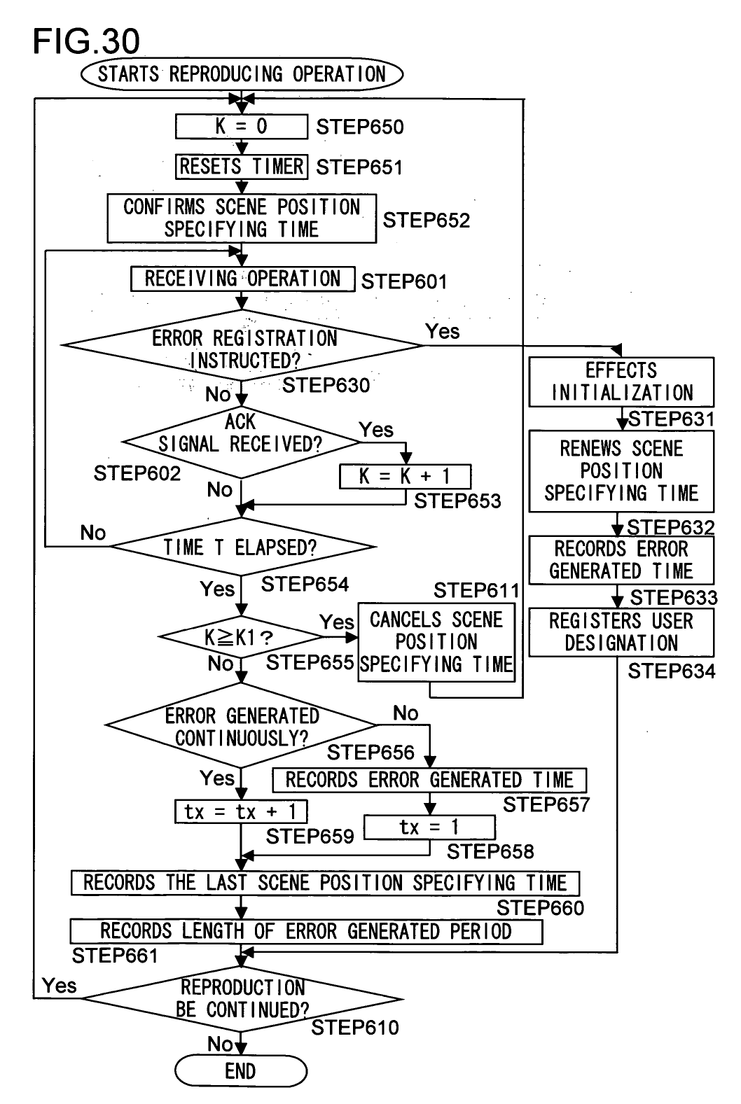

Further, in the seventh embodiment, it is also allowable to have users register the error generated period. In this case, those registering operations according to the flowchart shown in FIG. 29 or FIG. 30, which are respectively obtained by adding serial operations shown in steps 630 to 633 to the flowchart shown in FIG. 26 and FIG. 27, are respectively executed.

Referring to the flowchart shown in FIG. 29 or FIG. 30, when an operation for receiving signal from the AV data receiving device 4 is executed in step 601, then, the data analyzer 513 confirms in step 630 whether the received signal corresponds to an error registration instructing signal for instructing registration of the error generated period, or not. When a user instructs registration of the error generated period by operating a remote controller 5 or an operating unit 551 against the AV data receiving device 4, then, an error registration instructing signal is transmitted to the data generator 555 via a remote controlling data receiving terminal 553 and a remote controlling data converter 554 or an input data converter 552. Like other signals, the error registration instructing signal generated by the data generator 555 is transmitted from the AV data receiving device 4 to the AV data transmitting device 3.

While step 630 is underway, when reception of the error registration instructing signal has been confirmed (YES), then, step 631 is entered, in which the receiving condition analyzer 530 executes an initializing process so as to reset the value S counted by the ACK non-received counter or the value K counted by the ACK receiving counter and the time counted by the timer loaded therein. Then, step 632 is entered, in which the scene position specifying time confirmed via step 605 or 652 is canceled, and then, the actually present scene position specifying time is confirmed anew.

Next, step 633 is entered, in which the receiving condition analyzer 530 internally records the confirmed scene position specifying time as an error generated time. When the next step 634 is entered, the receiving condition analyzer 530 records that this data corresponds to the error generated period designated by the user. Then, operating mode shifts to step 610. If the reception of the error registration instructing signal was not confirmed in step 630 (NO), those serial operations beyond step 602 are executed. Inasmuch as these serial operations correspond to those described above, further description thereof is deleted here.

As described above, when the error generated period data is registered based on the user's designation, once resumption of the AV data reproduction from the error generated period registered by user's designation has been selected at the time of resuming the AV data reproducing operation, in order to generate the reproduction resuming time, the error generated time registered is read out as the one corresponding to the error generated period. Next, a specific overlap time is confirmed, which is previously set as the one usable when the error generated period registered by user's designation is selected, and then, the time resulted from subtraction of the overlap time from the error generated time is entered as the reproduction resuming time. Then, transmission of AV data starting from the reproduction resuming time entered via the above processes is resumed. It is also allowable to set the overlap time subtracted from the error generated time as was done for the sixth embodiment.

The Eighth Embodiment:

Referring to the accompanying drawings, the eighth embodiment of the present invention is described below. As provided for the second embodiment, constitution of the AV data transmitting device according to the eighth embodiment conforms to that is shown in FIG. 58, whereas constitution of the AV data receiving device according to the eighth embodiment conforms to that is shown in FIG. 8. The following description is based on the constitution of the second embodiment. It is also possible for the third to sixth embodiments of the present invention to apply the function of the eighth embodiment.

As was performed for the seventh embodiment, in the case in which receiving error is generated in the AV data receiving device 4a only for a short duration without necessarily raising the instructions against the AV source apparatus 1 so as to provisionally halt its reproducing operation, the eighth embodiment enables the receiving condition identifier 566 to internally store this period as the error-generated period.

1. The First Example of Registration of the Error Generated Period:

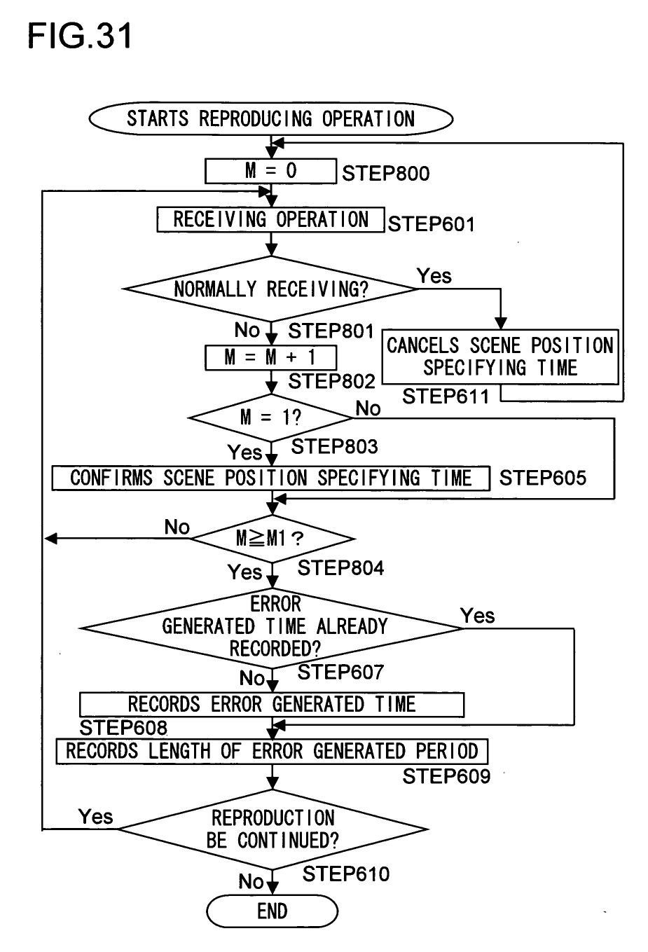

Referring now to the flowchart shown in FIG. 31, the first example of the operation for registration of the error generated period in the receiving condition identifier 566 is described below. Those steps of the flowchart shown in FIG. 31 identical to those shown in the flowchart of FIG. 26 are respectively designated by identical reference numerals, where detailed description thereof is deleted. In the eighth embodiment, a receiving error counter (not shown) is loaded in the receiving condition identifier 566 in order to count the number of rounds failed to normally receive AV data from the AV data transmitting device 3a. When step 800 corresponding to step 600 is entered, the value M counted by the receiving error counter is reset to zero.

When step 801 corresponding to step 602 is entered, it is confirmed whether the AV data from the AV data transmitting device 3a has normally been received, or not. When step 802 corresponding to step 603 is entered, the value M counted by the receiving error counter is counted up by one. When step 803 corresponding to step 604 is entered, it is confirmed whether the value M counted by the receiving error counter corresponds to 1, or not. When step 804 corresponding to step 606 is entered, it is confirmed whether the value M counted by the receiving error counter has actually exceeded a predetermined number of rounds M1, or not.

Concretely, if the count value M corresponds to 1 in step 803 (YES), then, step 606 is entered. If the count value M is other than 1 (NO), then, step 804 is entered. If the count value M is equal to or more than M1 in step 804 (YES), then, step 607 is entered. If the count value M is less than M1 (NO), then, step 601 is entered. As described above, in the eighth embodiment, error generated period is confirmed depending on the number of the rounds of generating error in the reception of AV data, and then, registration of the error generated period is effected by storing the error generated time and the length of duration of the error generated period in the receiving condition identifier 566. Other operational functions are identical to those of the seventh embodiment.

2. The Second Example of the Registration of Error Generated Period:

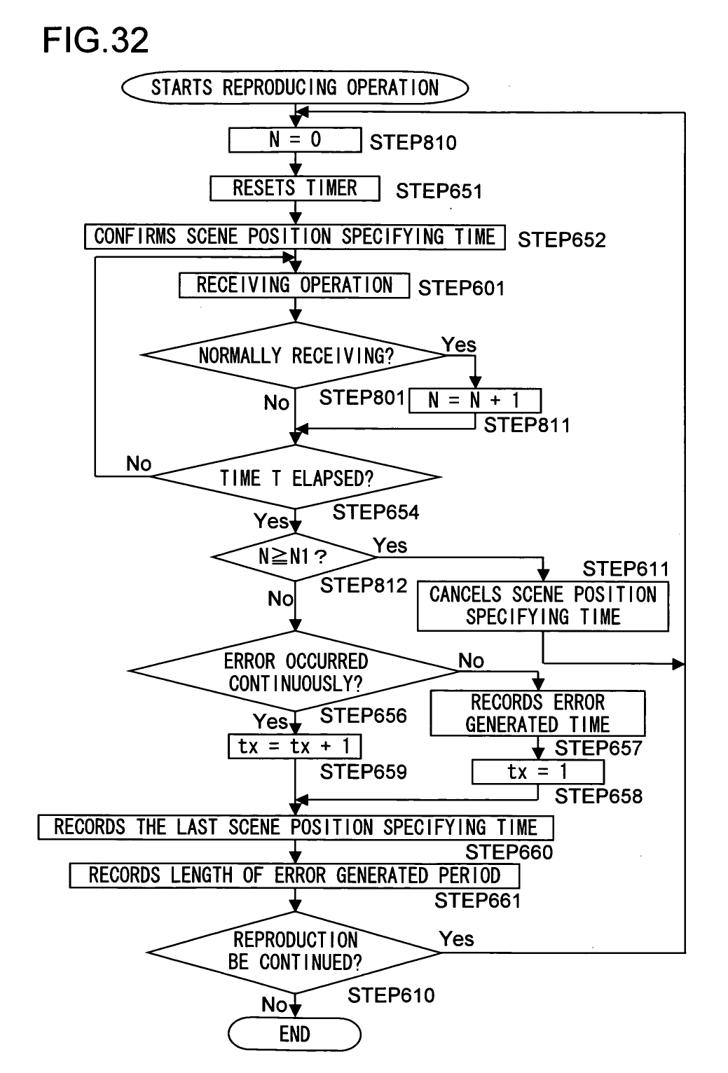

Referring to the flowchart shown in FIG. 32, the second example of operation for registering the error generated period is described below. Those operational steps shown in the flowchart of FIG. 32 identical to those shown in the flowchart of FIG. 27 are respectively designated by identical reference numerals, where detailed description thereof is deleted. The eighth embodiment provides a normal receiving counter (not shown) in the receiving condition identifier 566 in order to count the number of rounds normally received AV data from the AV data transmitting device 3a. When step 810 corresponding to step 650 is entered, the value N counted by the normal receiving counter is reset to zero.

When step 801 corresponding to step 602 is entered, it is confirmed whether AV data from the AV data transmitting device 3a has normally been received, or not. When step 811 corresponding to step 653 is entered, the count value N of a normal receiving counter is counted up by one. When step 812 corresponding to step 655 is entered, it is confirmed whether the count value N of the normal receiving counter has exceeded a predetermined number of rounds N1, or not. Concretely, if the count value N exceeds N1 in step 812 (YES), then, step 611 is entered. Conversely, if the count value N is less than N1 (NO), then, step 656 is entered. In this way, in the eighth embodiment, by referring to the rate of generating error in the reception of AV data, the error generated period is confirmed, and then, by storing the error generated time and length of the error generated period in the receiving condition identifier 566, the error generated period is registered. Other operational functions in the eighth embodiment are identical to those which were performed in the seventh embodiment.

After being registered via the first and second examples, when a registered error generated period has been selected, an error generated time corresponding to the selected error generated period is entered as the time for resuming reproduction of AV data, and then, resumes transmission of AV data from the set-up reproduction resuming time. In this case, as was performed in the sixth embodiment, it is also allowable to set an overlap time so as to set a time resulted from subtraction of the overlap time from the error-generated time.

3. Cancellation of Registration of Error Generated Period:

Based on the first and second examples of the operation for registering the error generated period, when the error generated time representing the error generated period is stored in the receiving condition identifier 566, as was performed in the seventh embodiment, if the error generated time stored in the receiving condition identifier 566 were found to be at a critical limit in the quality-wise and time-wise condition, this time data is deleted from the record stored in the receiving condition identifier 530. As was performed in the seventh embodiment, serial processes for canceling registration of the error generated period are executed in accordance with steps of the flowchart shown in FIG. 28.

By implementing the first and second examples of the serial operations for registering the error generated period and also by canceling the registration of the error generated period, the error generated period is registered in the receiving condition identifier 566. When registering the above error generated period, by way of enabling step 801 of the flowchart shown in FIG. 31 or FIG. 32 to perform serial operation for registering the error generated period so as to confirm generation of unstable image or speech error, it is also possible to effect registration of the error generated periods corresponding to the unstable image or speech error. During the above process, the receiving condition identifier 566 uniformly controls the error generated periods registered in correspondence with individual cases of unstable image and speech error by way of serially executing the canceling processes of the flowchart shown in FIG. 28.

In order to apply, as the AV data reproduction resuming time, the error generated time in the error generated period registered in the receiving condition identifier 566 via the above first and second examples of the operations for registering the error generated period and the above operation for canceling the error generated period, the error generated time is displayed on the AV data reproduction apparatus device 2 when being instructed so as to resume the AV data reproducing operation. These processes are described below.

4. The First Example of Selective Display of Error Generated Time:

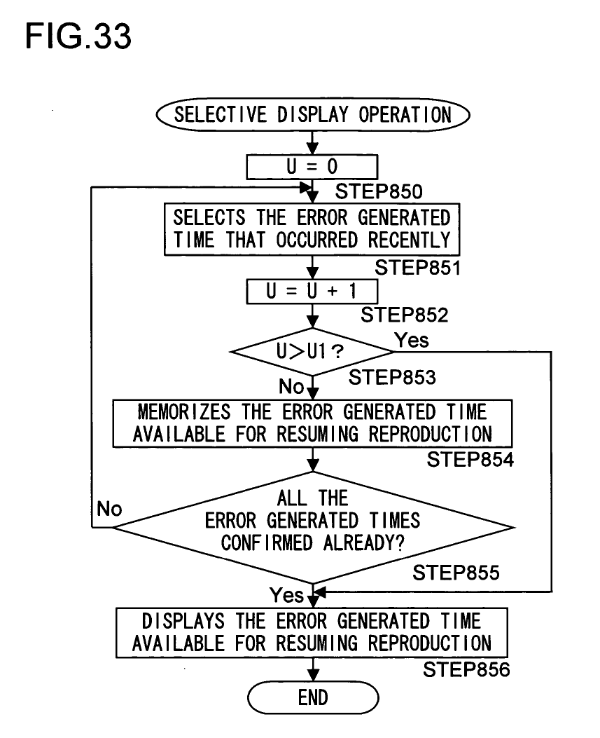

First, referring to the flowchart shown in FIG. 33, the first example of the operation for selectively displaying the selected error generated time (as the error generated time usable for resuming reproduction of AV data) is described below. When resumption of the AV data reproduction is ready, step 850 is entered, in which the receiving condition identifier 566 causes the count value U of its own selecting counter (not shown) to be reset to zero. Here this selecting counter counts the number of the selected error generated time units usable for the resumption of the AV data reproduction.

When the next step 851 is entered, the receiving condition identifier 566 selects a specific error generated time being closest to the actually present time out from all the error generated time units stored therein, and then, step 852 is entered, in which the count value U of the selecting counter is counted up by one. Then, step 853 is entered, in which it is confirmed whether the count value U of the selecting counter has exceeded a predetermined number U1, or not. If the count value U of the selecting counter were confirmed to be less than the predetermined number U1 (NO), then, step 854 is entered, in which the error generated time selected via step 851 is stored in the receiving condition identifier 566 as the error generating time usable for resuming the AV data reproducing operation.

After storing the selected error generated time usable for resuming reproduction of AV data, step 855 is entered, in which it is confirmed whether all the error generated time units have been selected as the error generated time usable for resuming the AV data reproduction, or not. If all the error generated time units have been selected (YES), then, step 856 is entered, in which the corresponding error generated time unit usable for resuming reproduction of AV data is read out from the receiving condition identifier 566, which is then transmitted to the AV data reproducing apparatus 2 via a data analyzer 545, an MPEG processor 546, a D/A converter 547, and an analog data output terminal 548, or via the data analyzer 545, a digital data output analyzer 549, and a digital data output terminal 550. Concurrently, in order that the error generated time unit can be selected for the reproduction resuming time, in place of an overlap time shown in the bottom domain 702 of FIG. 23, the AV data reproducing apparatus 2 displays the corresponding error generated time selected in the receiving condition identifier 566.

While step 853 is underway, if the count value U of the selecting counter exceeds a predetermined value U1 (YES), then, step 856 is entered, in which the error generated time selected is transmitted to the AV data reproducing apparatus 2. While step 855 is underway, when all the error generated time units stored in the receiving condition identifier 566 are not selected as the error generated time usable for resuming the AV data reproduction (NO), then, step 851 is entered, in which the one closest to the actually present time is selected as the error generated time usable for resuming reproduction of AV data.

5. The Second Example of Selective Display of Error Generated Time:

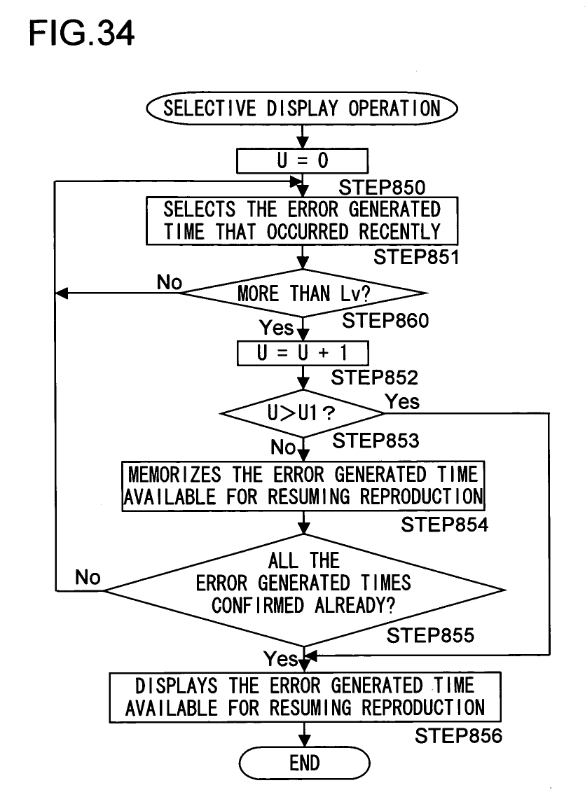

Referring to the flowchart shown in FIG. 34, the second example of operation for selectively displaying the error generated time to be selected for resuming reproduction of AV data is described below. Note that those operational steps described in the flowchart shown in FIG. 34 identical to those shown in the flowchart of FIG. 33 are respectively designated by identical reference numerals, where detail description of these steps is deleted here.

While steps 850 and 851 are respectively underway, when resumption of the reproduction of AV data is ready, the count value U of the selecting counter loaded in the receiving condition identifier 566 is reset to zero, and then, one of the error generated time units being closest to the actually present time is selected. Next, step 860 is entered, in which it is confirmed whether the length of the error generated period at the selected error generated time is longer than a predetermined value Lv, or not. If the length of the error generated period were longer than the predetermined value Lv (YES), then, as was performed in the first example, serial operations beyond step 852 are executed. If the length of the error generated period were shorter than the predetermined value Lv, then, step 851 is entered.

By performing the above operations, an error generated time unit at the moment at which the length of the error generated period exceeds the predetermined value Lv is selected as the error generated time usable for resuming reproduction of AV data, thereby making it possible to select the reproduction resumption from the image scene at which the rate of generating error exceeds the predetermined value. Although the second example defines to select the error generated period usable for resumption of the AV data reproduction depending on the length of the error generated period, it is also allowable to select the error generated time in step 860 by referring to the error generated rate.

6. The Third Example of Selective Display of Error Generated Time:

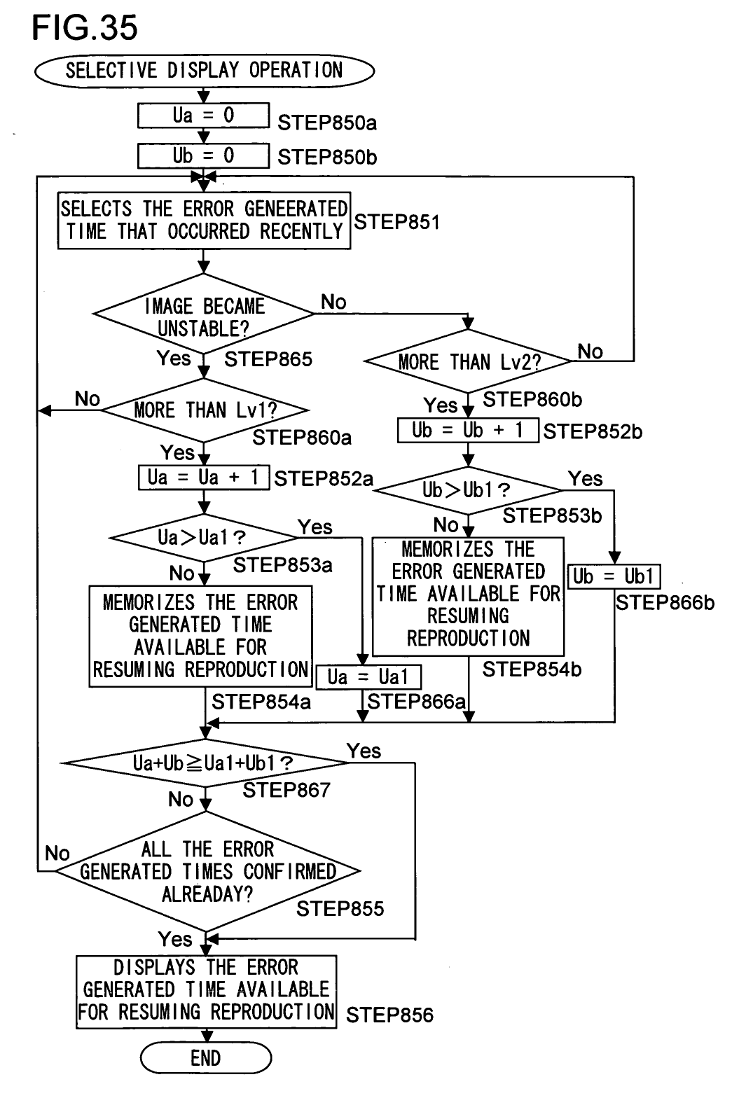

Referring to the flowchart shown in FIG. 35, the third example of the serial operations for selectively displaying the selected error generated time usable for resumption of the AV data reproduction. Note that those operational steps shown in the flowchart of FIG. 35 identical to those shown in the flowchart of FIG. 33 are respectively designated by identical reference numerals, where detailed description of these is deleted here. In the third example, it is assumed that the above described operations for registering the error generated period are executed against unstable image and speech error, and that the error generated period has been recorded in the state capable of discerning that the recording of the error generated period has been done as a result of generating unstable image and speech error.

In the third example, when resumption of reproduction of AV data is ready, the count value Ua of the selecting counter loaded in the receiving condition identifier 566 is reset to zero in step 850a. Here this selecting counter counts that the error generated time caused by unstable image display has been selected as the error generated time usable for resuming reproduction of visual data. Simultaneously, the count value Ub of another selecting counter is also reset to zero in step 850b. Here this selecting counter counts that the error generated time caused by speech error has been selected as the error generated period usable for resuming reproduction of audio data. Next, step 851 is entered, in which one of the error generated time units being closest to the actually present time is selected.

When step 865 is entered, it is confirmed whether the selected error generated time corresponds to the error generated period caused by unstable image display, or not. If the error generated time was generated by unstable image display (YES), then, step 860a is entered, in which it is confirmed whether the length of the error generated period is longer than a predetermined value Lv1, or not. If the length of the error generated period were longer than the predetermined value Lv1 (YES), then, the count value Ua of the selecting counter is counted up by one in step 852a, and then, step 853a is entered, in which it is confirmed whether the count value Ua has exceeded Ua1, or not. If the count value Ua is less than or equal to Ua1 (NO), then, step 854a is entered, in which the error generated time selected via step 851 is stored in the receiving condition identifier 566 as the error generated time usable for resuming AV data reproduction.

If it is confirmed in step 865 that the error generated time was generated by speech error (NO), then, step 860b is entered, in which it is confirmed whether the length of the error generated period is longer than a predetermined value Lv2, or not. If the length of the error generated period were confirmed to be longer than the predetermined value Lv2 (YES), then, the count value Ub of the selecting counter is counted up by one in step 852b, and then, step 853b is entered, in which it is confirmed whether the count value Ub has exceeded Ub1, or not. If the count value Ub is less than or equal to Ub1 (NO), then, step 854b is entered, in which the selected error generated period is stored in the receiving condition identifier 566 as the error generated time usable for resuming reproduction of AV data.

If the count value Ua is greater than Ua1 in step 853a (YES), then, step 866a is entered, in which the count value Ua is compulsorily changed into Ua1. If the count value Ub is greater than Ub1 in step 853b (YES), then, the count value Ub is compulsorily changed into Ub1 in step 866b. After serially executing processes in steps 854a, 854b, 866a, and 866b, it is confirmed in step 867 whether the sum Ua+Ub of the count values Ua and Ub has exceeded a predetermined value Ua1+Ub1, or not in step 867. In this case, if the sum of the count values Ua+Ub is greater than the sum of Ua1+Ub1 (YES), then step 856 is entered. If the sum of Ua+Ub is less than the sum of Ua1+Ub1 (NO), then, step 855 is entered. If the length of the error generated period were shorter than Lv1 in step 860a (NO) or if the length of the error generated period were shorter than Lv2 in step 860b (NO), or the length of the error generated period were shorter than Lv2 in step 860b (NO), then, step 851 is entered.

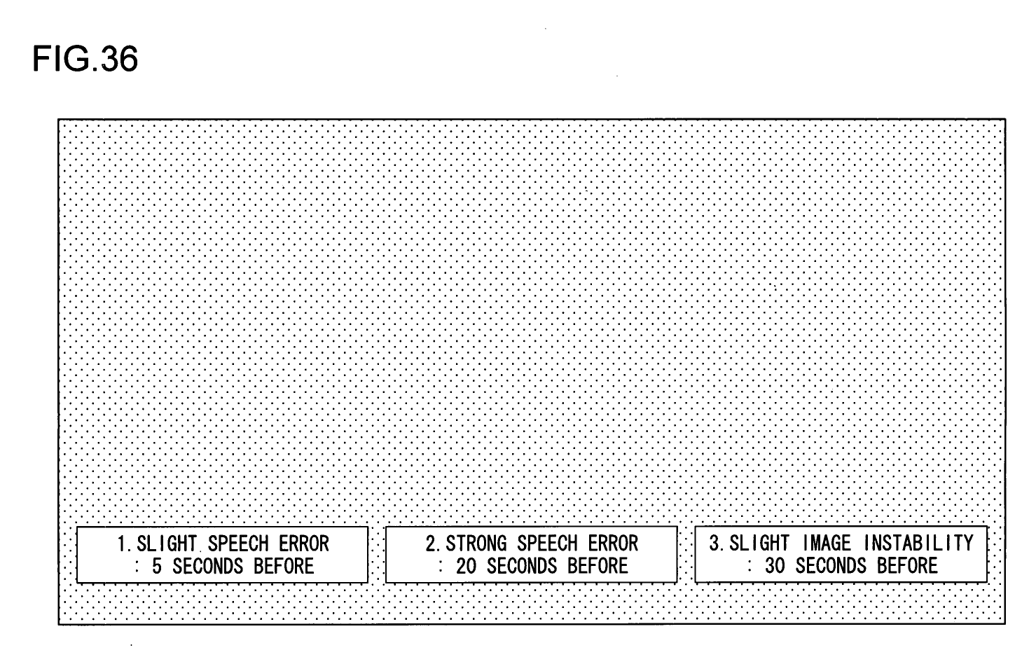

After executing the above serial operations, when step 856 is underway, the error generated time usable for AV data reproduction resumption generated by unstable image and the other error generated time usable for AV data reproduction resumption generated by speech error are respectively transmitted to the AV data reproduction apparatus 2. Accordingly, as shown in FIG. 36, it is possible for the AV data reproduction apparatus 2 to display the error generated time usable for resuming the data reproduction generated by unstable image and the other error generated time usable for resuming the data reproduction generated by speech error in the discernible condition.

In the course of resuming the AV data reproduction, when the error generated times set via the first, second, and the third examples are displayed on the AV data reproduction apparatus 2, and then the error generated period based on one of the above error generated times displayed is selected. Next, the above error generated time against the selected error generated period is entered as the time for resuming the AV data reproduction. Then, transmission of AV data is resumed from the time entered via the above steps for resuming reproduction of AV data. In this case, it is also allowable to set the time resulted from subtraction of the overlap time from the above error generated time as the time for resuming reproduction of AV data.

7. Registration of Error Generated Time by User:

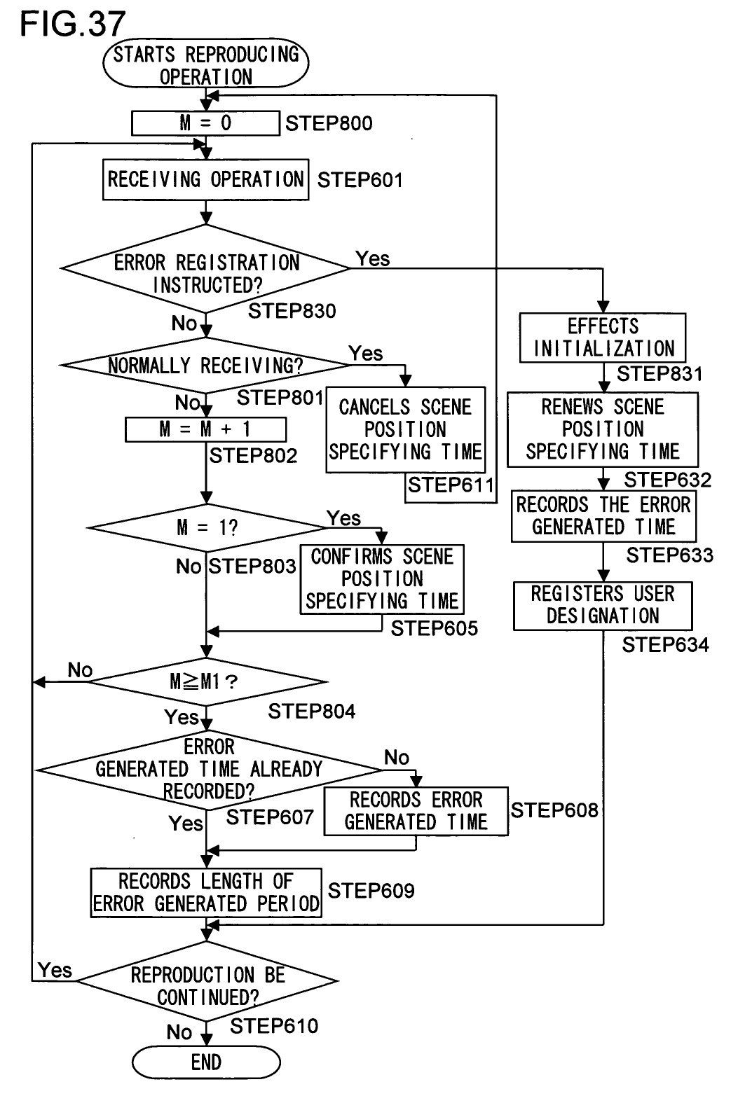

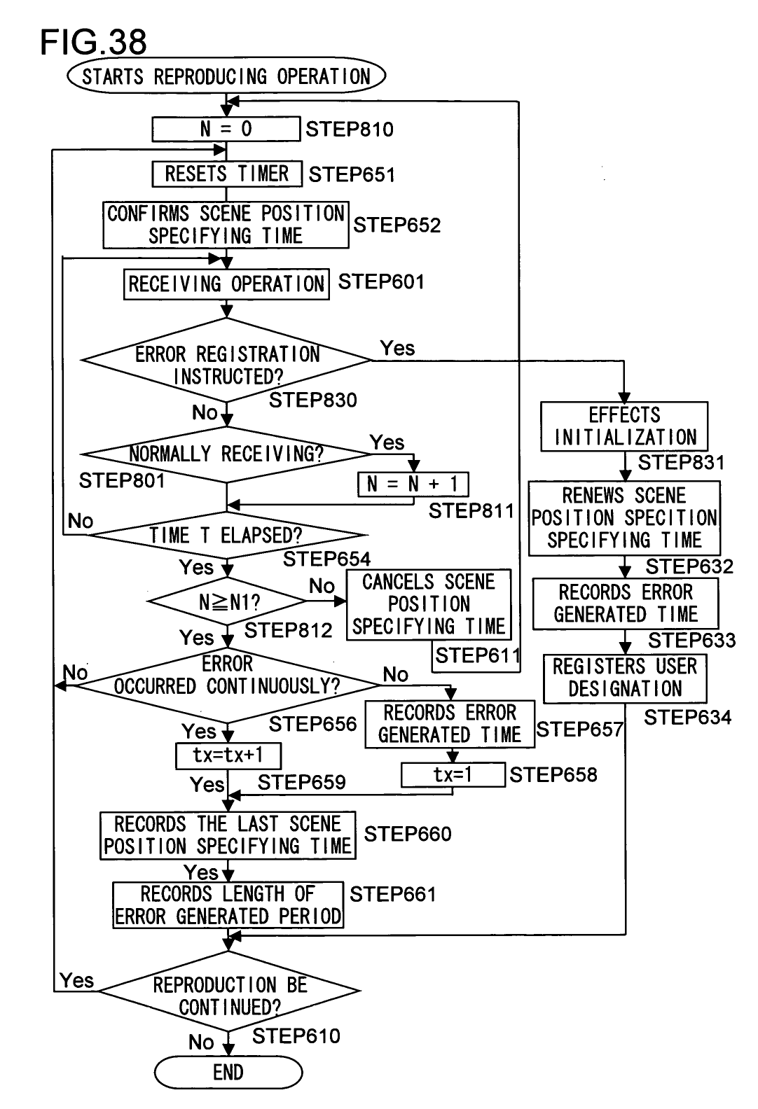

In the eighth embodiment, it is also allowable for users to register the error generated time. In this case, user executes registering operations according to the flowchart shown in FIG. 37 or FIG. 38, which are respectively obtained by adding steps 830, 831, and steps 632 to 634 to the flowchart shown in FIG. 31 and FIG. 32. In this case, the AV data receiving device 4b shown in FIG. 13 is applied.

Referring to the flowchart shown in FIG. 37 or FIG. 38, after a receiving operation of signal from the AV data receiving device 4 is performed in step 601, the receiving condition identifier 566 confirms in step 830 whether user has instructed to register the error generated period by operating the operation switching setting unit 568, or not. If it is confirmed that the user has instructed to register the error generated period (YES), then, step 831 is entered, in which the receiving condition identifier 566 internally executes an initializing process so as to reset the count value M of the receiving error counter or the count value N of the normal receiving counter and the time measured by the timer loaded therein.

Next, step 632 is entered, in which the scene position specifying time confirmed in step 605 or 652 is canceled, and then, the actually present scene position specifying time is confirmed anew. Next, the receiving condition identifier 566 internally records the confirmed scene position specifying time as the error generated time in step 633 and also records in step 634 that this corresponds to the error generated period designated by the user, and then, operating mode shifts to step 610. If the above instructions for registering the error generated period were not confirmed in step 830 (NO), then serial operations beyond step 801 are executed. These serial operations are identical to those described earlier, and thus further description thereof is deleted here.

In the case of registering the error generated period based on the designation of a user, in the course of resuming the AV data reproduction, when the resumption of the AV data reproduction from the error generated period registered based on the designation of a user has been selected, in order to generate the time for resuming the AV data reproduction, the error generated time registered as the error generated period is read out. Next, the overlap time is preset as usable when selecting the error generated period registered based on the user's designation is confirmed, and then, enters the time resulted from subtraction of the overlap time from the error generated time as the time for resuming AV data reproduction. Then, transmission of AV data from the established time for resuming the reproduction is resumed. It is allowable to set the overlap time to be subtracted from the error generated time as was performed in the sixth embodiment.

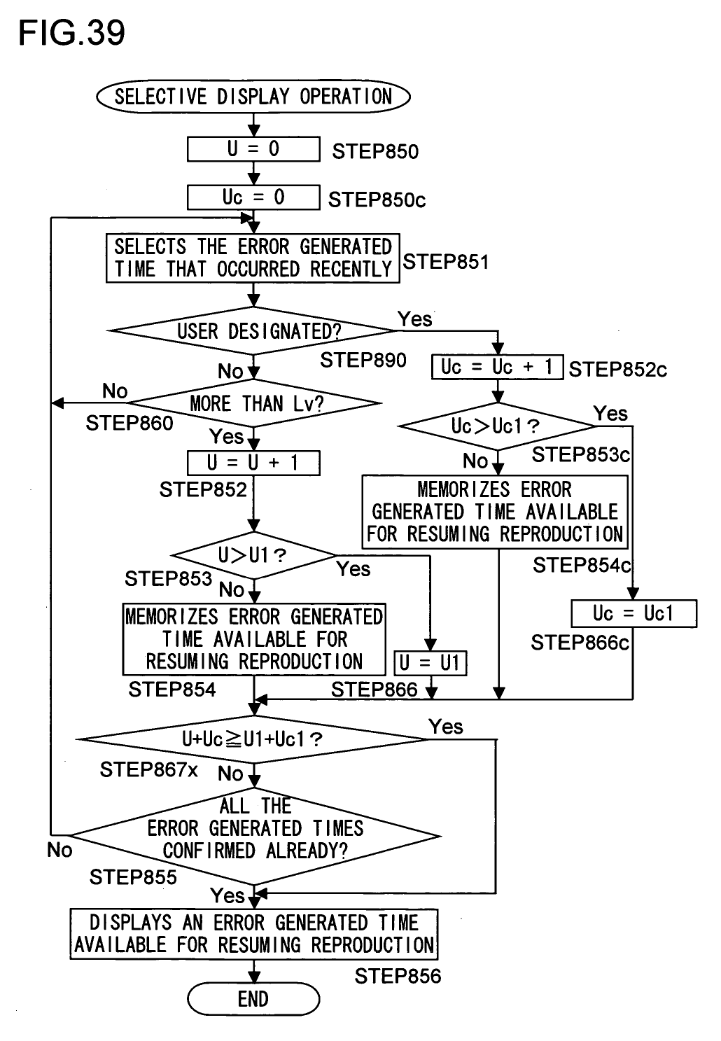

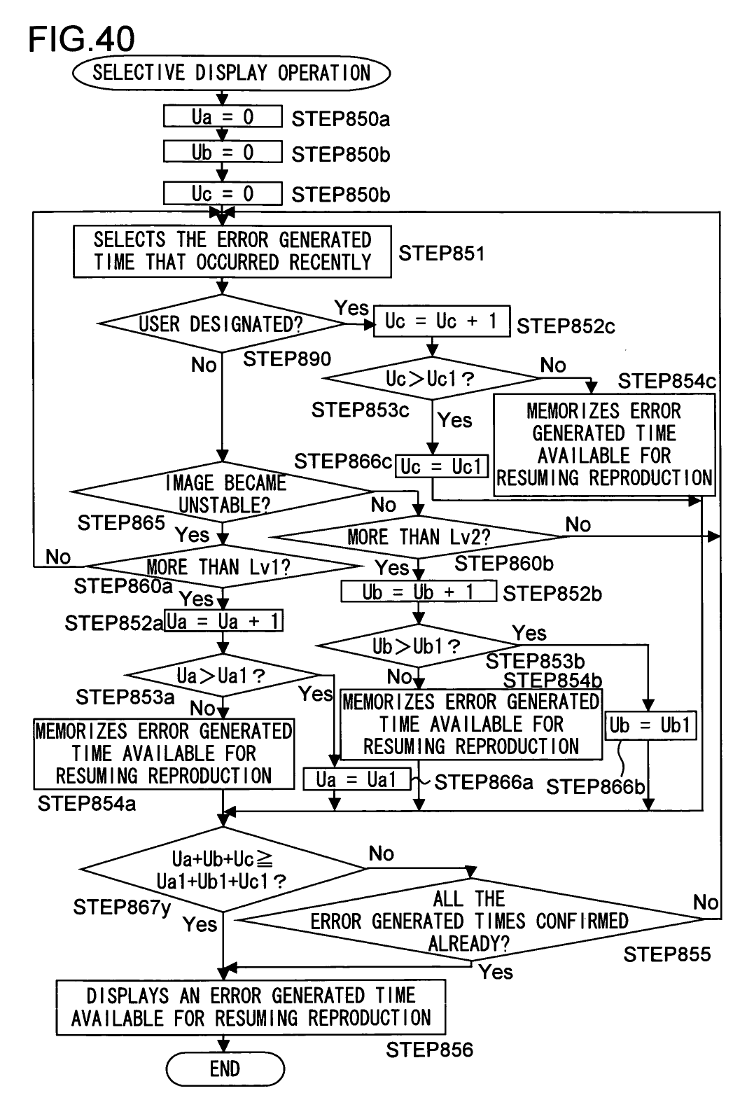

After registering the error generated period via user's designation, when selectively displaying the error generated time as described above, operations for selectively displaying the error generated time in the second and third examples respectively correspond to those serial operations complying with the flowchart shown in FIG. 39 or FIG. 40. Concretely, in the flowchart of FIG. 39, after resetting the count value U in step 850, count value Uc of a selecting counter is reset to zero in step 850c. Here this selecting counter counts the selected error generated time, which is registered based on the user's designation, usable for resuming the AV data reproduction. When the error generated time has been selected in step 851, then, step 890 is entered, in which it is confirmed whether the selected error generated time corresponds to the error generated time in the error generated period registered based on the user's designation, or not.

If the selected error generated time were not registered based on the user's designation (NO), those serial operations beyond step 860 are executed. If the selected error generated time corresponds to the one registered based on the user's designation (YES), the count value Uc is counted up by one in step 852c, and then step 853c is entered, in which it is confirmed whether the count value Uc has exceeded a predetermined value Uc1, or not. If the count value Uc were less than the predetermined number Uc1, then, the selected error generated time is stored in the receiving condition identifier 566 as the error generated time usable for resuming the AV data reproduction in step 854c. If the count value Uc were in excess of the predetermined value Uc1, then, the count value Uc is compulsorily changed into Uc1 in step 866c. If the count value U were in excess of U1 in step 853, then step 866 is entered, in which the count value U is compulsorily changed into U1.

After executing serial operations corresponding to steps 854, 854c, 866, and 866c, then, step 867x is entered, in which it is confirmed whether the sum U+Uc of the count values U and Uc has exceeded the sum of predetermined values U1+Uc1, or not. If the sum U+Uc were in excess of the sum U1+Uc1 (YES), then, step 856 is entered. If the sum U+Uc of the count values were less than the sum U1+Uc1 (NO), then step 855 is entered.

As was performed in the flowchart of FIG. 39, when an error generated time has been selected in step 851 shown in the flowchart of FIG. 40, then step 890 is entered, in which it is confirmed whether the selected error generated time is registered based on the user's designation, or not. If it is identified that the selected error generated time has been registered based on the user's designation (YES), those serial operations beyond step 852c are executed as was performed in the flowchart shown in FIG. 39. If it is identified in step 890 that the selected error generated time has not been registered based on the user's designation (NO), then, those serial operations beyond step 865 are executed as was performed in the flowchart shown in FIG. 35. Next, those operations specified in steps 854a to 854c or steps 866a to 866c are serially executed. Next, when step 867y is entered, it is confirmed whether the sum Ua+Ub+Uc of the count values Ua to Uc has exceeded a predetermined value comprising a sum of Ua1+Ub1+Uc1, or not. Further operations are identical to those shown in the flowchart of FIG. 35.

By serially executing the above operations, independent of the length of the registered error generated period under user's designation, it is possible to select the error generated time as available for resuming reproduction of AV data.

When implementing the sixth or eighth embodiment, it was arranged to effect display on the AV data reproducing apparatus 2 as shown in FIG. 23 and FIG. 36. It is also allowable to effect display as shown in FIG. 23 and FIG. 36 on an electronic apparatus such as a remote controller capable of communicating with an AV data receiving device via infrared rays. When implementing the seventh or eighth embodiment, even when it is not judged that the receiving condition on the part of an AV data receiving device is unstable, it is also allowable to enable the user to optionally designate a specific error generated time as a scene position desired to view and listen to it over again. In this case, on the way of normally reproducing AV data without halting the reproduction provisionally, in the event if error is generated and this is recorded as an error generated period, it is possible for the user to arrange that he can resume reproduction of the AV data from the recorded error generated period.

The Ninth Embodiment:

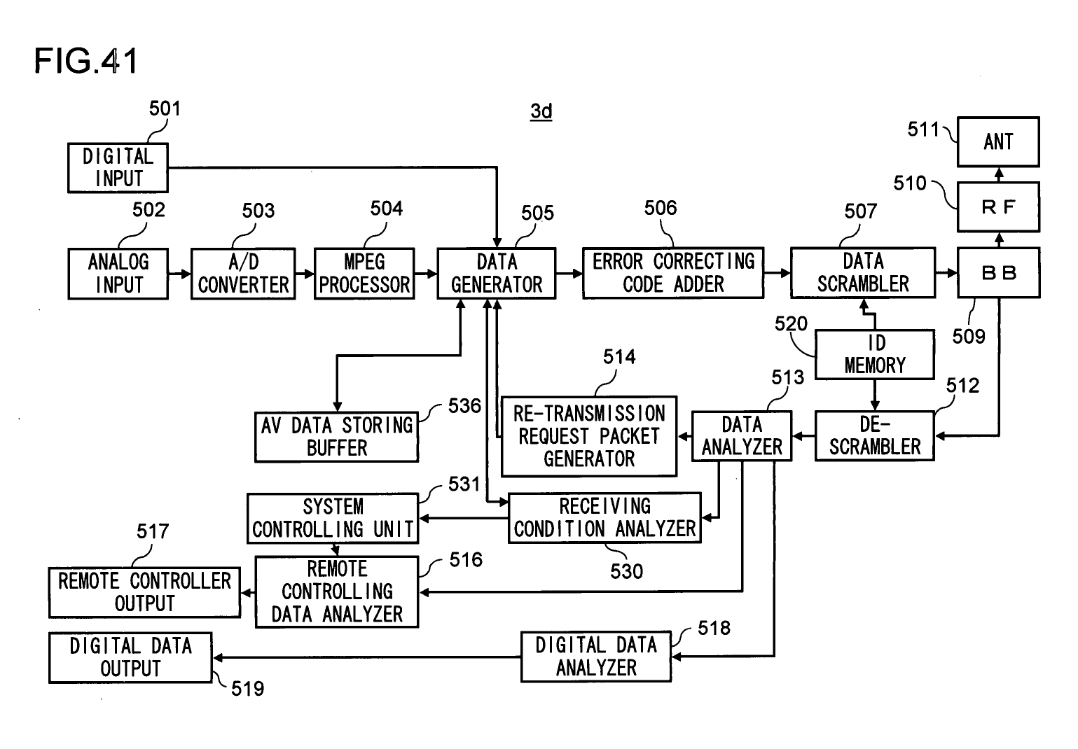

Referring to the accompanying drawings, the ninth embodiment of the present invention is described below. FIG. 41 is a simplified block diagram representing a constitution of an AV data transmitting device according to the ninth embodiment. Those components of the AV data transmitting device shown in FIG. 41 identical to those of the AV data transmitting device shown in FIG. 2 are respectively designated by identical reference numerals, where further description thereof is deleted here. The constitution of the AV data receiving device used for implementing the ninth embodiment conforms to the one shown in FIG. 59.

The AV data transmitting device 3d shown in FIG. 41 basically consists of the constitution of the AV data transmitting device 3 shown in FIG. 2 added with an AV data buffer 536 for storing data packet of AV data generated by a data generator 505. The AV data transmitting device 3d executes an operation for identifying the actual receiving condition as was performed in the first embodiment. When identifying the receiving condition, upon confirmation of the worsened receiving condition on the part of the AV data receiving device 4, the AV data transmitting device 3d stores the data packet consisting of a predetermined amount of AV data in the AV data buffer 536. When resuming the AV data reproducing operation after a provisional halt, the AV data transmitting device 3d transmits the AV data out from the data packet stored in the AV data buffer 536.

Those operations executed in steps 6 and 16 relative to the operation of the AV data transmitting device 3d for identifying the receiving condition in conformity with the flowchart shown in FIG. 3 or FIG. 4 are described below. If the receiving condition analyzer 530 confirms in step 5 or step 55 that the receiving condition on the part of the AV data receiving device 4 has become unstable, then, operating mode shifts to a provisional halt of the AV data transmission in step 6.

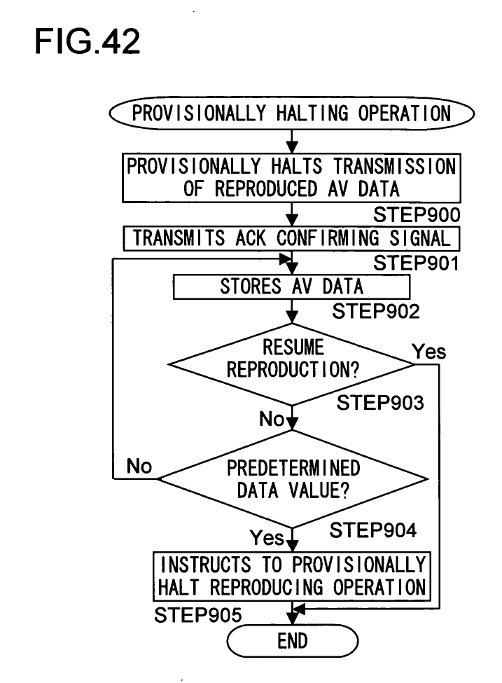

The receiving condition analyzer 530 operates itself in compliance with the flowchart shown in FIG. 42. First, step 900 is entered, in which the receiving condition analyzer 530 instructs the data generator 505 so as to cause transmission of AV data packet from an MEPG processor 504 or a digital data input terminal 501 to be halted provisionally. When the next step 901 is entered, the AV data transmitting device 3d commences transmission of a signal, pertaining to the AV data packet consisting of still image data at the starting point of the provisional halt, for confirming an ACK signal.

Next, the receiving condition analyzer 530 instructs the data generator 505 in step 902 so as to store the generated AV data packet in the AV data buffer 536. When storing the AV data packet in the AV data buffer 536, data related to the time representing the scene position of AV data in each data packet is also stored in the AV data buffer 536. Next, step 903 is entered, in which it is confirmed whether reproduction of the AV data should be resumed or not after shifting operation of the AV data transmitting device 3d to step 16. If it is confirmed that AV data reproduction should be resumed after shifting operation of the AV data transmitting device 3d to step 16 (YES), predetermined operations are terminated.

In the case in which the receiving condition remained unstable while step 903 was underway, and thus, operating mode was not able to shift to step 16 (NO), then, step 904 is entered, in which the data generator 505 checks to see if the amount of the AV data packet stored in the AV data buffer 536 has reached a predetermined amount of data, or not. If it is confirmed by the data generator 505 that a predetermined amount of data has not yet been secured (NO), then, step 902 is entered, in which operation for storing the AV data packet in the AV data buffer 536 is continued.

If it is confirmed in step 904 that the data stored in the AV data buffer 536 has reached a predetermined amount of data (YES), then, the system controlling unit 531 generates a unit operating data for causing the AV source apparatus 1 to provisionally halt the AV data reproducing operation, and then, while step 905 is entered, transmits the unit operating data to the AV source apparatus 1 via a remote controller output terminal 517. Concurrently, the act of instructing the AV source apparatus 1 to effect provisional halt of AV data reproduction is recorded in the receiving condition analyzer 530.

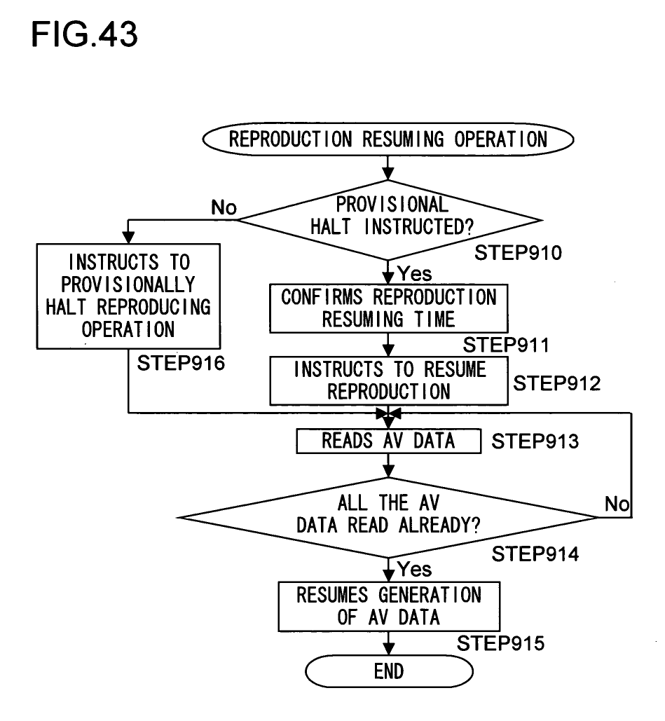

When it is confirmed by the receiving condition analyzer 530 in step 15 or step 58 that the receiving condition has become stable, operating mode shifts to step 16 so as to resume reproduction of AV data in compliance with the flowchart shown in FIG. 43. Next, step 910 is entered, in which the receiving condition analyzer 530 confirms whether the AV source apparatus 1 was instructed to provisionally halt its reproducing operation, or not. If it is confirmed that the instructions for the provisional halt were executed, then, step 911 is entered, in which the time representing the scene position of the AV data corresponding to the finally stored data packet among all the data packets stored in the AV data buffer 536 is confirmed as the AV data reproduction resuming time.

When the next step 912 is entered, the system controlling unit 531 generates a unit operating data for instructing the AV source apparatus 1 so as to resume reproduction of AV data from the scene position at the confirmed reproduction resuming time, and then transmits the unit operating data to the AV source apparatus 1 via the remote controller output terminal 517. Simultaneously with the transmission of the unit operating data for resuming reproduction of AV data to the AV source apparatus 1, the receiving condition analyzer 530 reads the data packet stored in the AV data buffer 536 out so as to transmit the data packet to the data generator 505, and then instructs the data generator 505 in the next step 913 so as to transmit the data packet to the AV data receiving device 4.

After commencing transmission of the data packet stored in the AV data buffer 536, step 914 is entered, in which it is confirmed whether the data packet stored in the AV data buffer 536 have fully been read out, or not. If there were such data packets still remaining in the AV data buffer 536 without being read out (NO), then, step 913 is entered, in which an ensuing data packet is read out and then transmitted to the AV data receiving device 4.

If no instructions were given to the AV source apparatus 1 in step 910 so as to provisionally halt the AV data reproducing operation (NO), then, the system controlling unit 531 generates a unit operating data for instructing the AV source apparatus 1 so as to halt the reproducing operation provisionally and resume reproduction of an output AV data corresponding to the next scene position against the presently output scene, and then transmits the unit operating data from the remote controller output terminal 517 in step 916. In this case, unlike the provisional halt performed in step 905 in the flowchart shown in FIG. 42, the AV source apparatus 1 is so instructed that it should enter into an operating condition to immediately resume reproduction of the AV data via the reproduction resuming operation, and then, those serial operations beyond step 913 are executed.

When it is identified in step 914 that all the data packets stored in the AV data buffer 536 have been read out (YES), then, step 915 is entered, in which the system controlling unit 531 instructs the data generator 505 so as to resume generation of data packets based on AV data transmitted from the MEPG processor 504 or the digital data input terminal 501. Accordingly, transmission of AV data packets from the AV data buffer 536 is terminated, thereby enabling the AV source apparatus 1 to commence transmission of AV data.

The AV data transmitting device 3d operates itself as described above, whereas the AV source apparatus 1 was instructed in step 905 to provisionally halt own operation and then further instructed in step 912 so as to resume own reproducing operation. When the AV source apparatus 1 was instructed to resume own reproducing operation, the AV data buffer 536 stores the AV data packets corresponding to the time intervals ranging from the time at which instructions were given so as to resume reproduction of AV data up to the time at which reproduction of AV data from the specified scene position is actually resumed. Accordingly, when the data packet corresponding to the above time intervals are read out from the AV data buffer 536, the reproduction resumed AV data is transmitted from the AV source apparatus 1 to the AV data transmitting device 3d. As a result, it is no longer necessary for the AV data transmitting device 3d to remain in the standby mode while the AV source apparatus 1 remains in the standby mode for resuming reproduction of AV data. Accordingly, simultaneously with confirmation of the resumed reproduction of AV data, the AV data transmitting device 3d transmits the AV data packet stored in the AV data buffer 536 immediately.

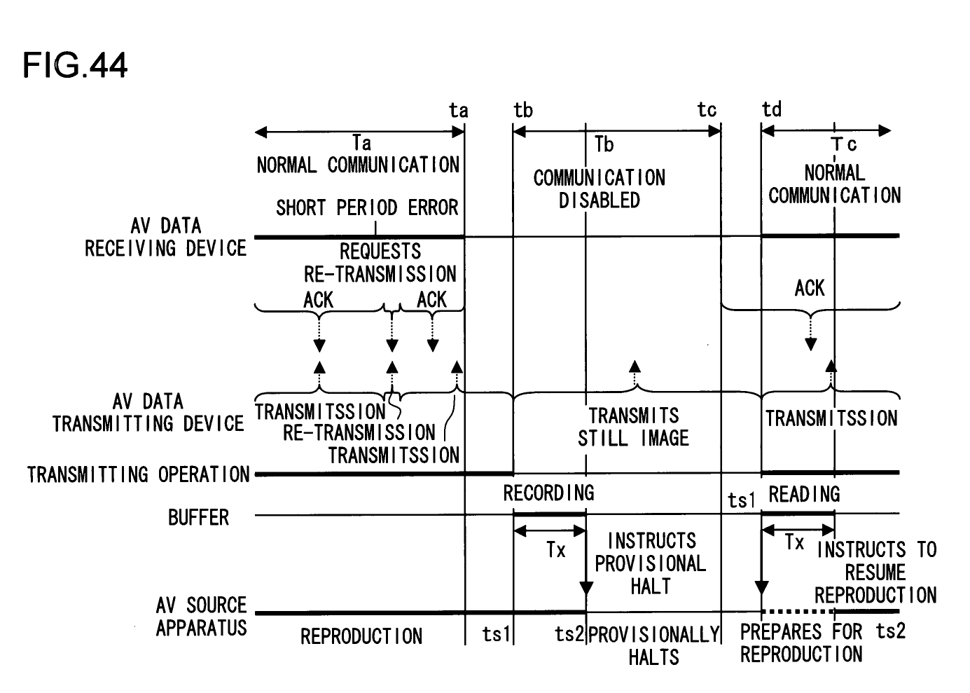

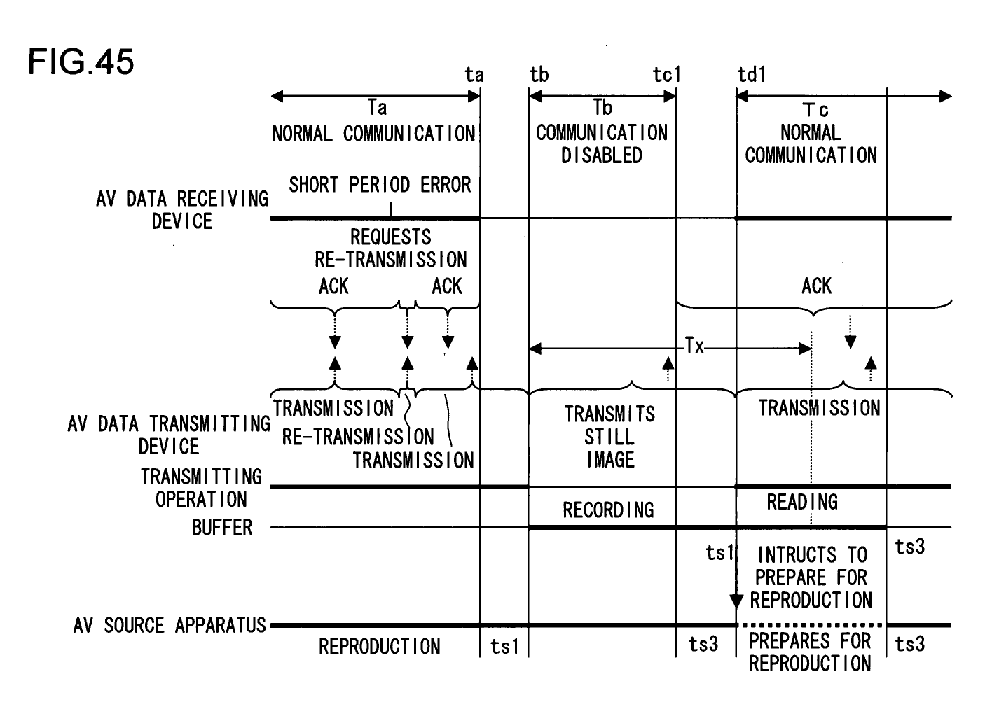

Referring now to the timing charts shown in FIG. 44 and FIG. 45, serial operations of the AV data transmitting device 3d, the AV data receiving device 4, and the AV source apparatus 1 of the AV data radio communication system using the above AV data transmitting device 3d are described below. As was performed for the first embodiment and as shown in the timing chart of FIG. 44, while a period Ta is present, without causing the receiving condition of the AV data receiving device 4 to be worsened, in response to the ACK signal and the retransmission request signal from the AV data receiving device 4, the AV data transmitting device 3d executes retransmission and further transmission of AV data. Concurrently, the AV source apparatus 1 executes reproduction of AV data and simultaneously outputs the AV data to the AV data transmitting device 3d.

When the receiving condition of the AV data receiving device 4 has become unstable at the time “ta”, the AV data transmitting device 3d confirms at time “tb” that the receiving condition on the part of the AV data receiving device 4 has already been worsened. Simultaneously, the AV data transmitting device 3d halts its own operation for transmitting reproduced AV data and commences transmission of signal including still image for confirming the ACK signal from the AV data receiving device 4, and simultaneously starts an operation for recording AV data packets corresponding to a predetermined period of time Tx. When these AV data packets have been recorded in the AV data buffer 536, the AV data transmitting device 3d causes the AV source apparatus 1 to provisionally halt own reproducing operation, and simultaneously causes the AV data buffer 536 to halt own recording operation. Concurrently, a certain number of AV data packets, comprising time units for representing the AV data scene positions ranging from “ts1” to “ts1”+Tx (=ts2), are recorded.

Thereafter, as was confirmed in the first embodiment, when the time “tc” has come, the receiving condition on the part of the AV data receiving device 4 has become stable. The AV data transmitting device 3d confirms at time “td” that the receiving condition on the part of the AV data receiving device 4 has been stabilized. Concurrently, the AV data transmitting device 3d sequentially reads the AV data packets comprising the time unit “ts1” representing the AV data scene position recorded in the AV data buffer 536, and then transmits this AV data packet to the AV data receiving device 4. Next, the AV data transmitting device 3d instructs the AV source apparatus 1 to resume reproduction of the AV data from the one having the time unit “ts2” representing the AV data scene position.

Next, when a predetermined period of time TX elapses, all the AV data stored in the AV data buffer 536 are read out and then transmitted to the AV data receiving device 4. Thereafter, the AV source apparatus 1 sequentially transmits the AV data corresponding to the one beyond “ts2” of the time unit representing the AV data scene position to the AV data transmitting device 3d, and then, the AV data transmitting device 3d transmits the above AV data to the AV data receiving device 4.

As was seen from the timing chart of FIG. 45 and as was performed in the first embodiment, when a period of time “Ta” is present, serial operations for reproducing AV data are executed by the AV source apparatus 1, the AV data transmitting device 3d, and the AV data receiving device 4 without causing the receiving condition of the AV data receiving device 4 to be worsened. When time “ta” has come, the receiving condition of the AV data receiving device 4 has become unstable. The unstable receiving condition is confirmed by the AV data transmitting device 3d at the time “tb”. Simultaneously, as was performed via the timing chart shown in FIG. 44, the AV data transmitting device 3d commences transmission of signal including still image so as to confirm the ACK signal and further commences an operation for recording the above AV data in the AV data buffer 536.

Based on the above sequence, the AV data transmitting device 3d serially records AV data from the one corresponding to the time “ts1” representing the AV data scene position into the AV data buffer 536. Thenceforth, during a period from the start of the AV data recording into the AV data buffer 536 up to the elapse of the time “Tx”, the receiving condition of the AV data receiving device 4 becomes stable at the time “tc1”. When the AV data transmitting device 3d confirms this effect at the time “td1”, the AV data transmitting device 3d instructs the AV source apparatus 1 to provisionally halt own reproducing operation as of the state complete with a preparation for reproduction starting from the AV data having the time unit for representing the AV data scene position expressed as “ts1+td1−tb (=ts3).

Next, the AV data transmitting device 3d serially reads the data packets out from the AV data buffer 536 from the AV data packet having the time unit “ts1” for representing the AV data scene position, and then transmits the data packets to the AV data receiving device 4. Thenceforth, after elapsing a period of time “td1 to tb”, when all the AV data stored in the AV buffer 536 are read out and transmitted to the AV data receiving device 4. Thereafter, the AV source apparatus 1 serially transmits the AV data having the time units for representing the AV data scene position beyond “ts3” to the AV data transmitting device 3d, and then, these AV data are transmitted to the AV data receiving device 4.

In the ninth embodiment, it is also allowable to implement those serial processes as cited below. While the AV data transmitting device 3d still transmits AV data, it is allowable for the data generator 505 to provisionally store the data packets generated from the AV data from the AV source apparatus 1 in the AV data buffer 536, and then, after a reading operation, transmit the data packets to an error correcting code adder 506. In this case, when the provisional halting mode has been entered, the data generator 505 provisionally halts own operation for reading AV data out from the AV data buffer 536. In the meanwhile, the AV data packets are stored in the AV data buffer 536 until reaching a predetermined amount. Then, when the AV data reproducing operation has been resumed, it is also possible to resume reading of the data packets from the AV data buffer 536 and external delivery of AV data from the AV source apparatus 1.

In the course of transmitting the above AV data and storing the AV data packets in the AV data buffer 536, it is also allowable to store the transmitted AV data packets in the AV data buffer 536 by the amount corresponding to an overlap time that can be set. Concretely, it is possible to set up to an overlap time “tx”. Assuming that the time representing the AV data scene position in the presently transmitted data packet is “t1”, it is possible for the AV data buffer 536 to store those data packets up to the one having the time “t1−tx” for representing the AV data scene position. Based on this arrangement, it is possible to resume reproduction of AV data from respective scene positions up to the AV data corresponding to the scene position tracing back to the overlap time “tx” from the AV data at the provisionally halted scene position.

Like the first embodiment, the AV data transmitting device according to the ninth embodiment is arranged to confirm the receiving condition of the AV data receiving device. However, like the second embodiment, it is also allowable to cause the AV data receiving device to confirm its own receiving condition, and then, instructs the AV reproduction apparatus to provisionally halt an operation for reproducing AV data and resume the AV data reproducing operation. In this case, like the second embodiment, the AV data receiving device conforms to the constitution shown in FIG. 8, whereas the AV data transmitting device conforms to the constitution shown in FIG. 41 incorporating an AV data buffer.

The above description on the AV data transmitting device and the AV data receiving device related to the ninth embodiment has been made based on the AV data transmitting and receiving devices in the AV data radio communication system of the first embodiment. However, it is also allowable to further provide them with operational functions of the AV data transmitting and receiving devices of the AV data radio communication systems related to the third to eighth embodiments of the present invention.

In the first to ninth embodiments, the AV data transmitting device is installed discretely from the AV source apparatus without performing tuning operation and an AV data reading operation from a recording medium. However, it is also allowable to provide the AV data transmitting device with operational function of the AV source apparatus in the above embodiments. In this case, the AV data transmitting device is enabled to perform tuning operation, reading of AV data from a recording medium, and generation of AV data. Furthermore, by instructing the AV source apparatus to provisionally halt own reproducing operation or resume the reproducing operation, it is possible to execute those functional operations in the first to ninth embodiments.

Further, in the first to ninth embodiments, it is so arranged that the AV data receiving device is installed discretely from the AV data reproducing apparatus without implementing a video reproducing operation and speech output operation. However, it is also allowable to provide the AV data receiving device with operational functions of an AV data reproducing apparatus in the above embodiments. In this case, the AV data receiving device is enabled to reproduce video data from the received AV data and output speech data as well.

Further, in the first to ninth embodiments, it is so arranged that, when the receiving condition of the AV data receiving device has become unstable, still image data is transmitted to the AV data receiving device. However, it is also allowable to have the AV source apparatus 1 continuously perform the AV data reproducing operation and enable the AV data transmitting device to continuously transmit reproduced moving image transmitted from the AV source apparatus 1. In this case, when it is identified that the receiving condition of the AV data receiving device has become unstable, the time representing the AV data scene position at the detected moment is recorded as the reproduction resuming time. Then, after being confirmed that the receiving condition of the AV data receiving device has been stabilized, instructions are transmitted to the AV data transmitting device and the AV source apparatus so as to resume the AV data reproduction from the scene corresponding to the recorded reproduction resuming time. In this case it is also allowable to determine this reproduction resuming time based on the overlap time or the error generated time.

The Tenth Embodiment:

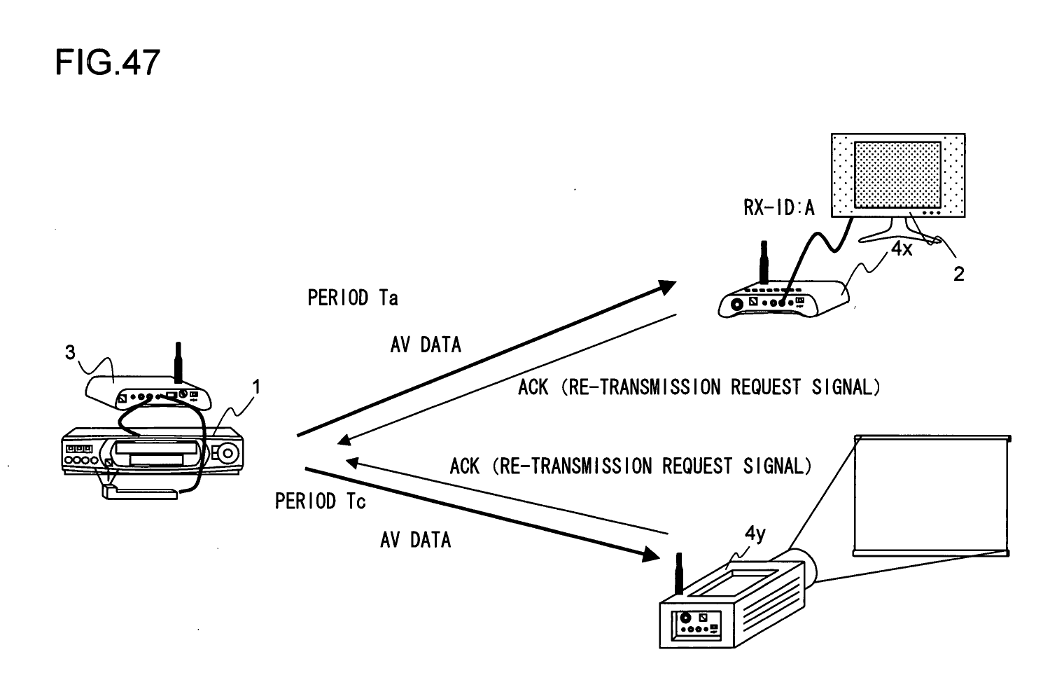

Referring to the accompanying drawings, the tenth embodiment of the present invention is described below. FIG. 47 is a simplified block diagram for explanatory of the constitution of the AV data radio communication system according to the tenth embodiment. Like any of the first, and the third to seventh, and the ninth embodiment, in the tenth embodiment, the AV data transmitting device confirms the receiving condition of the AV data receiving device. Concretely, like the first embodiment, the AV data transmitting device conforms to the constitution shown in FIG. 2, whereas the AV data receiving device conforms to the constitution shown in FIG. 59. Details of the tenth embodiment are described based on the constitution of the first embodiment. It should be understood that operational functions of the tenth embodiment are also applicable to any of the third to seventh embodiments and the ninth embodiment as well.

In the tenth embodiment, as shown in FIG. 47, a pair of AV data receiving devices 4x and 4y based on the constitution shown in FIG. 59 respectively perform radio communication with the AV data transmitting device 3 based on the constitution shown in FIG. 2. The AV data receiving device 4y basically consists of the constitution shown in FIG. 59 added with operational function of an AV data reproducing apparatus 2. The AV data receiving device 4y is enabled to reproduce and display video data and output speech data from the received AV data.

More particularly, an ID code A available for transmission is stored in an ID memory 520 loaded in the AV data transmitting device 3. On the other hand, an ID code A available for reception is stored in an ID memory 560 loaded in the AV data receiving devices 4x and 4y. Based on this arrangement, an AV data is initially enciphered by the ID code A stored in the ID memory 520 loaded in the AV data transmitting device 3, and then, the enciphered AV data is received by the AV data receiving devices 4x and 4y. Then, the enciphered AV data is deciphered by the ID code A stored in the ID memory 560. Based on this arrangement, an AV data radio communication system can be established between the AV data transmitting device 3 and a pair of AV data receiving devices 4x and 4y.

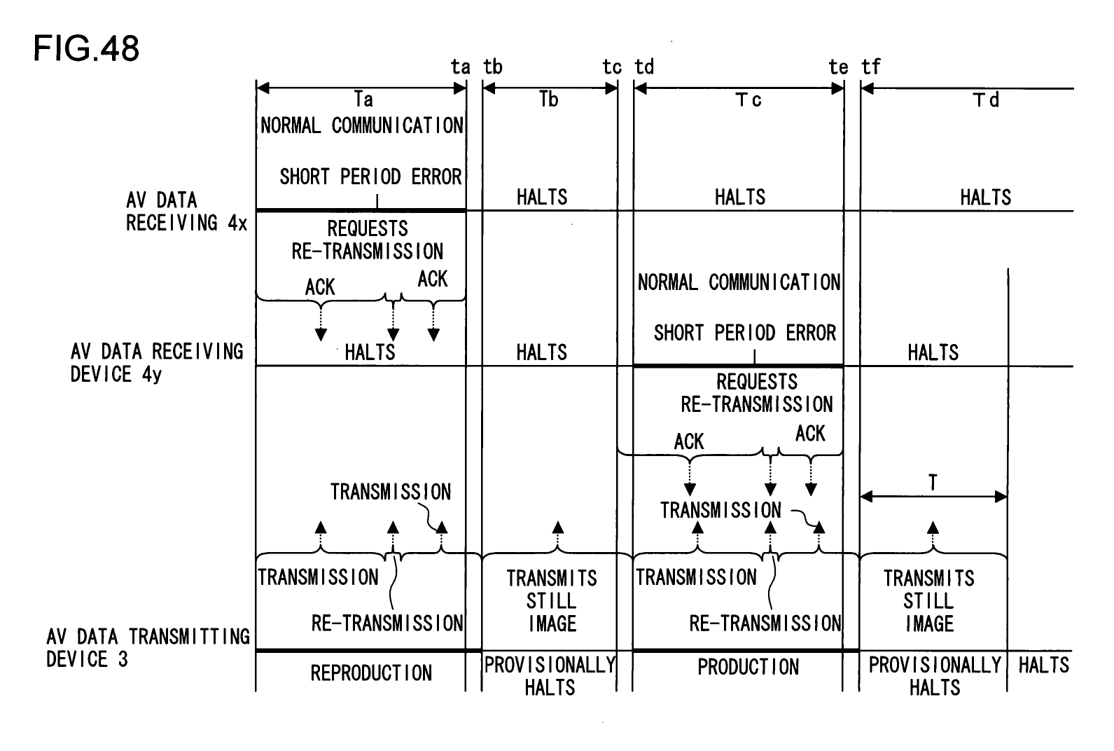

Referring now to the timing chart shown in FIG. 48, serial operations executed by the AV data transmitting device 3 and a pair of AV data receiving devices 4x and 4y are described below. First, while a period Ta remains, when the AV data receiving device 4x normally receives an AV data transmitted from the AV data transmitting device 3, concurrently, the AV data transmitting device 3 is enabled to receive an ACK signal or a retransmission request signal from the AV data receiving device 4x, thereby confirming that the AV data receiving device 4x normally receives the AV data. Inasmuch as there is merely a very short duration of error generated period in the above period Ta, based on the retransmitted AV data, it is possible for the AV data reproducing apparatus 2 to normally and fully reproduce the above AV data. In the meanwhile, the other AV data receiving device 4y remains in a halt.

When a time “ta” has come, the AV data receiving device 4x is turned off so as to halt its operation. This in turn disables the AV data transmitting device 3 from receiving the ACK signal or the retransmission request signal from either of the AV data receiving devices 4x and 4y. When the following time “tb” has come, the AV data transmitting device 3 confirms that the number of rounds that failed to receive the ACK signal or the retransmission request signal has reached a predetermined number of rounds X1 or confirms that the number of rounds in receipt of the ACK signal within a predetermined period of time T2 has become less than a predetermined number of rounds Y2. Based on the confirmed result, the AV data transmitting device 3 instructs the AV source apparatus 1 to provisionally halt own operation, and then, in order to confirm reception of the ACK signal from either of the AV data receiving devices 4x and 4y, commences transmission of data signals including still image AV data.

While the period “Tb” remains, the AV data receiving devices 4x and 4y respectively remain in a halt, whereas the AV data transmitting device 3 continuously transmits data signals including still image AV data. When the following time “tc” has come, power supply source of the AV data receiving device 4y is turned ON, and then, in response to data signals transmitted from the AV data transmitting device 3, the ACK signal is transmitted from the AV data receiving device 4y. Accordingly, when the following time “td” has come, the AV data transmitting device 3 confirms that the number of rounds in receipt of the ACK signal from the AV data receiving device 4y has exceeded a predetermined value Y1, or confirms that the rate of receiving thee ACK signal from the AV data receiving device 4y has exceeded a predetermined rate Z1.

Based on the confirmed result, when the time “td” has come, the AV data transmitting device 3 instructs the AV source apparatus 1 to resume the AV data reproducing operation from the scene at which the AV data reproducing operation was provisionally halted, and then transmits the AV data beyond the provisionally halted scene to the AV data receiving device 4y. In this way, the AV data transmitting device 3 transmits the AV data to the AV data receiving device 4y, thereby enabling the AV data reproducing operation to be resumed. During the period Tc, while the AV data receiving device 4y remains in the state capable of exchanging communication, as was done in the period Ta, in response to the AV data transmitted from the AV data transmitting device 3, the AV data receiving device 4y transmits the ACK signal or the retransmission request signal to the AV data transmitting device 3.

When the following time “te” has come, the power supply source is turned off from the AV data receiving device 4y so as to halt its operation. When the next time “tf” has come, the AV data transmitting device 3 confirms that the number of rounds that failed to receive the ACK signal or the retransmission request signal has reached a predetermined number of rounds X1 or confirms that the number of rounds in receipt of the ACK signal has become less than a predetermined number of rounds Y2. Based on the confirmed result, when the time “tf” has come, the AV data transmitting device 3 instructs the AV source apparatus 1 to provisionally halt own operation, and then transmits data signals including still image AV data.

While the period Td is underway, power supply sources of the AV data receiving devices 4x and 4y remain being OFF. In the meanwhile, until a predetermined period of time T is past, the AV data transmitting device 3 does not confirm reception of the ACK signal from either of the AV data receiving devices 4x and 4y. In the case in which the number of rounds in receipt of the ACK signal failed to reach a predetermined number of rounds Y1, or when the rate of receiving the ACK signal failed to reach a predetermined rate Z1, the AV data transmitting device 3 instructs the AV source apparatus 1 to halt own operation. Simultaneously, transmission of data signals including still image AV data is also brought to a halt.

By providing the tenth embodiment with the above-described constitution, it is possible for plural AV data receiving devices 4, that are communication-approved against an identical AV data transmitting device 3, to perform communicating operations identical to those which were performed for the first embodiment. More particularly, in the event if a unit of AV data receiving device 4 currently executing an AV data receiving operation fell into the state no longer capable of exchanging communication, operation of the AV source apparatus 1 is brought to a provisional halt, and then, when any of plural units of AV data receiving devices 4 has restored the receivable condition, the AV source apparatus 1 is released from the state of halting own operation provisionally so as to resume the AV data reproducing operation thenceforth.

By constituting the operational components as practiced in the third embodiment, it is also possible for the tenth embodiment to vary the judging values for switching the provisional halting operation to and from the reproduction resuming operation. Further, by way of forming the operational components as practiced in the fourth or sixth embodiment, it is possible to set an overlap time against the time for resuming AV data reproduction. Further, by way of forming the operational components as practiced in the fifth embodiment, it is possible to provide the AV data recorded during a provisional halt with time-wise allowance. Further, by way of forming the operational components as practiced in the sixth embodiment, it is possible to confirm whether an alleged user corresponds to the one who has actually instructed the system to provisionally halt operation or not, and then approve the authentic user to resume reproduction of AV data. Further, by way of forming the operational components as was practiced in the seventh embodiment, it is possible to set the moment at which receiving error occurred in the AV data receiving device as the time for resuming reproduction of AV data. Further, by way of constituting the operational components as practiced in the ninth embodiment, it is possible to store data signals in a buffer loaded in the AV data transmitting device, thereby dispensing with the needs otherwise required to hold the AV data transmitting device on the standby mode until operation of the AV source apparatus 1 is actuated before resuming reproduction of AV data.

The Eleventh Embodiment:

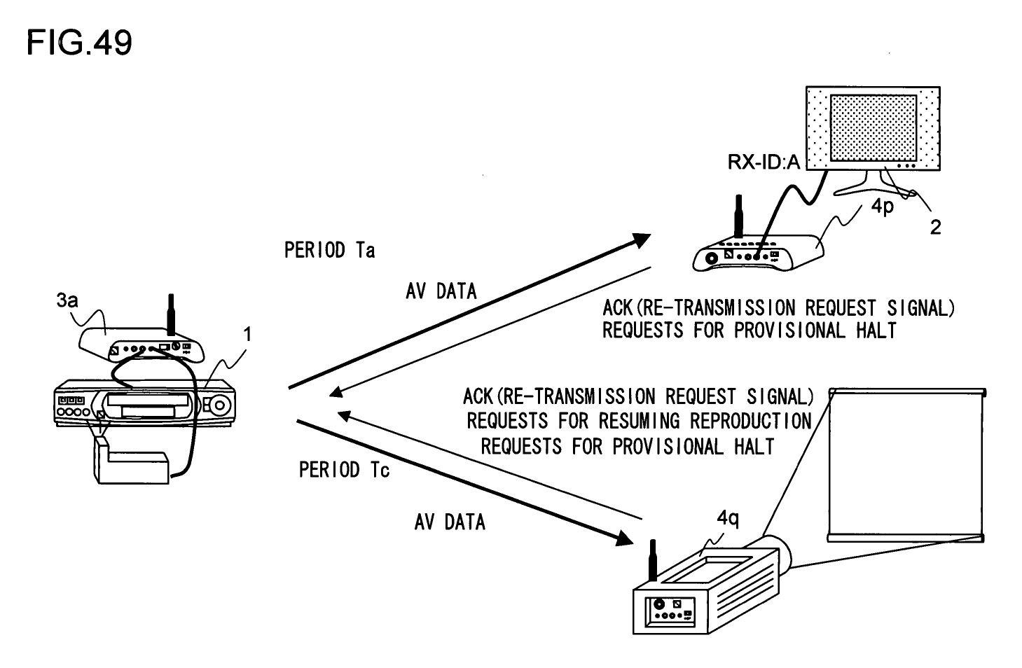

Referring now to the accompanying drawings, the eleventh embodiment of the present invention is described below. FIG. 49 is a simplified block diagram representing the constitution of the AV data radio communication system according to the eleventh embodiment. In this embodiment, as was practiced in any of the second to sixth, and the eighth, and the ninth embodiment, the AV data receiving devices individually confirm own receiving condition. Concretely, like the second embodiment, the AV data transmitting device is formed in conformity with the constitution shown in FIG. 58, whereas the AV data receiving devices are respectively formed in conformity with the constitution shown in FIG. 8. Details of the eleventh embodiment are described by referring to the constitution of the second embodiment. However, it is also practicable to apply operational function of the eleventh embodiment to those constitutions related to any of the third to sixth, and the eighth or ninth embodiment.

As shown in FIG. 49, in this embodiment, a pair of AV data receiving devices 4p and 4q having the constitution as shown in FIG. 8 individually exchange radio communication with an AV data transmitting device 3a having the constitution as shown in FIG. 58. The AV data receiving device 4q basically consists of the constitution shown in FIG. 8 added with operational function of an AV data reproducing apparatus 2. The AV data receiving device 4q is capable to reproduce and display video image and output speech data from the received AV data.

Concretely, the AV data transmitting device 3a stores a transmitting ID code A in its ID memory 520, whereas the AV data receiving devices 4p and 4q individually store a receiving ID code A in each of their ID memory 560. When an AV data enciphered by the ID code A stored in the ID memory 520 loaded in the AV data transmitting device 3a is received by the AV data receiving devices 4p and 4q, the enciphered AV data is then deciphered by the ID code A stored in the ID memory 560. Based on this arrangement, an AV data radio communication system can be established between the AV data transmitting device 3a and a pair of AV data receiving devices 4p and 4q.

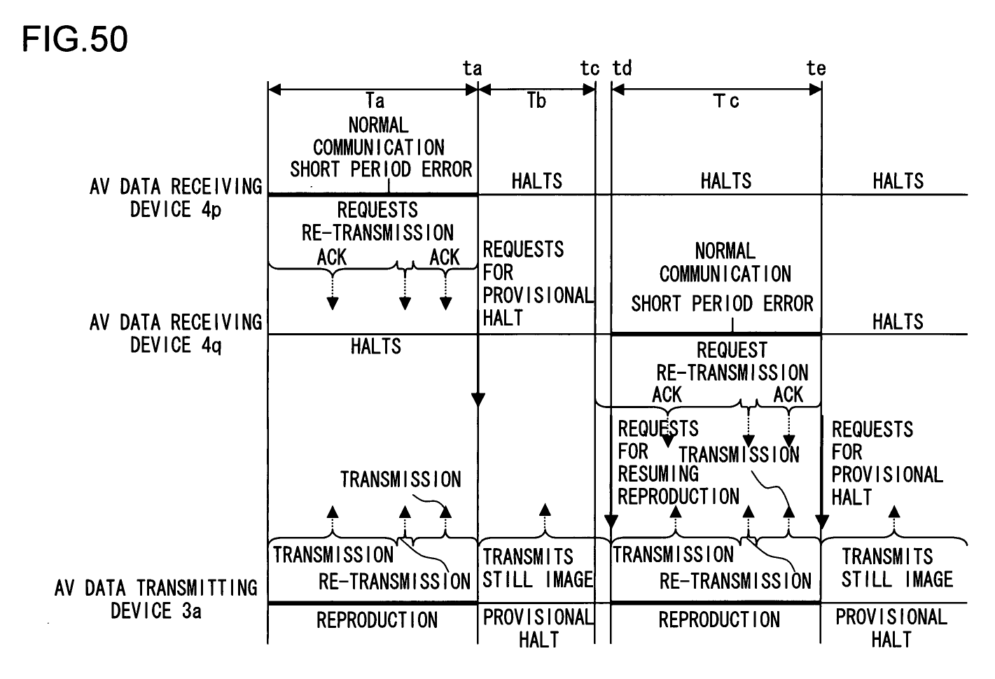

Referring now to the timing chart shown in FIG. 50, details of operational functions of the AV data transmitting device 3a and a pair of AV data receiving devices 4p and 4q are described below. First, while a period Ta is underway, it is assumed that the AV data receiving device 4p normally keeps on receiving the AV data transmitted from the AV data transmitting device 3a. In this case, the AV data receiving device 4p confirms that the receiving operation is normally carried on without causing the receiving error or the speech error to be generated continuously by more than a predetermined number of rounds P1. In other words, inasmuch as duration of receiving error occurring within the period Ta is very short, in the course of executing retransmission of AV data, the AV data reproducing apparatus 2 is enabled to normally and fully reproduce AV data. In this case, the AV data receiving device 4q remains in a halt.

When a time “ta” has come, the AV data receiving device 4p is turned off so as to halt its operation. Simultaneously, in order to cause the AV source apparatus 1 to provisionally halt own operation, the halted AV data receiving device 4p transmits a unit operating data to the AV data transmitting device 3a. Upon reception of the unit operating data, the AV data transmitting device 3a instructs the AV source apparatus 1 so as to halt own operation provisionally, and simultaneously commences transmission of data signals including still image AV data.

Then, when the next period Tb is present, the AV data receiving devices 4p and 4q respectively remain in a halt, whereas the AV data transmitting device 3a keeps on transmitting data signals including still image AV data. When the time “tc” is entered, power supply source of the AV data receiving device 4q is turned ON, thereby actuating own operation to receive data signals transmitted from the AV data transmitting device 3a. When the following time “td” is entered, the AV data receiving device 4q confirms that the data signals transmitted from the AV data transmitting device 3a has normally been received and the number of the rounds of transmission of the ACK signal has exceeded a predetermined number of rounds Q1. After confirming the above results, the AV data receiving device 4q transmits a unit operating data to the AV source apparatus 1 so as to resume an operation for reproducing an AV data starting from the provisionally halted scene.

Upon reception of the unit operating data, the AV data transmitting device 3a instructs the AV source apparatus 1 to resume an AV data reproducing operation, and further instructs the AV source apparatus 1 to resume transmission of the AV data beyond the provisionally halted scene. In this way, by resuming transmission of the AV data, the AV data reproducing operation is also resumed. While the period Tc is present, insofar as the AV data receiving device 4q remains in the state capable of normally executing communication, as in the period Ta, in response to the AV data transmitted from the AV data transmitting device 3a, then the AV data receiving device 4q transmits the ACK signal or the retransmission request signal to the AV data transmitting device 3a.

When the time “te” has come, the AV data receiving device 4q is turned off, and then, the AV data receiving device 4q transmits a unit operating data to the AV data transmitting device 3a so as to instruct the AV source apparatus 1 to provisionally halt own operation. Upon receipt of the unit operating data, the AV data transmitting device 3a provisionally halts operation of the AV source apparatus 1 and transmits data signal including still image AV data to the AV source apparatus 1.

By forming the above constitution for this embodiment, it is possible for plural AV data receiving devices 4a, duly approved for communicating with an identical AV data transmitting device 3a, to executes those serial operation identical to the second embodiment between. More particularly, when the power supply source of the AV data receiving device 4a is turned off, operation of the AV source apparatus 1 is provisionally halted, and then, when one of plural units of the AV data receiving devices 4a has restored the data receivable condition, the AV source apparatus 1 is released from the provisionally halted condition, thereby enabling to resume the AV data reproducing operation. Note that, not only in the case of power-off condition, but the provisional halting operation is also entered when the communicating routes remain unstable, thereby resulting in the interruption of radio communication.

When implementing the present embodiment, by arranging the system constitution as prepared for the third embodiment, it is possible to vary the judging value for switching the provisional halting operation to and from the operation for resuming the AV data reproduction. Further, by forming the constitution as in the fifth embodiment, it is possible to provide the AV data recorded during the provisional halting mode with time-wise allowance. Further, by forming the constitution as in the sixth embodiment, it is possible to confirm whether an alleged user corresponds to the one who has instructed to provisionally halt the AV data reproducing operation or not, and then approve the authentic user to resume reproduction of the AV data. Further, by forming the constitution as in the eighth embodiment, it is possible to set the time at which the receiving error has occurred in the AV data receiving device as the reproduction resuming time. Further, by forming the constitution as in the ninth embodiment, it is possible to store data signals in a buffer loaded in the AV data transmitting device, thereby dispensing with the needs otherwise required for holding the AV data transmitting device on the standby mode until the AV source apparatus 1 actuates own operation when resuming the AV data reproducing operation.

The Twelfth Embodiment:

Referring to the accompanying drawings, the twelfth embodiment of the present invention is described below. As was performed in any of the first, and the third to seventh, and the ninth embodiment, in this embodiment, the AV data transmitting device confirms the receiving condition on the part of the AV data receiving device. Concretely, as was provided for the first embodiment, the AV data transmitting device conforms to the constitution shown in FIG. 2, whereas the AV data receiving device conforms to the constitution shown in FIG. 59. Details of the twelfth embodiment are described below based on the constitution of the first embodiment. However, it is possible to apply operational function of the present embodiment to the third to seventh embodiments or the ninth embodiment. Note that a specific function causing the AV data reproduction to be halted provisionally or resumed in correspondence with the actual receiving condition on the part of the AV data receiving device as was performed for the preceding embodiments will be referred to as the “receiving condition rising operation controlling function” in the following description.

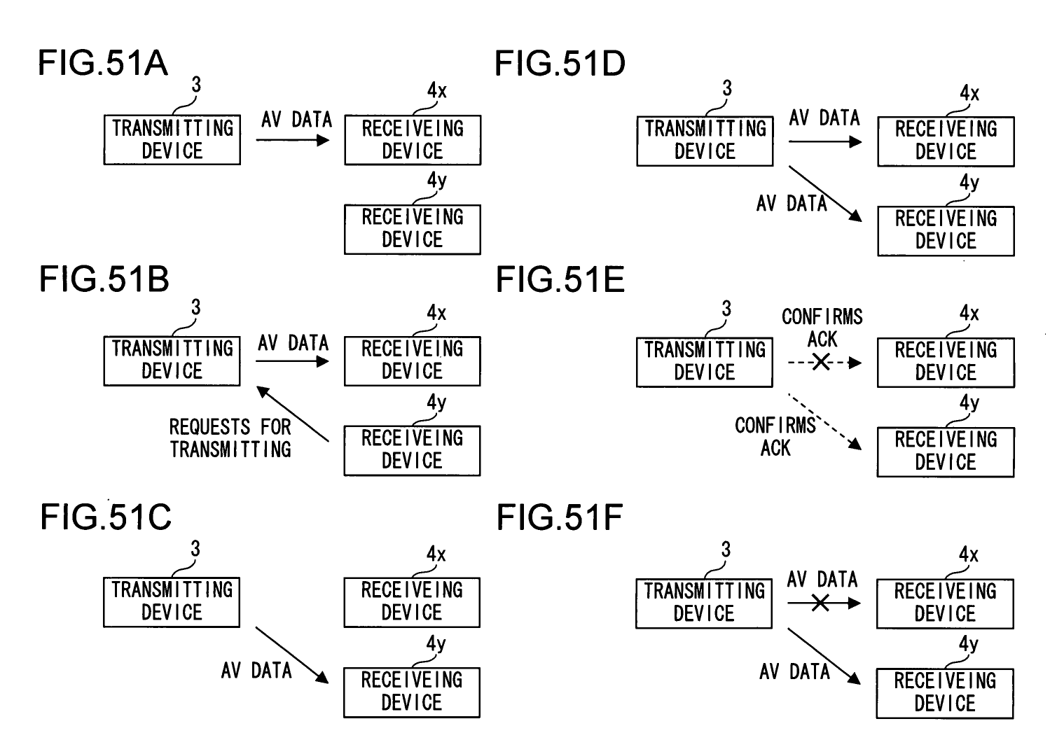

This embodiment provides an AV data radio communication system consisting of an AV data transmitting device 3 and an AV data receiving device 4x as shown in FIG. 51A, in which the AV data transmitting device 3 executes the receiving condition rising operation controlling function, and confirms the actual receiving condition of the AV data receiving device 4x. Concurrently, in response to the actual receiving condition on the part of the AV data receiving device 4x, the AV data transmitting device 3 controls reproduction of AV data so as to provisionally halt or resume the reproducing operation.

Simultaneously, as shown in FIG. 51B, the AV data receiving device 4y transmits a signal requesting for the AV data transmission to the AV data transmitting device 3. Upon reception of this signal the AV data transmitting device 3 confirms that the AV data receiving device 4y requests for transmission of AV data. Although not shown in FIG. 2, a controlling signal is transmitted from a receiving condition analyzer 530 installed in the AV data transmitting device 3 to a data generator 505.

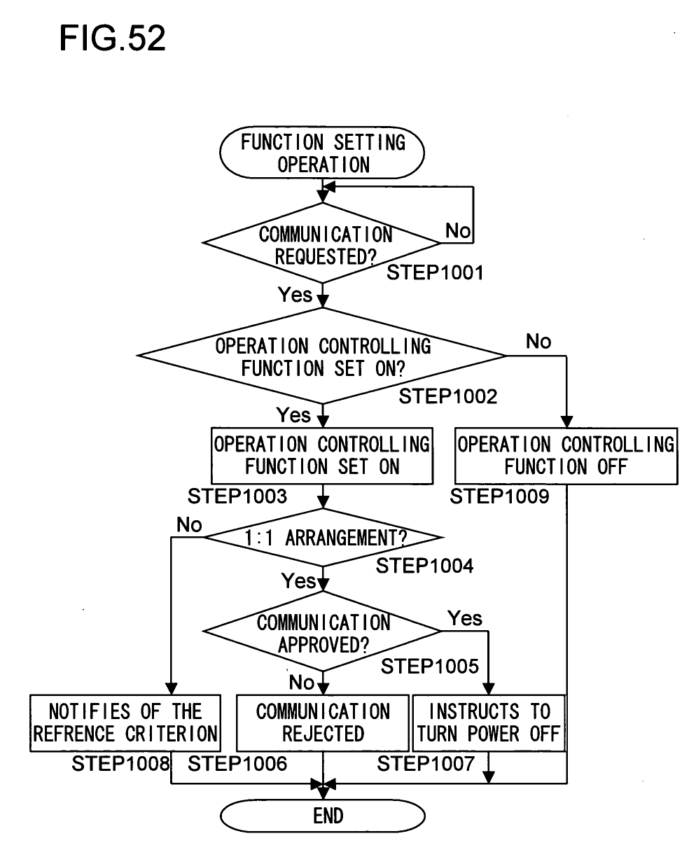

Referring now to the flowchart shown in FIG. 52, serial operations performed by the AV data transmitting device 3 in response to a request from another AV data receiving device 4y for exchanging radio communication with the AV data transmitting device 3 while the data transmitting and receiving devices 3 and 4x mutually exchange radio communication based on one-to-one relationship. As just mentioned, while the AV data transmitting device 3 exchanges radio communication with the AV data receiving device 4x based on the one-to-one relationship, a data analyzer 513 confirms in step 1001 whether the AV data transmitting device 3 has actually received a signal requesting for transmission of an AV data from another AV data receiving device 4 (i.e., the AV data receiving device 4y shown in FIG. 51A to FIG. 51F) other than the AV data receiving device 4x, or not.

Concurrently, as shown in FIG. 51B, when the AV data transmitting device 3 confirms that it has received a signal from the other AV data receiving device 4y requesting for transmission of an AV data (YES), then, step 1002 is entered, in which the receiving condition analyzer 530 confirms whether the receiving condition rising operation controlling function has been set, or not. Note that the receiving condition rising operation controlling function is determined to be operable or inoperable when exchanging radio communication of AV data with plural units of the AV data receiving devices 4. When actuating the receiving condition rising operation controlling function, criterion of the receiving condition is selected from any of those AV data receiving devices 4 participating in the AV data radio communication.

When it is confirmed that application of the receiving condition rising operation controlling function has been arranged (YES), then, step 1003 is entered so as to actuate the receiving condition rising operation controlling function. Next, step 1004 is entered, in which the receiving condition analyzer 530 confirms whether the AV data radio communication has been set based on the one-to-one relationship, or not. If the one-to-one relationship has been set (YES), then, step 1005 is entered, in which it is confirmed whether transition to an AV data receiving device 4 other than the one (i.e., the AV data receiving device 4x shown in FIG. 51A to FIG. 51F) currently engaged in the AV data radio communication has been approved, or not.

While step 1005 is underway, when it is confirmed that participation in the AV data radio communication has not yet been approved against the other AV data receiving device 4 (NO), then, the data generator 505 generates a signal for notifying of the impracticability to participate in the AV data radio communication, and then, in the following step 1006, transmits this signal to the AV data receiving device 4 (i.e., the AV data receiving device 4y shown in FIG. 51A) that raised a request for transmission of an AV data in the initial step 1001. Accordingly, as shown in FIG. 51A, AV data radio communication is solely executed between the AV data transmitting device 3 and the AV data receiving device 4x.

On the other hand, when it is confirmed in step 1005 that participation in the AV data radio communication has been approved for the other AV data receiving device 4y (YES), in response, the data generator 505 generates a signal for instructing to turn the power off, and then, step 1007 is entered, in which this signal is transmitted to the AV data receiving device 4 (i.e., the AV data receiving device 4x shown in FIG. 51A to FIG. 51F) currently engaged in the AV data radio communication. Accordingly, as shown in FIG. 51C, AV data radio communication is solely executed between the AV data transmitting device 3 and the AV data receiving device 4y at this moment.

While step 1004 is underway, if the AV data radio communication were not based on the one-to-one relationship (NO), then, the receiving condition analyzer 530 confirms a specific AV data receiving device 4 for constituting the reference unit when actuating the receiving condition rising operation controlling function, and then, instructs the data generator 505 to generate a signal for notifying all the AV data receiving devices 4 of the selected AV data receiving device 4 for designating the reference receiving condition. Then, step 1008 is entered, in which this signal is transmitted to all the AV data receiving devices 4 expected to participate in the AV data radio communication. Thenceforth, the AV data transmitting device 3 participates in the AV data radio communication applying the receiving condition rising operation controlling function together with plural units of the AV data receiving devices.

More particularly, in the course of executing an AV data radio communication with the AV data receiving devices 4x and 4y, assuming that the receiving condition rising operation controlling function is actuated by designating the receiving condition of the AV data receiving device 4x as the reference receiving condition for constituting the criterion, first, the AV data transmitting device 3 notifies the AV data receiving devices 4x and 4y of the setting of the criterion conformed with the receiving condition of the AV data receiving device 4x. If the receiving condition of the AV data receiving device 4x remains stable, then, as shown in FIG. 51D, reproducible AV data is transmitted to the AV data receiving devices 4x and 4y. On the other hand, if the receiving condition of the AV data receiving condition has turned to be unstable, as shown in FIG. 51E, reproduction of AV data is provisionally halted, and simultaneously, the AV data transmitting device 3 transmits still image to the AV data receiving devices 4x and 4y so as to check and confirm the actual receiving condition of the AV data receiving device 4x.

While step 1002 is underway, if it is confirmed that the use of the receiving condition rising operation controlling function has not been designated (NO), then, step 1009 is entered so as to turn the receiving condition rising operation controlling function off. Then, the AV data transmitting device 3 executes a normal AV data radio communication with plural units of the AV data receiving devices without applying the receiving condition rising operation controlling function.

Concretely, when the AV data transmitting device 3 executes an AV data radio communication with the AV data receiving devices 4x and 4y, in particular, when the receiving condition of the AV data receiving device 4x remains stable, as shown in FIG. 51D, reproducible AV data is transmitted to the AV data receiving devices 4x and 4y. Even when the receiving condition of the AV data receiving device 4x has turned to be unstable, as shown in FIG. 51F, reproducible AV data are continuously transmitted to the AV data receiving devices 4x and 4y without provisionally halting the AV data reproducing operation.

While the initial step 1001 is entered, if any request from other AV data receiving devices for transmission of AV data were not confirmed (NO), then operating mode reverts to step 1001, in which it is confirmed whether any request has been raised from other AV data receiving device 4 for transmission of AV data, or not.

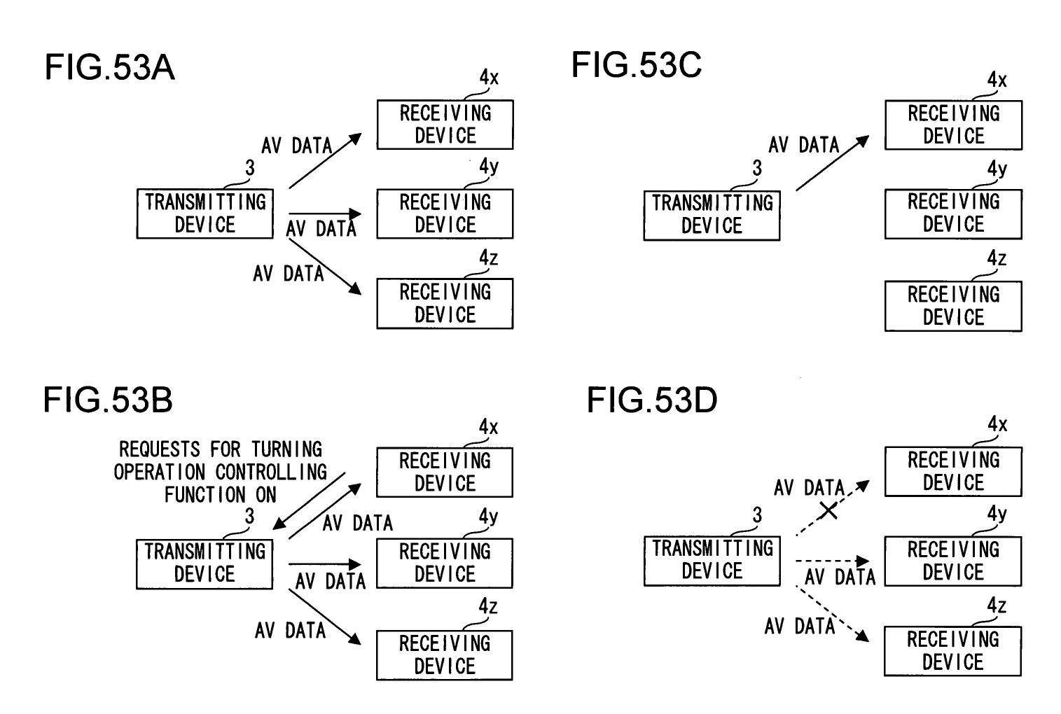

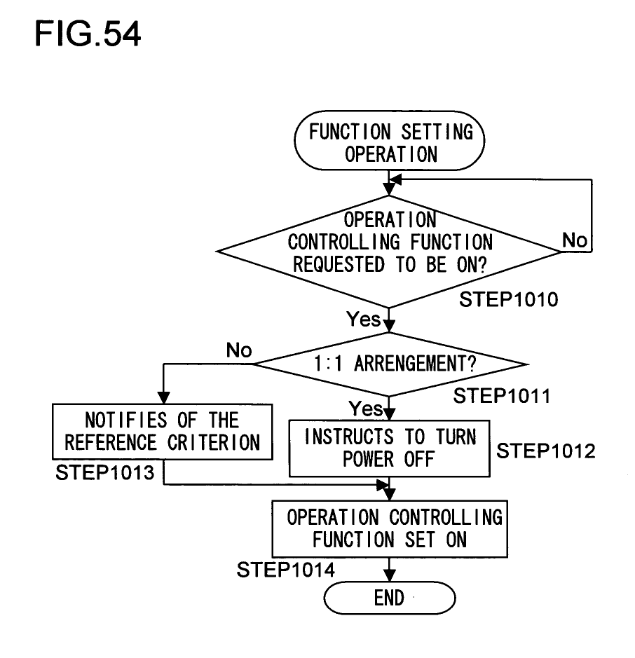

Further, as shown in FIG. 53A, when the AV data transmitting device 3 executes a normal AV data radio communication with plural units of the AV data receiving devices 4x to 4z without applying the receiving condition rising operation controlling function, as shown in FIG. 53B, it is possible for the AV data receiving device 4x to request for actuating AV data radio communication based on the application of the receiving condition rising operation controlling function. Processes for requesting to actuate the above AV data radio communication via said controlling function are described below by referring to the flowchart shown in FIG. 54.

As described above, when the AV data transmitting device 3 executes the above AV data radio communication with plural units of the AV data receiving devices 4 (i.e., the AV data receiving device 4x to 4z), the data analyzer 513 confirms in step 1010 whether a signal requesting for application of the receiving condition rising operation controlling function has been received from the AV data receiving device 4, or not. If it is requested by the AV data receiving device 4 to apply the receiving condition rising operation controlling function (YES), then, step 1011 is entered, in which it is confirmed whether the AV data radio communication based on the one-to-one relationship has been requested, or not.

If the AV data radio communication is preset based on the one-to-one relationship (YES), the data generator 505 generates a signal for instructing to turn the power off, and then transmits this instruction signal in the following step 1012 to all the AV data receiving devices 4 (i.e., the AV data receiving devices 4x and 4y shown in FIG. 53A to FIG. 53D) other than the AV data receiving device 4 (i.e., the AV data receiving devices 4x shown in FIG. 53A to FIG. 53D) that requested application of the receiving condition rising operation controlling function in step 1010. Concretely, as shown in FIG. 53B, when the AV data receiving device 4x has requested the application of the receiving condition rising operation controlling function, as shown in FIG. 53C, power supply sources of the AV data receiving devices 4y and 4z are turned off, and as a result, the AV data radio communication is solely executed between the AV data transmitting device 3 and the AV data receiving device 4x.

If the AV data radio communication designated in step 1011 were not based on the one-to-one relationship (NO), then, the AV data receiving device 4 (i.e., the AV data receiving device 4x shown in FIG. 53A to FIG. 53D) that requested in step 1010 to apply the receiving condition rising operation controlling function is designated as the AV data receiving device 4 for constituting the reference in the case of applying the receiving condition rising operation controlling function. Next, the data generator 505 generates a signal for notifying the AV data receiving devices 4 of which receiving condition is used as the criterion reference, and then transmits this signal in step 1013 to all the AV data receiving devices 4 that will potentially participate in the AV data radio communication. Thenceforth, the AV data transmitting device 3 executes an AV data radio communication by applying the receiving condition rising operation controlling function in conjunction with plural units of the AV data receiving devices 4.

Concretely, as shown in FIG. 53B, when the AV data receiving device 4x requests for the application of the receiving condition rising operation controlling function, then, in response, first, the AV data transmitting device 3 notifies the AV data receiving devices 4x to 4z of the designation of the receiving condition of the AV data receiving device 4x as the criterion reference. When the receiving condition of the AV data receiving device 4x remains stable, as shown in FIG. 53A, reproducible AV data are transmitted to the AV data receiving devices 4x to 4z. Conversely, when the receiving condition of the AV data receiving device 4x has turned to be unstable, as shown in FIG. 51D, the AV data transmitting device 3 instructs that reproduction of AV data be halted provisionally, and simultaneously, transmits data signal such as still image to the AV data receiving devices 4x to 4z so as to check and confirm the actual receiving condition of the AV data receiving device 4x.

The Thirteenth Embodiment:

Referring to the accompanying drawings, the thirteenth practical form for implementing the present invention is described below. As was performed for any of the second to sixth, and the eighth, and ninth embodiment, the thirteenth embodiment enables an AV data receiving device to confirm its own actual receiving condition. Concretely, as in the case of the second embodiment, an AV data transmitting device conforms to the constitution shown in FIG. 58, whereas the AV data receiving device conforms to the constitution shown in FIG. 8. Details of this embodiment are described based on the constitution of the second embodiment. It should be noted that the operational function of this embodiment is applicable to the constitution of any of the third to six embodiments, and the eighth or ninth embodiment.

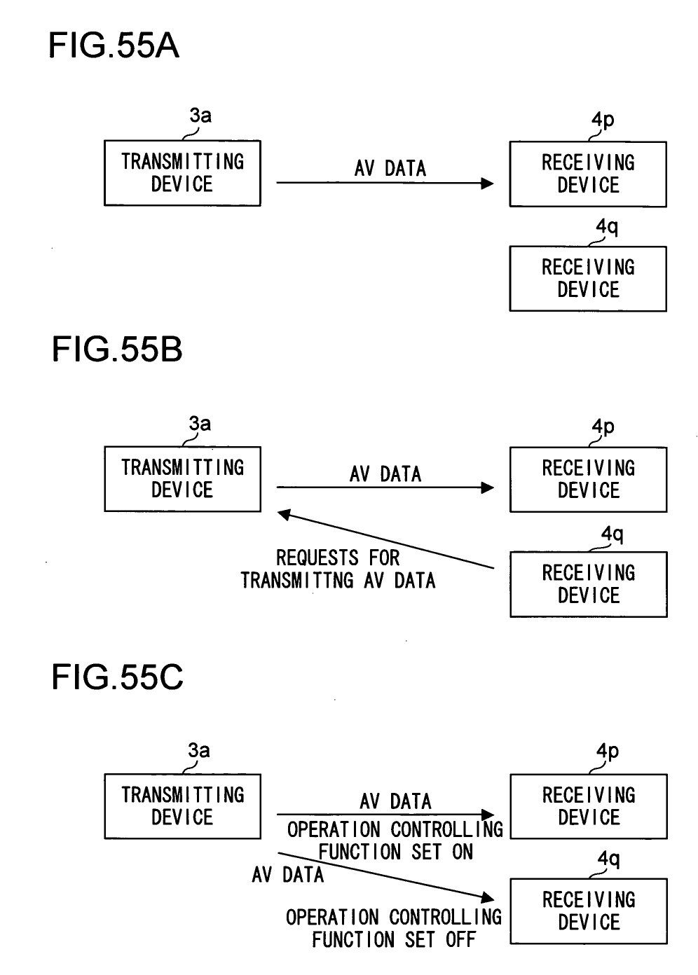

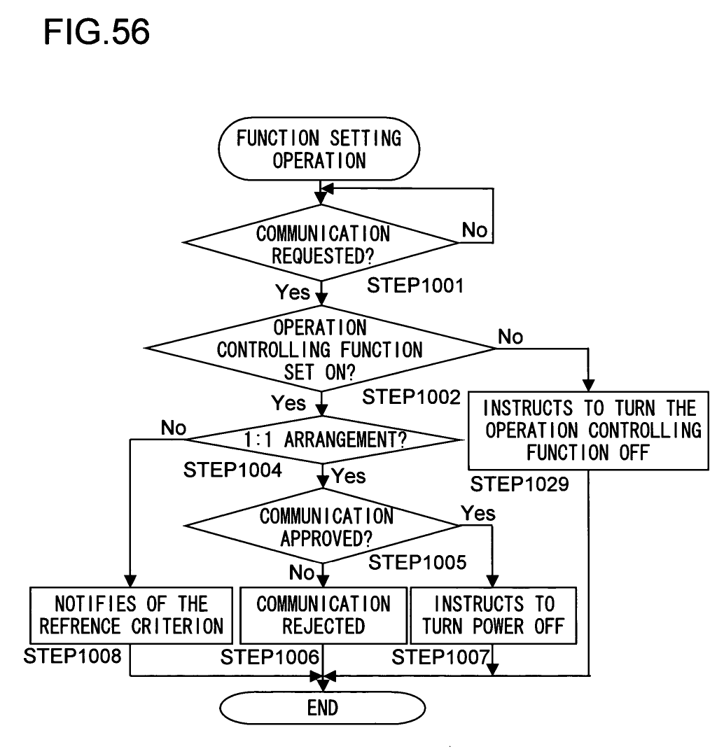

In this embodiment, as shown in FIG. 55A, while an AV data transmitting device 3a exchanges radio communication with an AV data receiving device 4p, as shown in FIG. 55B, when another AV data receiving device 4q requests transmission of an AV data, the AV data receiving device 4q notifies the AV data transmitting device 3a of the propriety on the use of the provisional halting function affected by the receiving condition of the AV data receiving device 4q itself. In this case, the AV data transmitting device 3a executes serial operations in accordance with the flowchart shown in FIG. 56.

As was performed in the twelfth embodiment, when it is confirmed in step 1001 whether there is a request for transmission of an AV data from an AV data receiving device 4a other than an AV data receiving device 4a (i.e., the AV data receiving device 4p shown in FIG. 55A to FIG. 55C) presently being engaged in an AV data radio communicating operation, or not, then, step 1002 is entered, in which it is confirmed whether the receiving condition rising operation controlling function be applied, or not. If it is confirmed that the receiving condition rising operation controlling function is not applicable, then, step 1029 is entered, in which the AV data transmitting device 3a instructs all the AV data receiving devices 4a capable of executing the AV data radio communication to turn the receiving condition rising operation controlling function off. Propriety on the use of the receiving condition rising operation controlling function confirmed in step 1002 and another propriety on the AV data radio communication based on the one-to-one relationship are respectively set to and stored in the AV data transmitting device 3a. In this embodiment, propriety on the use of the receiving condition rising operation controlling function is set by the AV data transmitting device 3a. However, it is also allowable to change the propriety depending on the designation from the AV data receiving device 4a.

After confirming in step 1002 that the receiving condition rising operation controlling function is applied, it is confirmed in step 1004 whether the AV data radio communication is executed based on the one-to-one relationship, or not. When it is confirmed that the AV data radio communication is executed based on the one-to-one relationship, as was done for the twelfth embodiment, serial operations corresponding to steps 1005 to 1007 are executed. Concretely, when step 1006 is entered, instructions are generated so as to actuate the receiving condition rising operation controlling function against an AV data receiving device 4a (i.e., the AV data receiving device 4q shown in FIG. 55A to FIG. 55C) that raised a request in step 1001 for transmission of an AV data. When step 1007 is entered, instructions are also generated so as to actuate the receiving condition rising operation controlling function against an AV data receiving device 4a (i.e., the AV data receiving device 4p shown in FIG. 55A to FIG. 55C) presently engaged in the AV data radio communication.

When it is confirmed in step 1004 that execution of an AV data radio communication based on the one-to-many relationship has been approved, as was performed for the twelfth embodiment, identity of an AV data receiving device 4a designated as the one generating the reference receiving condition is transmitted to all the AV data receiving devices 4a capable of exchanging the AV data radio communication while step 1008 is underway. Concurrently, the AV data transmitting device 3a instructs the above reference AV data receiving device 4a so as to actuate the receiving condition rising operation controlling function, and further instructs the remaining AV data receiving devices 4a to keep the receiving condition rising operation controlling function to remain off.

Concretely, as shown in FIG. 55C, while the receiving condition of the AV data receiving device 4p remains as the reference criterion, the receiving condition rising operation controlling function is held on operable in the AV data receiving device 4p, whereas the receiving condition rising operation controlling function is held on inoperable in the AV data receiving device 4q.

While the AV data transmitting device 3a has already been exchanging AV data radio communication with a plurality of AV data receiving devices 4a, if one of those AV data receiving devices 4a raises a request for implementing the receiving condition rising operation controlling function, as was performed in the twelfth embodiment, serial operations conforming to the flowchart shown in FIG. 54 are executed by the AV data transmitting device 3a. When those AV data receiving devices 4a of which the receiving condition is used as the reference criterion is notified of in step 1013, the receiving condition rising operation controlling function is turned off in all the AV data receiving devices 4a of which the receiving condition is not used as the reference criterion.

In this embodiment, as just described above, it is arranged that the receiving condition rising operation controlling function is entered by the AV data transmitting device 3a. Instead, it is also allowable to have the AV data receiving device 4a enter the receiving condition rising operation controlling function. When actuating the receiving condition rising operation controlling function, the AV data receiving device 4a designated as the reference unit notifies the AV data transmitting device 3a and the remaining AV data receiving devices 4a of the effect that the receiving condition thereof has been designated as the reference criterion directly or via the AV data transmitting device 3a.

Upon reception of the above notice, all the AV data receiving devices 4a except for the one designated as the reference unit respectively turn the receiving condition rising operation controlling function off. When executing the AV data radio communication based on the one-to-one relationship, the reference AV data receiving device 4a notifies the remaining AV data receiving devices 4a of the request for turning their power supply sources off directly or via the AV data transmitting device 3a as well.

The above description has fully explained the AV data radio communication system based on individual forms for embodying the present invention. However, not only for implementing the AV data radio communication, but the present invention is also applicable to any communication system for treating various data transmitted via the time-wise sequence. Further, not only the radio communication system, but the present invention is also applicable to conventional cable communication systems as well.

According to the present invention, whenever mutual communication exchanged between a data transmitting device and a data receiving device has been interrupted by any accidental reason such as worsened receiving condition on the part of the data receiving device or abrupt interruption of power supply source for example, the present invention enables recording of the actual data position of the interrupted data signal. Upon recovery of communication linkage between the data transmitting device and the data receiving device, it is possible to resume operations for generating and transmitting data signals from the recorded data position. Further, whenever mutual communication between the data transmitting device and the data receiving device has been interrupted, it is possible to cause the operations for generating and transmitting data signals to be halted provisionally. Upon recovery of communication linkage between the data transmitting device and the data receiving device, it is possible to resume operations for generating and transmitting data signals from the provisionally halted data position. Concurrently, it is possible to set an overlap time, and thus, when operations for generating and transmitting data signals have been resumed for example, user is enabled to easily identify the substance of contents.

Further, inasmuch as it has been made possible to select the data position required for resuming reproduction of a plurality of contents after a provisional halt thereof, user is enabled to view and listen to the desired contents at any optional time. Further, the data on the provisionally halted data position required for resuming the reproduction is stored in memory together with the data of an authentic user approved for viewing and listening to the desired contents. Owing to this arrangement, it is possible to restrict users approved for viewing and listening to the contents subject to resumption of its reproduction. Further, inasmuch as the error generated position can be determined as the reproduction resuming data position, after generation of error, user is enable to easily specify an error generated data position against which the user desires that AV data be reproduced without occurrence of error again. Further, when the mutual communication between the data transmitting device and the data receiving device has been interrupted, the generated data signal is provisionally stored in a buffer. When the communication linkage between the data transmitting device and the data receiving device has been restored, it is possible to commence transmission from the data signal stored in the buffer, and thus, it is possible to resume exchange of communication between the data transmitting device and the data receiving device without spending time required for standby mode until reproducing operation of an AV source unit can be actuated over again.

What is claimed is:

1. A data transmitting device comprising:
a data transmitter that transmits a data signal;
a data receiver that receives a receiving condition notifying signal that is transmitted, from a data receiving device that receives the data signal, to indicate receiving condition of the data receiving device;
a receiving condition analyzer that checks, based on the receiving condition notifying signal received by the data receiver, whether or not reception is proceeding normally in the data receiving device; and
a system controller
that, when the receiving condition analyzer finds reception not to be proceeding normally, recognizes the data receiving device to be unable to perform stable communication and thus temporarily halts transmission of the data signal, and
that, when the receiving condition analyzer finds reception to be proceeding normally while transmission of the data signal is temporarily or otherwise halted, recognizes the data receiving device to be able to perform stable communication and thus starts transmission of the data signal.

2. The data transmitting device according to claim 1,
wherein the data signal is based on data that is generated on a time-series basis,
wherein there is provided a reproduction resuming data memory in which is stored, as a reproduction resuming data position, a data position on a time axis at which the data receiving device is found to be unable to perform stable communication; and
wherein, when the data receiving device is found to be able to perform stable communication, the data signal is transmitted starting at the reproduction resuming data position.

3. The data transmitting device according to claim 1,
wherein, after the data receiving device is found to be unable to perform stable communication, a reception checking data signal for checking the receiving condition of the data receiving device is generated and transmitted.

4. The data transmitting device according to claim 1,
wherein, assuming that the data signal is based on AV data, and assuming that contents of the data signal of which transmission is temporarily halted are broadcast contents that permit use of a time-shift function whereby contents can be played back while the contents are still being recorded,
when transmission of the data signal of the broadcast contents is temporarily halted, the AV data of the broadcast contents is recorded by use of the time-shift function, and
when transmission of the data signal of the broadcast contents is resumed, the time-shift function continues to be used.

5. The data transmitting device according to claim 1,
wherein,
when the data receiving device is found to be unable to perform stable communication, both generation and transmission of the data signal is temporarily halted, and
when the data receiving device is found to be able to perform stable communication, generation and transmission of the data signal is resumed.

6. The data transmitting device according to claim 5,
wherein there is provided an interface that receives, from a source that generates the data signal, the data signal and that then feeds the thus received data signal to the data transmitter, and
wherein,
when the data receiving device is found to be unable to perform stable communication, generation of the data signal in the source as well as transmission of the data signal is temporarily halted, and
when the data receiving device is found to be able to perform stable communication, generation of the data signal in the source as well as transmission of the data signal is temporarily halted.

7. The data transmitting device according to claim 1,
wherein there is provided a buffer in which is temporarily stored the data signal starting at a reproduction resuming data position, which is a data position on a time axis at which the data receiving device is found to be unable to perform stable communication, and
wherein, when the data receiving device is found to be able to perform stable communication, generation of the data signal is resumed by reading and transmitting the data signal stored in the buffer.

8. The data transmitting device according to claim 1,
wherein reception of the data signal is permitted to a plurality of data receiving devices,
wherein there is provided a receiving-condition-dependent operation controlling function whereby operation of the system controller is set according to receiving condition of the data receiving devices,
wherein, when the data signal is transmitted to the data receiving devices, one of the following operation states is selected:
a first operation state in which, when the data signal is transmitted parallely to the plurality of data receiving devices, the receiving-condition-dependent operation controlling function is disabled;
a second operation state in which, when the receiving-condition-dependent operation controlling function is enabled, the data signal is transmitted to only one of the data receiving devices; and
a third operation state in which, when the receiving-condition-dependent operation controlling function is enabled, the data signal is transmitted to the plurality of data receiving devices by referring to, as a reference, receiving condition of one of the data receiving devices, and
wherein
when the second operation state is selected while the data signal is being transmitted to the plurality of data receiving devices, a request to halt reception is given to the data receiving devices other than the data receiving device to which the data signal is transmitted when the receiving-condition-dependent operation controlling function is enabled, and
when the third operation state is selected while the data signal is being transmitted to the plurality of data receiving devices, a notification of the data reception device of which receiving condition is referred to as the reference when the receiving-condition-dependent operation controlling function is enabled is given to the data receiving devices other than the data receiving device of which receiving condition is referred to as the reference.

9. A data transmitting device comprising:
a data transmitter that transmits a data signal based on data that is generated on a time-series basis;
a data receiver that receives a receiving condition notifying signal that is transmitted, from a data receiving device that receives the data signal, to indicate receiving condition of the data receiving device;
a receiving condition analyzer that checks, based on the receiving condition notifying signal received by the data receiver, whether or not reception is proceeding normally in the data receiving device;
a reproduction resuming data memory in which is stored, as a reproduction resuming data position, a data position on a time axis at which the data receiving device is found to be unable to perform stable communication; and
a system controller
that, when the receiving condition analyzer finds reception not to be proceeding normally, recognizes the data receiving device to be unable to perform stable communication and thus stores the reproduction resuming data position in the reproduction resuming data memory, and
that thereafter, when the receiving condition analyzer finds reception to be proceeding normally, recognizes the data receiving device to be able to perform stable communication and thus resumes transmission of the data signal starting at the reproduction resuming data position stored in the reproduction resuming data memory.

10. The data transmitting device according to claim 9,
wherein,
a length, along the time axis, of data to be transmitted again within data that has already been transmitted as the data signal up to the reproduction resuming data position set when the data receiving device is recognized to be unable to perform stable communication is set as an overlap time, and
when the data receiving device is recognized to be able to perform stable communication, the reproduction resuming data position is updated with a data position obtained by subtracting the overlap time therefrom, and data starting at the thus updated reproduction resuming data position is transmitted as the data signal.

11. The data transmitting device according to claim 10,
wherein the receiving condition analyzer or the data receiving device calculates the overlap time based on a difference between a first time point that is a current time point at which the data receiving device becomes able to perform stable communication and a second time point at which the data receiving device previously became unable to perform stable communication, and
wherein, when the data signal is transmitted starting at the reproduction resuming data position, first, data corresponding to a predetermined period of time starting at the reproduction resuming data position is transmitted to the data receiving device, and then, if transmission, requested via the data receiving device, of the data signal starting at the reproduction resuming data position is permitted, the data signal is transmitted starting at the reproduction resuming data position.

12. The data transmitting device according to claim 9,
wherein a data position on the time axis at which a reception error exceeding a predetermined level is recognized is recorded as an error inflicted data position, and
wherein, when one among a plurality of such error-inflicted data positions thus recorded and the reproduction resuming data position is selected via the data receiving device, the reproduction resuming data position is updated with the thus selected data position, and the data signal is transmitted starting at the thus updated reproduction resuming data position.

13. A data receiving device comprising:
a data receiver that receives a data signal from a data transmitting device;
a data analyzer that decodes the data signal received by the data receiver;
a receiving condition checker that checks whether or not the data receiver has received the data signal normally;
a system controller
that, when the receiving condition checker finds reception not to be proceeding normally, recognizes the data receiving device itself to be unable to perform stable communication and thus generates temporary-halt control data for making the data transmitting device temporarily halt transmission of the data signal, and
that, when the receiving condition checker finds reception to be proceeding normally while transmission of the data signal in the data transmitting device is being temporarily or otherwise halted, recognizes the data receiving device itself to be able to perform stable communication and thus generates transmission-resumption control data for making the data transmitting device start transmission of the data signal; and
a data transmitter that transmits to the data transmitting device the temporary-halt control data or the transmission-resumption control data generated by the system controller.

14. The data receiving device according to claim 13,
wherein the data signal is based on data that is generated on a time-series basis,
wherein there is provided a reproduction resuming data memory in which is stored, as a reproduction resuming data position, a data position on a time axis at which the data receiving device itself is found to be unable to perform stable communication; and
wherein, when the data receiving device itself is found to be able to perform stable communication, the transmission-resumption control data is transmitted to request the data signal to be transmitted starting at the reproduction resuming data position.

15. The data receiving device according to claim 13,
wherein, after the data receiving device itself is found to be unable to perform stable communication, a reception checking data signal that is transmitted from the data transmitting device to check the receiving condition of the data receiving device is received.

16. The data receiving device according to claim 13,
wherein, assuming that the data signal is based on AV data, and assuming that contents of the data signal of which transmission is temporarily halted are broadcast contents that permit use of a time-shift function whereby contents can be played back while the contents are still being recorded,
when the temporary-halt control data is transmitted to request halting of transmission of the data signal of the broadcast contents, temporary-halt control data that requests recording of the data signal of the broadcast contents is transmitted by use of the time-shift function, and
when the transmission-resumption control data is transmitted to request resumption of transmission of the data signal of the broadcast contents, transmission-resumption control data that requests continued use of the time-shift function is transmitted.

17. The data receiving device according to claim 13,
wherein the data transmitting device permits reception of the data signal to a plurality of data receiving devices,
wherein there is provided a receiving-condition-dependent operation controlling function whereby operation of the system controller is set according to receiving condition of the data receiving device itself
wherein, when the data signal is received from the data transmitting device, one of the following operation states is selected:
a first operation state in which, when the data signal is transmitted from the data transmitting device parallely to the plurality of data receiving devices including the data receiving device itself the receiving-condition-dependent operation controlling function is disabled;
a second operation state in which, when the receiving-condition-dependent operation controlling function is enabled and the data signal from the data transmitting device is received, reception by the data receiving devices other than the data receiving device itself is stopped; and
a third operation state in which, when the receiving-condition-dependent operation controlling function is enabled and the data signal from the data transmitting device is received, the receiving-condition-dependent operation controlling function in the data receiving devices other than the data receiving device itself is disabled.

18. The data receiving device according to claim 13,
wherein the receiving condition checker checks whether or not reception is proceeding normally based on continuity of the data signal.

19. The data receiving device according to claim 13,
wherein the data signal is based on AV data, and the receiving condition checker checks whether or not reception is proceeding normally based on continuity of audio data decoded by the data analyzer.

20. The data receiving device according to claim 13,
wherein, when a request to stop reproduction of the data signal is recognized, the system controller generates transmission-stop control data for requesting stopping of transmission of the data signal, and the data transmitter transmits the transmission-stop control data to the data transmitting device.

21. A data receiving device comprising:
a data receiver that receives from a data transmitting device a data signal based on data that is generated on a time-series basis;
a data analyzer that decodes the data signal received by the data receiver;
a receiving condition checker that checks whether or not the data receiver has received the data signal normally;
a reproduction resuming data memory in which is stored, as a reproduction resuming data position, a data position on a time axis at which the data receiving device itself is found to be unable to perform stable communication;
a system controller
that, when the receiving condition checker finds reception not to be proceeding normally, recognizes the data receiving device itself to be unable to perform stable communication and thus stores the reproduction resuming data position in the reproduction resuming data memory, and
that thereafter, when the receiving condition checker finds reception to be proceeding normally, recognizes the data receiving device itself to be able to perform stable communication and thus generates transmission-resumption control data for requesting transmission of the data signal starting at the reproduction resuming data position; and
a data transmitter that transmits the transmission-resumption control data generated by the system controller to the data transmitting device.

22. The data receiving device according to claim 21,
wherein, when the data receiving device itself is recognized to be able to perform stable communication,
a length, along the time axis, of data to be transmitted again within data that has already been transmitted as the data signal up to the reproduction resuming data position set when the data receiving device itself is recognized to be unable to perform stable communication is set as an overlap time, and
the reproduction resuming data position is updated with a data position obtained by subtracting the overlap time therefrom, and transmission-resumption control data that requests transmission of, as the data signal, data starting at the thus updated reproduction resuming data position is transmitted.

23. The data transmitting device according to claim 22,
wherein the receiving condition checker calculates the overlap time based on a difference between a first time point that is a current time point at which the data receiving device becomes able to perform stable communication and a second time point at which the data receiving device previously became unable to perform stable communication,
wherein the overlap time can be entered by a user, and
wherein, when a plurality of such overlap times are generated or entered, selectable ones among those overlap times are notified of.

24. The data transmitting device according to claim 21,
wherein a data position at which a reception error exceeding a predetermined level is recognized is recorded as an error-inflicted data position, and
wherein, when the transmission-resumption control data is transmitted, if one among a plurality of such error-inflicted data positions thus recorded and the reproduction resuming data position is selected, the reproduction resuming data position is updated with the thus selected data position, and transmission-resumption control data that requests transmission of the data signal starting at the thus updated reproduction resuming data position is transmitted.

25. The data transmitting device according to claim 24,
wherein, when a number of error-inflicted data positions recorded exceeds a predetermined number, an oldest error-inflicted data position recorded is deleted.

26. The data transmitting device according to claim 24,
wherein a plurality of error-inflicted data positions selected from those of the error-inflicted data positions which are close to a current time point or from those of the error-inflicted data positions at which the reception errors exceed the predetermined level are notified of.

27. A data communication system comprising:
a data transmitting device that transmits a data signal; and
a plurality of data receiving devices that are permitted to receive the data signal from the data transmitting device,
wherein,
when a first data receiving device, which is one of the plurality of data receiving devices, finishes data communication with the data transmitting device and disconnects itself therefrom, the data transmitting device temporarily halts transmission of the data signal, and
when a second data receiving device, which is one of the plurality of data receiving devices, establishes connection for communication with the data transmitting device, the data signal is transmitted starting at a reproduction resuming data position that is set based on a data position at which the data transmitting device halted transmission.

28. A data communication system comprising:
a data transmitting device that transmits a data signal; and
a plurality of data receiving devices that are permitted to receive the data signal from the data transmitting device,
wherein, when communication is performed, one of the following operation states is selected:
a first operation state in which, when the data transmitting device transmits the data signal to the plurality of data receiving devices, a receiving-condition-dependent operation controlling function whereby transmission of the data signal is controlled according to receiving condition of the data receiving devices is disabled;
a second operation state in which, when the receiving-condition-dependent operation controlling function is enabled, the data transmitting device transmits the data signal only to one of the data receiving devices, and stops reception by the other data receiving devices; and
a third operation state in which, when the receiving-condition-dependent operation controlling function is enabled, the receiving-condition-dependent operation controlling function is used according to receiving condition of one of the plurality of data receiving devices to which the data transmitting device transmits the data signal.
